(19) United States
(12) Patent Application Publication
(10) Pub. No.: US 2025/0187757 A1
(43) Pub. Date: Jun. 12, 2025

(54) SYSTEM AND ASSOCIATED METHODS FOR A MODULAR SATELLITE HAVING COMPLEX BEHAVIOR

(71) Applicant: Sidus Space, Inc., Merritt Island, FL (US)

(72) Inventors: Carol Craig, Merritt Island, FL (US); Jeremy Joseph Allam, Honolulu, HI (US); Marcel Romeo Lariviere, Pasadena, CA (US); Valerij Ojdanic, Indian Harbour Beach, FL (US)

(73) Assignee: Sidus Space, Inc., Merritt Island, FL (US)

(21) Appl. No.: 19/059,553

(22) Filed: Feb. 21, 2025

Related U.S. Application Data
(63) Continuation-in-part of application No. 17/828,233, filed on May 31, 2022.
(63) Continuation-in-part of application No. 18/175,977, filed on Feb. 28, 2023.
(63) Continuation-in-part of application No. 18/742,400, filed on Jun. 13, 2024.
(60) Provisional application No. 63/315,461, filed on Mar. 1, 2022.

(51) Int. Cl. B64G 1/10; B64G 1/22; B64G 1/24; B64G 1/36; B64G 1/44; G05D 1/49; G06F 16/11; G06V 10/14; G06V 20/13; H04B 7/185

(52) U.S. Cl. CPC B64G 1/1007; B64G 1/222; B64G 1/244; B64G 1/361; B64G 1/443; G06F 16/113; G06V 10/14; G06V 20/13; H04B 7/18513; G05D 1/49

(57) ABSTRACT

A modular satellite system is provided comprising a main body member, one or more controllers, a communication system, a datastore, a power unit, and one or more orbital cameras. The controller(s) may be operable to perform a mission instruction. The communication system may be in communication with the controller(s) and with a client terminal. The datastore may store data accessible by the controller(s). The orbital camera(s) may be operable to capture one or more image(s) associated with the mission instruction, which may be defined as captured image(s). The controller(s) may be operable to detect and identify one or more predetermined object(s) in the one or more captured image(s). The controller(s) may generate a mission analytics packet, and the controller(s) may be operable to transmit the mission analytics packet to the client terminal.

### RELATED APPLICATIONS

This application is a continuation-in-part application of and claims priority under 35 U.S.C. § 120 of U.S. patent application Ser. No. 17/828,233 filed on May 31, 2022, and titled SYSTEM FOR A MODULAR SATELLITE TESTING PLATFORM (attorney docket number 6270.00019). This application also is a continuation-in-part application of and claims priority under 35 U.S.C. § 120 of U.S. patent application Ser. No. 18/175,977 filed on Feb. 28, 2023, and titled HOST SATELLITE HAVING PRIORITIZED ANALYTICS ASSOCIATED WITH DETECTED OBJECTS AND MISSION CONSTRAINTS FOR COMMUNICATION WITH CLIENT TERMINAL (attorney docket no. 6270.00055), which in turn claims priority under 35 U.S.C. § 119 (e) of U.S. Provisional Patent Application Ser. No. 63/315,461 filed on Mar. 1, 2022, and titled HOST SATELLITE HAVING PRIORITIZED ANALYTICS ASSOCIATED WITH DETECTED OBJECTS AND MISSION CONSTRAINTS FOR COMMUNICATION WITH CLIENT TERMINAL. This application also is a continuation-in-part application of and claims priority under 35 U.S.C. § 120 of U.S. patent application Ser. No. 18/742,400 filed on Jun. 13, 2024, and titled SYSTEM AND ASSOCIATED METHODS FOR A LIGHT FILTERING DEVICE (attorney docket no. 6270.00064). The contents of these applications are incorporated herein by reference except for where they conflict with the content herein.

### FIELD OF THE INVENTION

The present invention relates to satellites that collect data on orbit.

### BACKGROUND OF THE INVENTION

In general, there is a need within the satellite industry by researchers who specialize in satellite subsystem design who do not have the expertise to design, integrate, launch and operate a satellite. There is a need to be able to test hardware and give flight heritage without worrying about how to design and build an entire satellite. This creates a need for a modular satellite wherein researchers can be provided a simple interface for power, data, and handover their payload to a company for on-orbit testing and/or operation and that company returns the vital data. Moreover, there is a demand for satellites to be made of a lighter material in order to reduce the cost of launching it into orbit.

Traditionally satellites use lighter metals, such as aluminum, as the main material to construct the components of a satellite. These lighter metals have a well understood reaction to thermal changes and electrical conductivity. However, using these traditional materials in manufacturing satellite structures requires long periods of planning, testing, and lead times to create a finished product to fulfill a purchaser's order to the purchaser's chosen specifications.

Additionally, satellites in orbit capture and transmit over 10 million raw photos consuming over 100 terabytes of data transfer bandwidth per day down to Earth. Furthermore, it can take hours from the time a raw photo is captured by a satellite, delivered to the ground, and processed to extract analytics before the extracted analytics are transmitted to the end user. This delay in obtaining the extracted analytics data from a raw photo, also known as latency, can impact effective decision-making for commercial, regulatory, or environmental conditions such as the ability to effectively prevent a small wildfire or oil leak from growing into a large, catastrophic environmental event.

Also, a critical component of some satellite is the light sensor, which relies heavily on the accuracy and quality of light filtration to function optimally. The data that can be derived from the use of an effective light filter in a light sensor is widely sought after. There exists a significant need within the industry for a light filter that can further enhance and provide for the filtration performance that these sensors need. It can lead to breakthroughs in accurate climate monitoring, resource management, and even planetary exploration.

Historically, the prior art in light filtration for orbital devices has been fraught with limitations. The prior art have often been prohibitively expensive, limiting their accessibility to a broad customer base. Moreover, they have less than ideal reliability, succumb to the harsh conditions of space, such as extreme temperature fluctuations and radiation exposure. Additionally, the prior art have failed to provide for light filters that are easily configurable to filter desired wavelengths of light. The complexity and cost of development have deterred many potential users from attempting to create proprietary solutions, as the investment in time and resources required is substantial.

In light of the above deficiencies in the prior art, a solution is needed that provides a modular satellite testing platform with shorter lead times and using components that are lower in cost and weight while still allowing for customization by a purchaser that performs the same or better as the traditional materials. Furthermore, a solution is needed to implement a new material to be used as the structure of a satellite exposed to the vacuum of space given the different electrical conductivity and thermal transfer properties of the new material. Moreover, a solution is needed to solve the issues caused by the delay in latency in obtaining the extracted analytics data from a raw photo captured by a satellite. Also, a solution is needed for a light filter that overcomes the problems left unsolved by the prior art and provides for an improvement thereof, especially as related to the space industry.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a modular satellite comprising a main body member, one or more controller(s), a communication system, a datastore, a power unit, and one or more orbital camera(s). The controller(s) may be carried by the main body member. The controller(s) may be operable to perform a mission instruction. The communication system may be carried by the main body member. The communication system may be in communication with the controller(s) and with a client terminal. The datastore may be carried by the main body member and the datastore may be operable to store data which may be accessible by the controller(s).

The power unit may be carried by the main body member. The power unit may be in communication with the controller(s). The orbital camera(s) may be carried by the main body member and may be operable to capture one or more image(s) that may be associated with the mission instruction. The image(s) captured by the orbital camera(s) may be defined as captured image(s). The controller(s) may be operable to detect one or more predetermined object(s) in the one or more captured image(s), which may be defined as detected predetermined object(s). The controller(s) may be operable to identify the detected predetermined object(s), defined as an identified predetermined object(s).

The controller(s) may generate a mission analytics packet which may be based on the one or more captured image(s), the detected predetermined object(s), the identified predetermined object(s), and/or the mission instruction. The controller(s) may be operable to store the mission analytics packet in the datastore. The controller(s) may be operable to transmit the mission analytics packet to the client terminal.

Some embodiments of the present invention may include cover members. The cover members may be carried by the main body member and may be movable between an opened position and a closed position. each of the plurality of cover members includes a retention member. The main body member includes a respective plurality of release members. a retention line is extended between the retention member and a retention line connection point on the main body member adjacent to the release member.

The retention line may be configured to be in contact with the release member when the cover member is in the closed position. The retention line may be moveable from a retention state to a released state. When the retention line is in the retention state the cover member may be prevented from moving to the opened position. When the retention line is in the released state, the cover member may be moveable from the closed position to the opened position.

The release member may be operable between a neutral state and a charged state. The charged state may be defined as the release member being heated to a temperature suitable to cause the retention line to be severed. The cover member may be moveable from the closed position to the opened position when, while, and/or upon the retention line being severed.

Some embodiments of the present invention may also include an attitude control system that may monitor and control an orientation of the main body member. The attitude control system may detect a movement force associated with the cover members being moved between the closed position and the open position. The attitude control system may generate a counter force to counteract the movement force.

Some embodiments of the present invention may include a star tracker that may be operable to track one or more star(s). Each of the cover members may include a photovoltaic member. The attitude control system may be operable to orient the main body so that the photovoltaic members may be oriented to face a direction of the one or more star(s). The orbital camera may be configured to filter one or more wavelength(s) of light from light received thereby to define a filtered light. The orbital camera may sense the filtered light to generate sensed light data. The one or more captured image(s) may be defined by the sensed light data.

The mission instruction may comprise an original mission instruction. The one or more captured image(s) may be stored in the datastore. The controller(s) may be operable to generate one or more of an additional mission instruction based on the original mission instruction. The orbital camera may be operable to capture one or more additional image(s) associated with the additional mission instruction, which may be defined as captured additional image(s). The controller(s) may be operable to detect or more additional predetermined object(s) in the captured additional image(s), which may be defined as detected predetermined object(s).

The controller(s) may be operable to identify the detected additional predetermined object(s), defined as identified additional predetermined object(s). The controller(s) may be operable to generate an additional mission analytics packet based on the additional mission instruction and/or the captured additional image(s). The controller(s) may be operable to store the additional mission analytics packet in the datastore. The controller(s) may be operable to transmit the additional mission analytics packet to the client terminal.

The orbital camera may be operable to capture one or more image(s) associated with the mission instruction and one or more additional image(s) associated with the additional mission instruction(s) simultaneously. The controller(s) may be operable to receive a mission analytics packet request from the client terminal. The controller(s) may be operable to retrieve data from the datastore responsive to the mission analytics packet request.

The controller(s) may perform a relevancy process to determine one or more relevancy parameter constraint(s). The relevancy process may be based on the mission instruction to determine the one or more relevancy parameter constraint(s). The controller(s) may be operable to compare data in the mission analytics packet to the relevancy parameter constraint(s). At least a portion of the data in the mission analytics packet may be identified based on the comparison of the data in the mission analytics packet to the at least one relevancy perimeter constraint, which may be defined as relevant data. The controller(s) may be operable to remove data from the mission analytics packet that is not identified as the relevant data.

The controller(s) may be operable to identify expired data by comparing an age associated with at least one portion of the data stored in the datastore to a predetermined age constraint. The controller(s) may be operable to delete the expired data. Some embodiments of the present invention may include an archive datastore that may be carried by the main body member and may be operable to store archive data. The archive data stored in/stored by the archive datastore may be accessible by the controller(s). The controller(s) may be operable to identify matured data by comparing an age associated with at least one portion of the data stored in the datastore to a predetermined age constraint. Furthermore, the controller(s) may be operable to transfer the matured data from the datastore to the archive datastore.

Some embodiments of the present invention may be directed to a modular satellite cooperation that comprises more than one modular satellite. Each of the modular satellites of the modular satellite cooperation may comprise a main body member, one or more controller(s), a communication system, a datastore, a power unit, and one or more orbital camera(s). The controller(s) may be carried by the main body member.

The communication system may be carried by the main body member and may be in communication with one or more of the controller(s). The datastore may be carried by the main body member and may be operable to store data accessible by one or more of the controller(s). The power unit may be carried by the main body member and may be in communication with the controller(s).

The orbital camera(s) may be carried by the main body member and may be operable to capture one or more image(s). Each one of the modular satellites may be operable to perform a mission instruction. Each one of the modular satellites may be operable to capture one or more image(s) associated with the mission instruction, which may be defined as one or more captured image(s). Each one of the modular satellites may be configured to communicate with a client terminal. Each one of the modular satellites may be operable to detect one or more predetermined object(s) in the one or more captured image(s) based on the mission instruction, which may be defined as detected predetermined object(s).

Each one of the modular satellites may be operable to identify the detected predetermined object(s), which may be defined as an identified predetermined object(s). Each one of the modular satellites may be operable to generate a mission analytics packet based on the one or more captured image(s), the detected predetermined object(s), the identified predetermined object(s), and/or the mission instruction. Each one of the modular satellites may be operable to store the mission analytics packet. Each one of the modular satellites may be operable to transmit the mission analytics packet to the client terminal. Each one of the modular satellites may be operable to be in communication with one or more of another one of the modular satellites to form a mesh network, and to share and coordinate performance of the mission instruction.

Each one of the modular satellites in the mesh network may coordinate performance of the mission instruction with one another based on the mission instruction and based on one or more mission performance factor(s). Each one of the modular satellites in the mesh network may be operable to determine the mission performance factor(s) based on the mission instruction. Each one of the modular satellites in the mesh network may be operable to identify and share status data to other modular satellite via the mesh network. Each one of the modular satellites in the mesh network may be operable to determine the mission performance factor(s) based on the mission instruction and/or the status data.

Coordination of performance of the mission instruction by the modular satellites in the mesh network may include causing at least one of the modular satellites in the mesh network to: capture the one or more image(s) associated with the mission instruction, which may be defined as the one or more captured image(s); transmit and share the one or more captured image(s) via the mesh network; and/or receive the one or more captured image(s) via the mesh network. Coordination of performance of the mission instruction by the modular satellites in the mesh network may further include causing at least one of the modular satellites in the mesh network to: detect the predetermined object(s) in the one or more captured image(s) based on the mission instruction, which may be defined as the detected predetermined object(s); transmit and share the detected predetermined object(s) via the mesh network; and/or receive the detected predetermined object(s) via the mesh network.

Coordination of performance of the mission instruction by the modular satellites in the mesh network may yet further include causing at least one of the modular satellites in the mesh network to: identify the detected predetermined object(s), which may be defined as the identified predetermined object(s); transmit and share the identified predetermined object(s) via the mesh network; and/or receive the identified predetermined object(s) via the mesh network.

Coordination of performance of the mission instruction by the modular satellites in the mesh network may further include causing at least one of the modular satellites in the mesh network to: generate the mission analytics packet based on the one or more captured image(s), the detected predetermined object(s), the identified predetermined object(s), and/or the mission instruction; store the mission analytics packet; and/or transmit the mission analytics packet to the client terminal.

In some embodiments of the present invention, each one of the modular satellites may comprise cover members that may be moveable between an opened position and a closed position. Each one of the cover members may include a retention member. The main body member of each one of the modular satellites may include a respective plurality of release members. A retention line may be extended between the retention member and a retention line connection point on the main body member adjacent to the release member.

The retention line may be configured to be in contact with the release member when the cover member is in the closed position. The retention line may be movable from a retention state to a released state. When the retention line is in the retention state, the cover member may be prevented from moving to the opened position. When the retention line is in the released state, the cover member may be movable from the closed position to the opened position.

The release member may be operable between a neutral stated and a charged state. The charged state may be defined as the release member being heated to a temperature suitable to cause the retention line to be severed. The cover member may be moveable from the closed position to the opened position when, while, and/or upon the retention line being severed. In some embodiments of the present invention, each one of the modular satellites may include an attitude control system to monitor and control an orientation of the main body member. The attitude control system may detect a movement force associated with the cover members being moved between the closed position and the opened position. The attitude control system may generate a counter force to counteract the movement force.

In some embodiments of the present invention, each one of the modular satellites may include a star tracker that may be operable to track one or more star(s). Each of the cover members may include one or more of a photovoltaic member. The attitude control system may be operable to orient the main body so that the photovoltaic member(s) may be oriented to face a direction of the one or more star(s). Each one of the modular satellites may be configured to generate sensed light data by filtering one or more wavelength(s) of light from light received thereby, which may be to define a filtered light. Each one of the modular satellites may be configured to sense the filtered light to generate the sensed light data. The one or more captured image(s) may be defined by the sensed light data.

The mission instruction may comprise an original mission instruction. Each one of the modular satellites may be operable to store one or more of the captured image(s). Each one of the modular satellites may be operable to generate additional mission instruction(s) based on the original mission instruction. Each one of the modular satellites may be operable to capture one or more additional image(s) associated with the additional mission instruction, which may be defined as captured additional image(s).

Each one of the modular satellites may be operable to detect one or more additional predetermined object(s) in the captured additional image(s), which may be defined as detected additional predetermined object(s). Each one of the modular satellites may be operable to identify the detected additional predetermined object(s), which may be defined as identified additional predetermined object(s). Each one of the modular satellites may be operable to generate an additional mission analytics packet based on the additional mission instruction(s) and/or the one or more captured image(s).

Each one of the modular satellites may be operable to store the additional mission analytics packet. Each one of the modular satellites may be operable to transmit the additional mission analytics packet to the client terminal. Each one of the modular satellites may be operable to store the one or more captured image(s), the detected predetermined object(s), and/or the identified predetermined object(s). Data stored by each one of the modular satellites in the mesh network may be accessible by at least another one of the modular satellites in the mesh network.

Each one of the modular satellites may be operable to receive a mission analytics packet request from the client terminal. Each one of the modular satellites may be operable to retrieve data stored by at least one of the modular satellites in the mesh network responsive to the mission analytics packet request. Each one of the modular satellites may be operable to perform a relevancy process. Performance of the relevancy process may be to determine one or more relevancy parameter constraint(s) and may be based on the mission instruction.

Each one of the modular satellites may be operable to compare data in the mission analytics packet to the one or more relevancy parameter constraint(s). At least a portion of the data in the mission analytics packet may be identified based on the comparison of the data in the mission analytics packet to the one or more relevancy parameter constraint(s), which may be defined as relevant data. Each one of the modular satellites may be operable remove data from the mission analytics packet that is not identified as the relevant data.

### BRIEF DESCRIPTION OF THE DRAWINGS

Some embodiments of the present invention are illustrated as an example and are not limited by the figures of the accompanying drawings, in which like references may indicate similar elements.

FIG. 1 is a perspective view of a modular satellite testing platform system according to an embodiment of the present invention with a plurality of bottom cover members in a closed position.

FIG. 2 is a perspective view of the modular satellite testing platform system of FIG. 1 and having the plurality of bottom cover members in an opened position.

FIG. 3 is a side elevation view of the modular satellite testing platform system of FIG. 1.

FIG. 4 is a perspective side view of the modular satellite testing platform system of FIG. 3 showing inner areas thereof.

FIG. 5 is another perspective view of the modular satellite testing platform system of FIG. 4.

FIG. 6 is a side perspective view of the modular satellite testing platform system of FIG. 1 and showing the plurality of bottom cover members in the opened position.

FIG. 7 is a side perspective view of the modular satellite testing platform of FIG. 1 and showing the plurality of bottom cover members in the closed position.

FIG. 8 is another side perspective view of the modular satellite testing platform system of FIG. 1 with photovoltaic members on every other of the bottom cover members.

FIG. 9 is a perspective view of the modular satellite testing platform system of FIG. 1 and having a satellite antenna connected to a top portion thereof.

FIG. 10 is a schematic diagram of electronic components of the modular satellite testing platform system according to an embodiment of the present invention.

FIG. 11 is a schematic diagram of a thermal control system of the modular satellite testing platform system according to an embodiment of the present invention.

FIG. 12 is a schematic diagram of a communications system of the modular satellite testing platform system according to an embodiment of the present invention.

FIG. 13 is a schematic diagram of a power unit of the modular satellite testing platform system according to an embodiment of the present invention.

FIG. 14 is a schematic diagram of a propulsion system of the modular satellite testing platform system according to an embodiment of the present invention.

FIG. 15 is a perspective view of a modular satellite testing platform system including cover members and U-shape members according to an embodiment of the present invention.

FIG. 16 is another perspective view of the modular satellite testing platform system of FIG. 15 with the cover members and U-shape members removed.

FIG. 17 is a perspective view of a modular satellite testing platform system including photovoltaic members and an attachment member located on an upper member and showing the plurality of lower cover members in the opened position, according to an embodiment of the present invention.

FIG. 18 is a side elevation view of a modular satellite testing platform system showing the bottom cover members in the closed position according to an embodiment of the present invention.

FIG. 19 is a perspective view of a modular satellite testing platform system showing photovoltaic members only covering a portion of a bottom cover member according to an embodiment of the present invention.

FIG. 20 is a perspective view of the modular satellite testing platform system of FIG. 19 and showing inner areas thereof.

FIG. 21 is a perspective view of the modular satellite testing platform system of FIG. 17 having the cover members removed therefrom.

FIG. 22 is a schematic diagram a modular satellite testing platform system according to an embodiment of the present invention, shown with light sensors.

FIG. 23 is an exploded perspective and schematic view of the light sensor and modular satellite of FIG. 22, showing the filtering device being positionable between one or more sub-sensors and a lens of the light sensor.

FIG. 24 is a schematic diagram of the filtering device and light sensor of FIG. 22, showing the lens receiving light reflected from the surface of the Earth.

FIG. 25 is a perspective and schematic view of the filter of the filtering device according to an embodiment the present invention and shown comprising a pattern of filter devices.

FIG. 26 is a schematic diagram of the filter of FIG. 25, showing light filtered by the filtering device and being sensed by a sub-sensor.

FIG. 27 is a graph showing quantum efficiency percentage versus wavelength(s) of light and showing ranges of light wavelengths filtered by one or more filters.

FIG. 28 is an illustration of exemplary light filter ranges of the filtering device according to an embodiment of the present invention, as well as an exemplary pixel resolution of the light sensor.

FIG. 29 is a schematic diagram showing a filtering device according to an embodiment of the present invention, with filtered light shown being received from consecutive moments of time as a series of frames that overlap one another relative to an area of the surface of the Earth.

FIG. 30 is a schematic diagram of a modular satellite according to an embodiment of the present invention, shown with a filter selection device.

FIG. 31 is a schematic diagram of a modular satellite according to an embodiment of the present invention, shown with an alternative embodiment of a filter selection device, and also a filter selection library.

FIGS. 32A-37 are flowchart illustrations of method aspects of the present invention.

FIG. 38 is a schematic diagram showing a plurality of modular satellites in communication with one another in a mesh network.

FIG. 39 is a schematic diagram of a modular satellite according to an embodiment of the present invention, shown including a light sensor having multiple filtering devices positioned in series to consecutively filter light.

FIG. 40 is a schematic diagram of a modular satellite according to an embodiment of the present invention, shown including an analytics generator.

FIG. 41 illustrates an embodiment of the lookup table in the mission operation identifier memory segment of the modular satellite of FIG. 40.

FIG. 42 illustrates an embodiment of the lookup table in the mission analytics packet priority memory segment of the modular satellite of FIG. 40.

FIG. 43 illustrates an embodiment of the packet catalogue in the mission analytics packet catalogue memory segment of the modular satellite of FIG. 40.

FIG. 44 is a flowchart illustration of a method aspect of an embodiment of the present invention for generating orbital mission analytics and for transmission from a modular satellite to a client terminal.

FIG. 45 is an exploded perspective view of a cube satellite with stacked circuit board subsystems and an integrated payload enclosure implementing an embodiment of the adaptive mission operation characterization system of the modular satellite of FIG. 40.

FIG. 46 is a perspective view of the thermal and radiation structure of the payload enclosure of FIG. 45.

FIG. 47 is an elevated perspective view of a modular satellite according to and embodiment of the present invention.

FIG. 48 is a schematic diagram of the modular satellite according to FIG. 47.

FIG. 49 is a schematic diagram of the modular satellite according to FIG. 47, and a modular satellite cooperation according to and embodiment of the present invention.

FIG. 50 is a schematic illustration of the modular satellite according to FIG. 47, shown with a counter force generated to counteract a movement force created by movement of cover members according to an embodiment of the present invention.

FIG. 51 is a perspective view of multiple modular satellites according to the modular satellite of FIG. 47, shown tracking stars.

FIG. 52-56 are flowcharts showing various method aspects of a modular satellite according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a modular satellite testing platform system 100 for housing payloads that may be installed in the modular satellite 100 to be sent into the orbit of earth for monitoring, testing, and data collection about the payload's exposure to the harsh environment of space and other readings of anomalies, phenomena, and objects visible from space via a variety of instruments and devices onboard the system.

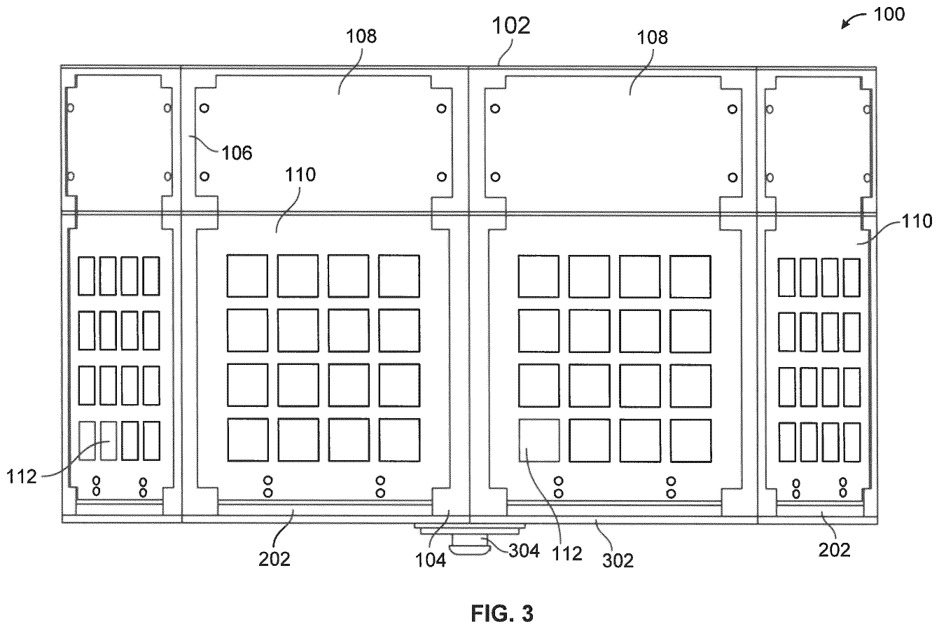

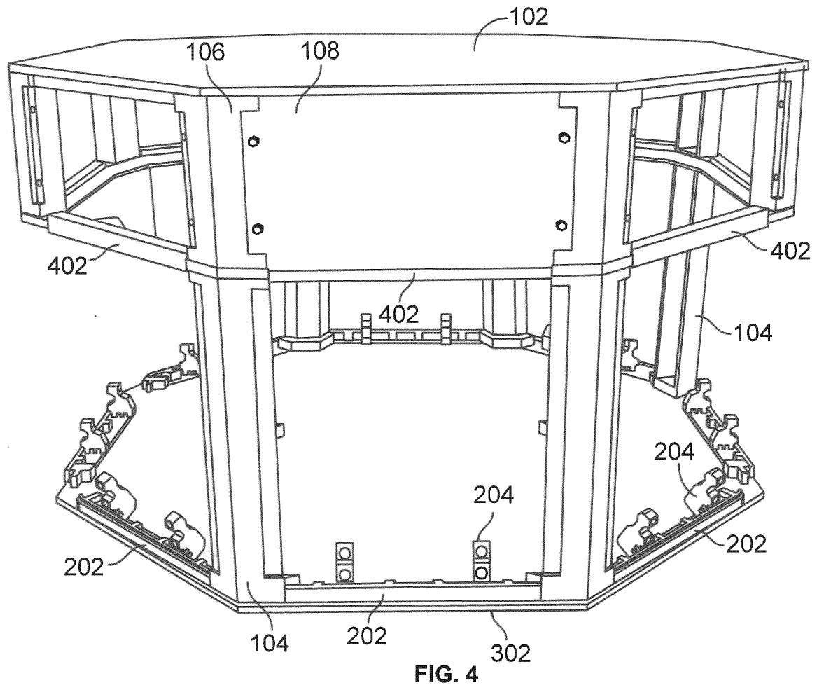

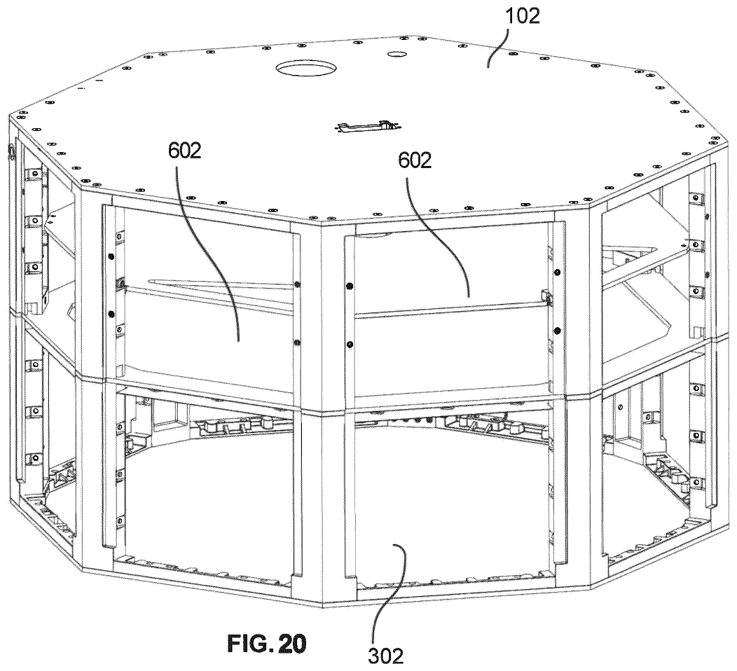

Referring now to FIGS. 3-4 and 15-21, a modular satellite testing platform system 1 according to an embodiment of the invention is presented. The modular satellite 100 may comprise of an upper member 102, a lower member 302, and a plurality of intermediate members 402. The intermediate members may be positioned between the upper member 102 and the lower member 302. The upper member 102, the lower member 302, and the plurality of intermediate members 402 may have a horizontal configuration, i.e., the upper member 102, the lower member 302 and the intermediate members 402 may all be configured in the same plane. The modular satellite 100 may also comprise of a plurality of lower support members 104, a plurality of upper support members 106, and a plurality of lower bar members 202. The lower support members 104 may be connected to and extend between the lower member 302 and the intermediate members 402. More specifically, the lower support members 104 may have a configuration that is substantially normal to the lower member 302 and the plurality of intermediate members 402. The plurality of upper support members 106 may be connected to and extend between the intermediate members 402 and the upper member 102. The plurality of upper support members 106 may have a configuration that is substantially normal to the plurality of intermediate members 402 and the upper member 102. The plurality of lower bar members 202 may be connected to and extend between a pair of the lower support members 104. More specifically, one of the plurality of lower bar members 202 extends between a pair of lower support members 104. Further, the plurality of lower bar support members 202 are configured normal to the lower support members 104 and in a parallel configuration to the lower member 302. The lower bar members 202 may be affixed to either the lower member 302 or the lower support members 104, or both the lower member 302 and the lower support members 104.

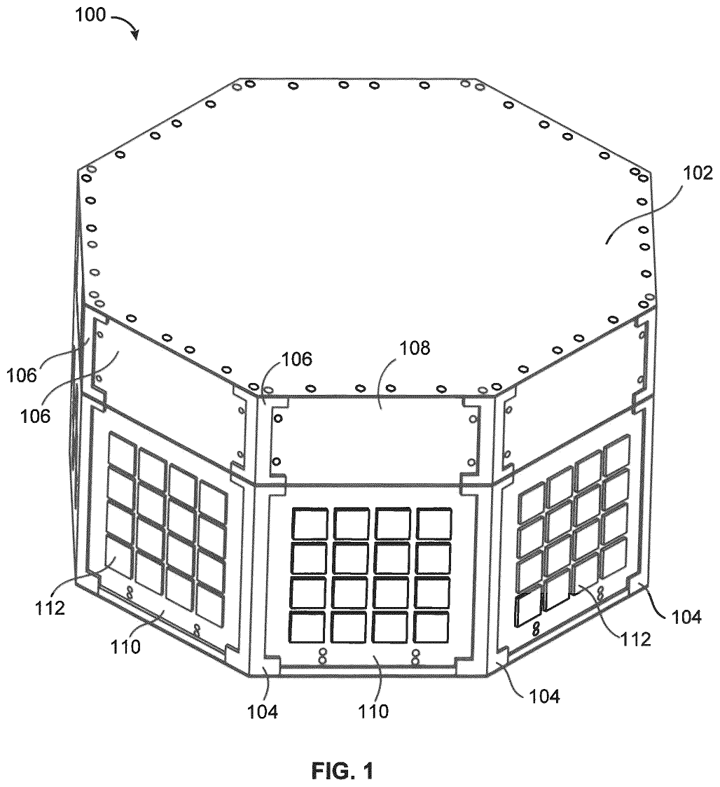

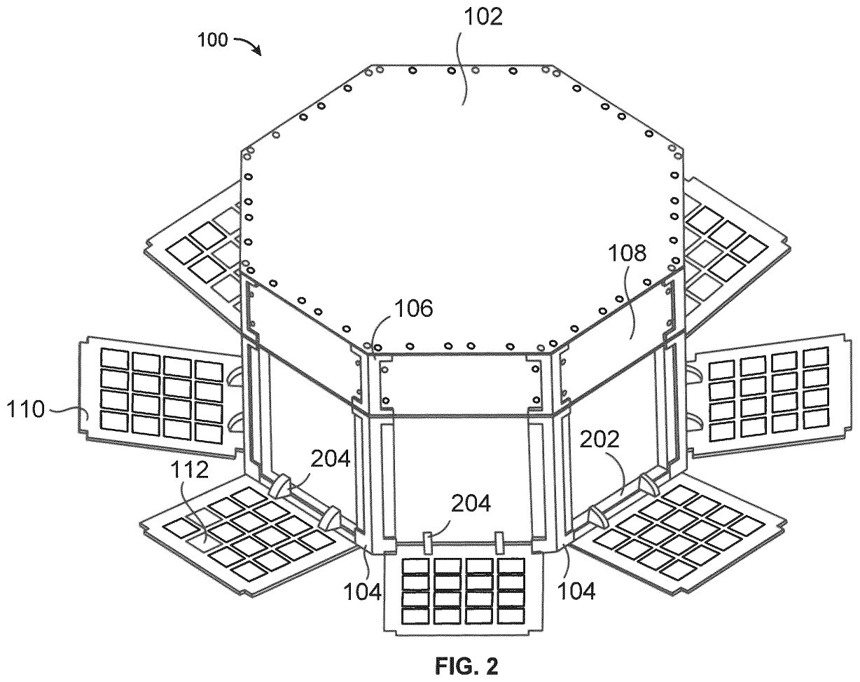

Now specifically referring to FIGS. 2, 17, and 21, the modular satellite 100 may further comprise of a plurality of hinge members 204 and a plurality of bottom cover members 110. The hinge members 204 may be affixed to the lower member 302 and/or the lower bar members 202. The modular satellite 100 may also comprise a plurality of bottom cover members 110 that may be affixed to one end of the hinge members 204. In FIG. 2, the bottom cover members 110 are shown in an opened position. In FIG. 1, the bottom cover members 110 are shown in a closed position. The bottom cover members 110 are moveable between the opened position and the closed position. As illustrated, the closed position of the bottom cover members 110 is defined as the bottom cover members 110 being in a position to enclose interior portions of the modular satellite 100, and the opened position of the bottom cover members 110 is defined as the bottom cover members 110 being in a position so that interior portions of the modular satellite 100 are exposed and/or accessible. Those skilled in the art will appreciate that the open position may also include any position of the bottom cover members 110 where the interior portions of the modular satellite 100 are significantly exposed, and the closed position may include any position of the bottom cover members 110 where the interior portions of the system are significantly unexposed.

As perhaps best illustrated in FIGS. 1-6, the modular satellite 100 may comprise of a plurality of upper cover members 108 that may be connected to and extending between an adjacent pair of upper support members 106. The upper cover members 108 may be attached to the upper support members 106, intermediate members 402, and/or the upper member 102.

Referring now to FIGS. 3-5, the modular satellite 100 may include a plurality of lower bar members 202. The lower bar members 202 may be configured to extend between the lower support members 104 and be connected to the lower support members 104 and/or the lower member 302.

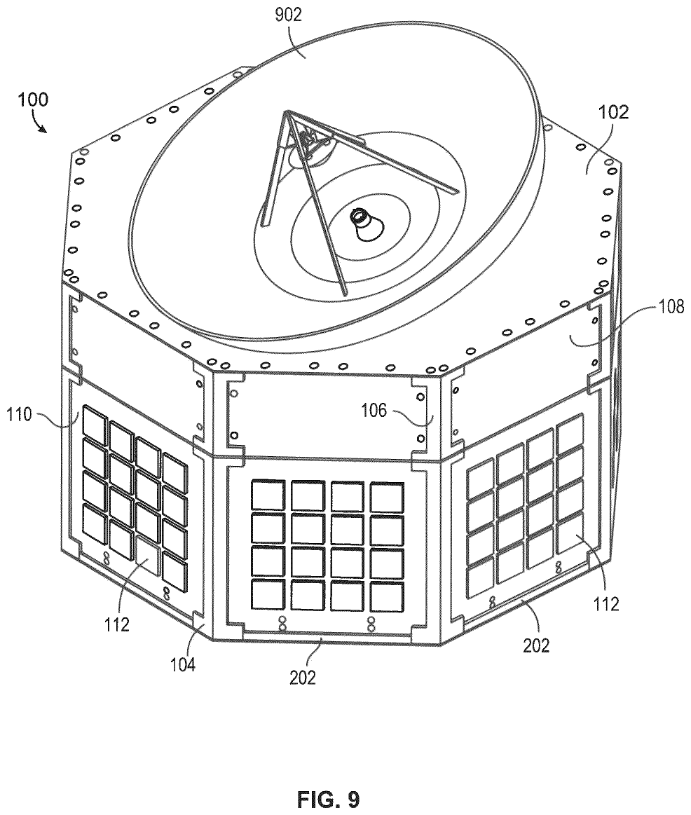

Referring now to FIG. 9, the modular satellite 100 may comprise an antenna 902 that may be attached to an outside face of the upper member 102. The antenna 902 depicted in FIG. 9 is a satellite dish type of antenna, but those skilled in the art will appreciate that the antenna 902 may be provided by any type of antenna such as, for example, a wire antenna, a horn antenna, a reflector antenna, an array antenna, a parabolic reflector antenna, a parabolic reflector antenna with offset feed, a double reflector antenna, a shaped reflector antenna, a conical horn antenna, or any other type of antenna as may be understood by those skilled in the art. The antenna 902 may be configured to be in communication with other devices (not shown) to send and receive computer readable information, data, and/or code. The other devices may include, but are not limited to, personal computers, tablet computers, communication towers, other satellites, antennas, cellular devices, radio communication devices, or other devices capable of wireless communication with the antenna 902 as may be understood by those skilled in the art. The antenna 902 may be configured to facilitate communication by a wide range of mediums of information transfer, including but not limited to radio waves, microwaves, visible light, or infrared waves. Those skilled in the art will notice and appreciate that a wide range of mediums of information transfer may be used for the communication configuration of the antenna 902 while accomplishing all the goals, features, and advantages of the present invention. Further details about the antenna 902 are given below.

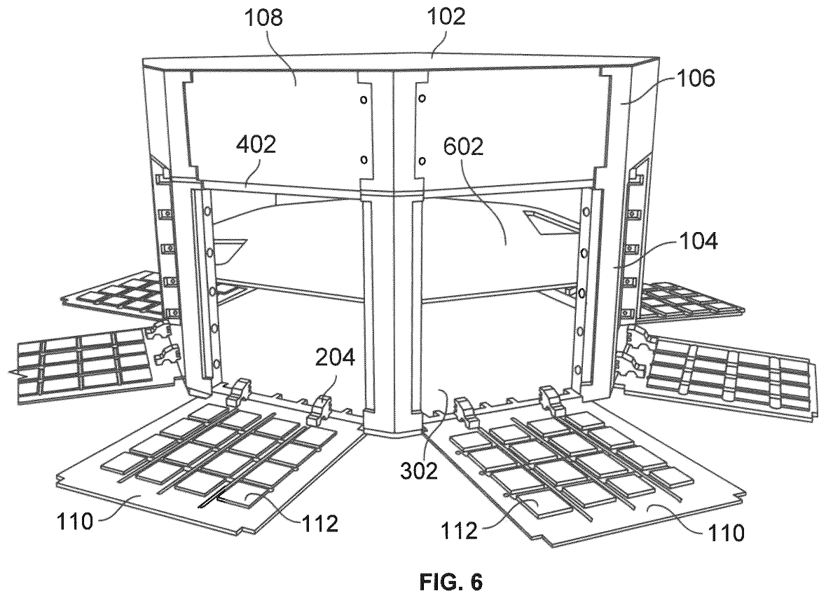

Now referring to FIGS. 6 and 20-21, the modular satellite 100 may comprise a plurality of shelf members 602. The shelf members 602 may be attached to and carried by the lower support members 104, the upper support members 106, the intermediate members 402, the lower member 302, or the lower bar members 202. The shelf members 602 may be adapted to facilitate attachment, connection, and/or fixation or various components, devices, and/or mechanisms as understood by those skilled in the art.

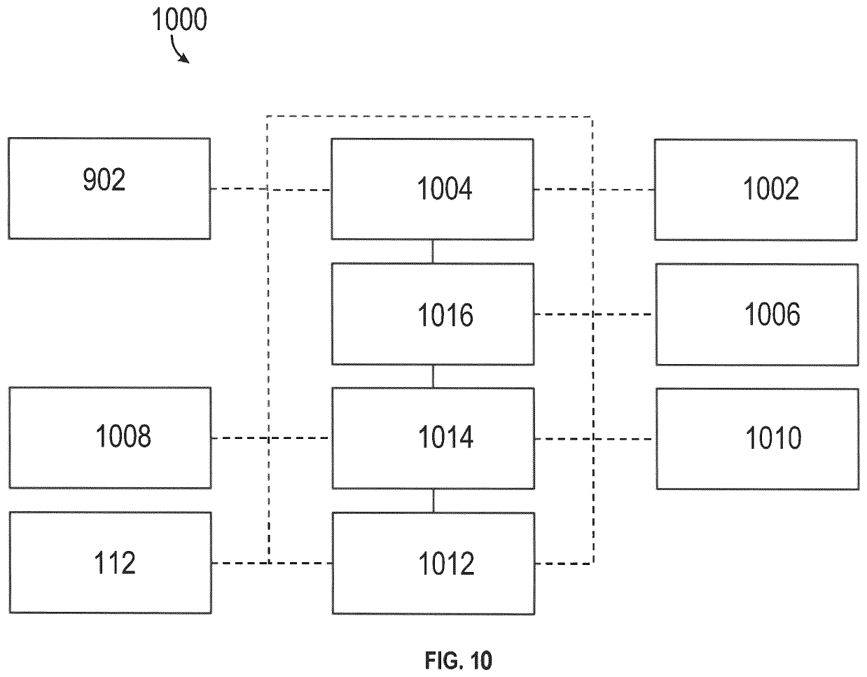

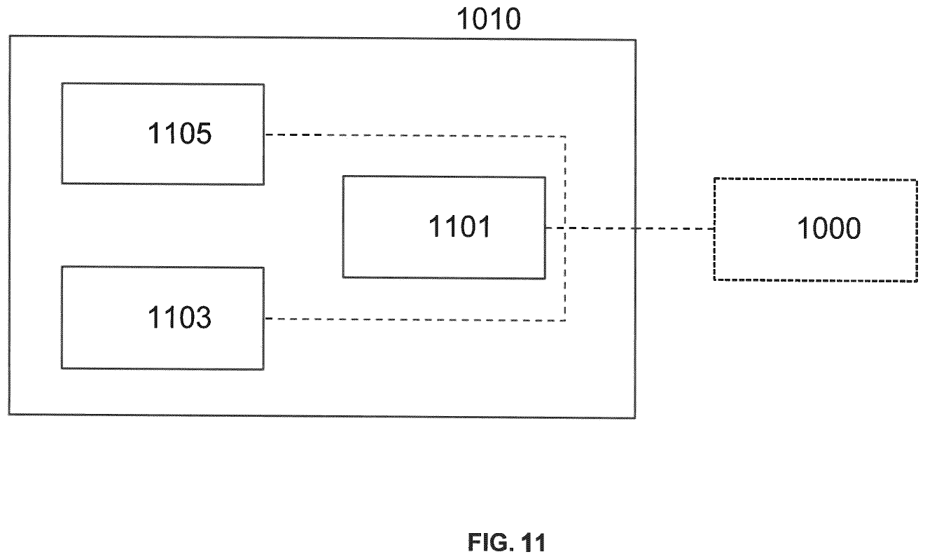

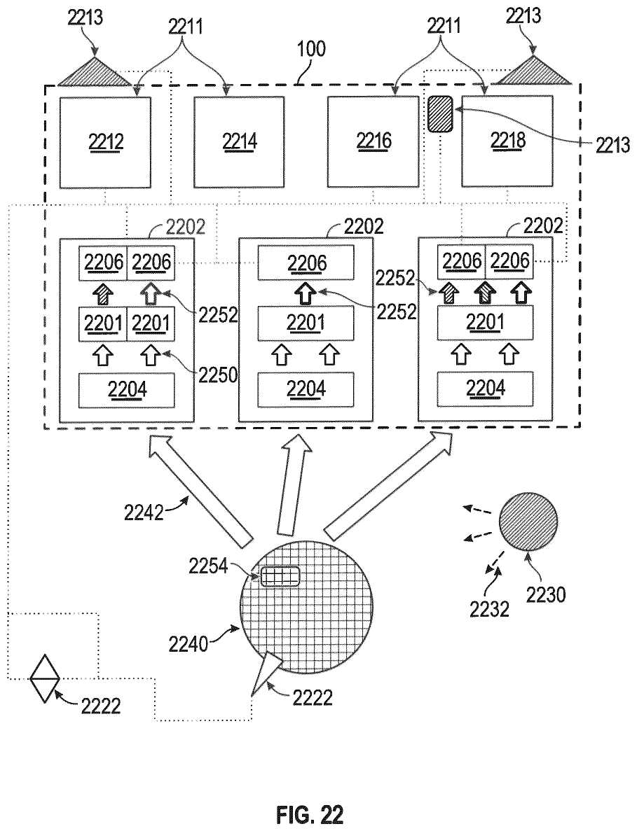

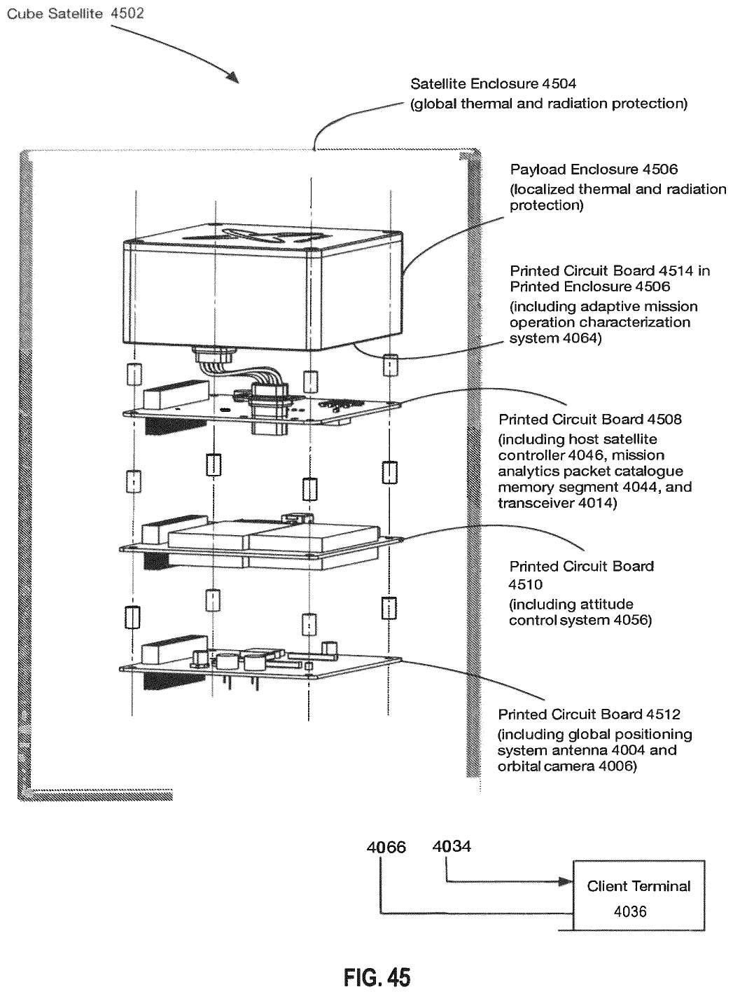

Referring now to FIG. 45, the modular satellite 100 according to an embodiment of the present invention, such as, the embodiments of the modular satellite 100 illustratively shown in FIGS. 10, 22, and/or 40, may be configured as a cube satellite 4502. The cube satellite 4502 may include a satellite enclosure 4504 and/or a payload enclosure 4506. The satellite enclosure 4504 may be stacked with the payload enclosure 4506 and/or stacked with one or more printed circuit board subsystems 4508, 4510, and 4512. The printed circuit board subsystems 4508, 4510, and 4512 may include one or more of the components shown and described herein for one or more of the embodiments of the modular satellite 100. However, in some embodiments of the modular satellite 100, one or more of the components thereof may not be carried by one of the printed circuit board subsystems 4508, 4510, 4512. For example, without limitation, in some embodiments of the present invention, one or more of the components, such as an adaptive mission operation characterization system 4064, may not be carried by one of the printed circuit board subsystems 4508, 4510, 4512. More detail on the adaptive mission operation characterization system 4064, the satellite enclosure 4504, the payload enclosure 4506, and the embodiments of the present invention illustrated in FIGS. 10, 22, and 40 follows further below.

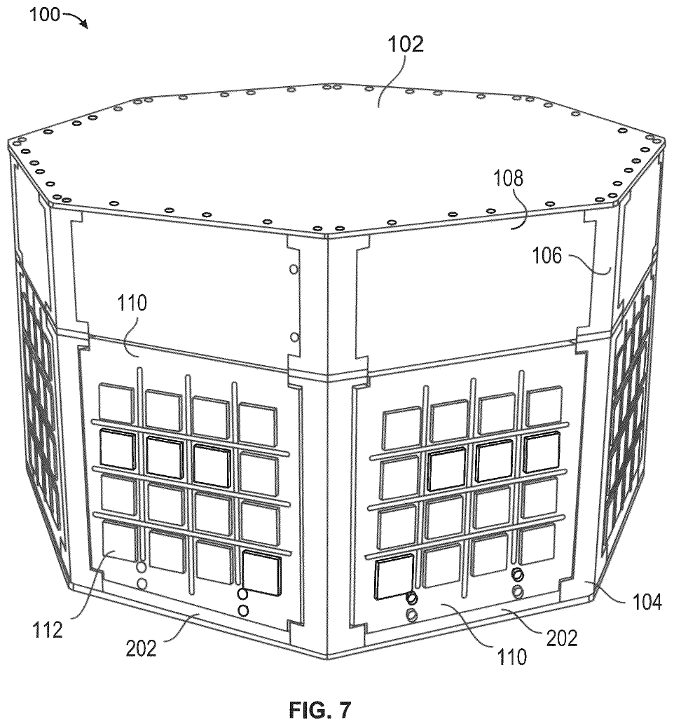

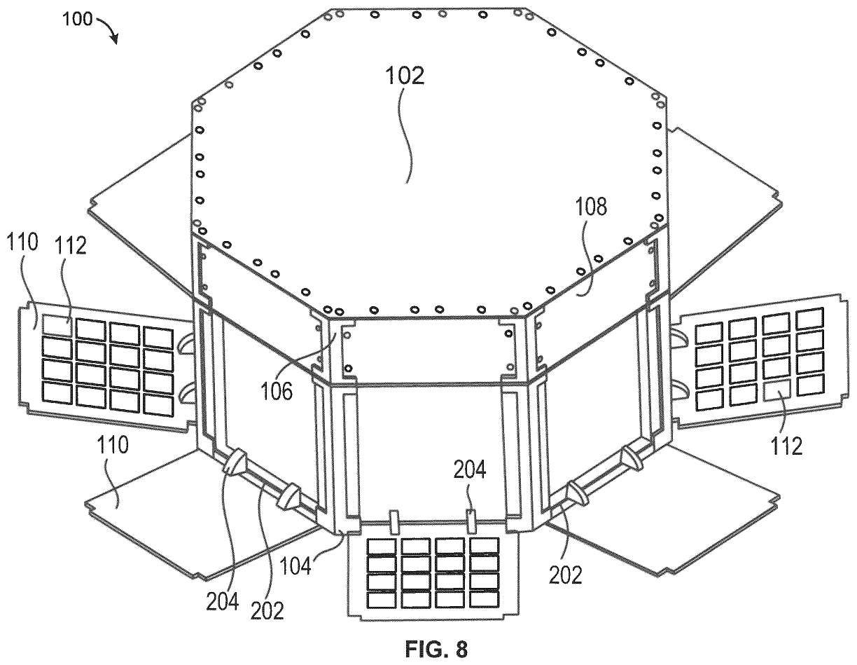

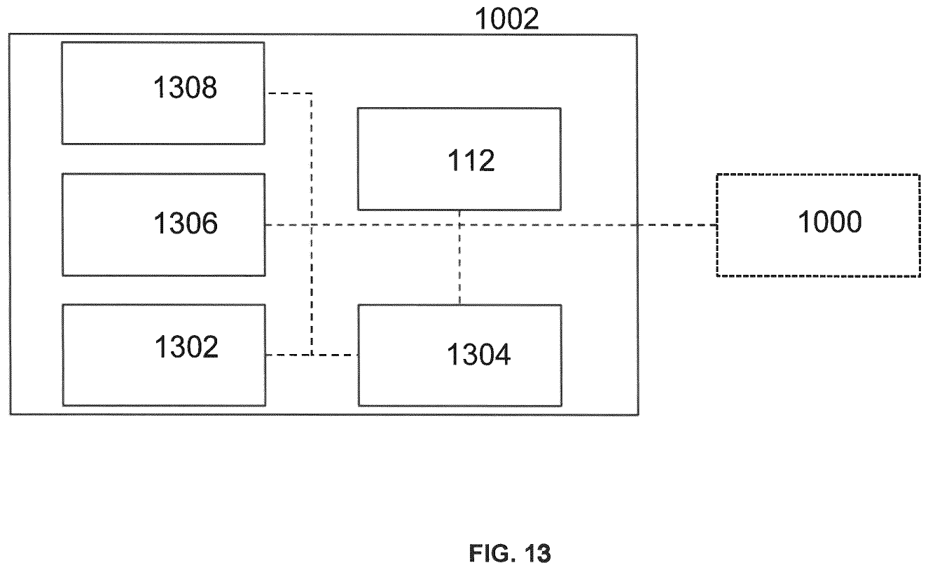

Referring now to FIGS. 1-3, 6-9, 13, 16-19, and 21, the modular satellite 100 may also include a power unit 1002 that may include a plurality of photovoltaic members 112. The photovoltaic members 112 may be attached to the bottom cover members 110. The attachment of the photovoltaic members 112 to the bottom cover members 110 may be on an outside face or an inside face of the bottom cover members 110, or on both the inside and outside face of the bottom cover members 110. The photovoltaic members 112 may be placed on one or more of the bottom cover members 110. The photovoltaic members 112 of the power unit 1002 may be configured to be in communication with one or more power storage units 29 that are onboard the modular satellite 100 illustratively shown in FIGS. 10 and 13. The photovoltaic member 112 may be configured so that they are operable to charge power storage units 29. Further details about the photovoltaic members 112 and the power storage units 29 follow below.

Referring specifically now to FIGS. 3, 17-18, and 21, the modular satellite 100 may include a space deployment arm attachment member 304. The space deployment arm attachment member 304 may be attached to an outside face of the lower member 302 and be configured to allow the grasping of the space deployment arm attachment member 304 by a space deployment arm so that the modular satellite 100 may be manipulated, handled, and/or launched in space. In some embodiments of the present invention the attachment member 304 may be attached to an outside face of the upper member 102, or there may be a first attachment member 304 attached to an outside face of the lower member 302 and a second attachment member 304 attached to an outside face of the upper member 102.

The attachment member 304 may be configured to be grasped and manipulated by a robotic space arm (not shown) that may be attached to a device in space (not shown). For example, without limitation, the device in space may be a space station, a satellite, a shuttle (or other vehicle), a rocket, a space pod, or any other device as understood by those skilled in the art that is capable of being placed in space to deploy a satellite and/or an embodiment of the present invention. The robotic space arm may comprise of a space station integrated kinetic launcher for orbital payload system (SSIKLOPS) or other robotic space arm or other device as understood by those skilled in the art that is capable of grasping and/or manipulating the attachment member 304 and/or the modular satellite 100. The attachment member 304 may be inserted into the robotic space arm for the robotic space arm to fixedly attach to or matingly engage the attachment member 304. The engagement of the robotic space arm with the attachment member 304 may be controllably releasable by the robotic space arm.

In some embodiments of the present invention the upper member 102, the lower member 302, the intermediate members 402, the lower support members 104, the upper support members 106, the upper cover members 108, the lower bar members 202, the hinge members 204, the bottom cover members 110, the space deployment arm attachment member 304, and the shelf members 602 may be made by a three-dimensional (3D) printing process such as, but not limited to, by continuous fiber fabrication (CFF). More specifically, CFF creates continuous layers of fiber using a 3D printing material to create components and/or objects. The 3D printing material may comprise a composite material that may have an onyx filament (nylon mixed with carbon fiber), carbon fiber, Kevlar, and/or fiberglass. Preferably, the 3D printing material used is the onyx filament for its advantageous properties. For example, components made with the 3D CFF onyx filament are advantageously stronger than type 6061 aluminum and about 40% lighter, while also having advantageous heat resistance, chemical resistance, and a smooth surface finish.

Those skilled in the art will notice and appreciate that using a 3D printed material for the upper member 102, the lower member 302, the intermediate members 402, the lower support members 104, the upper support members 106, the upper cover members 108, the lower bar members 202, the hinge members 204, the bottom cover members 110, the space deployment arm attachment member 304, and the shelf members 602 is also advantageous by allowing for fast turnover times from, when choosing which embodiment of the present invention is desired, and to having the chosen embodiment since 3D printing machines are highly configurable for implementing changes in creating/manufacturing components and/or objects. Furthermore, those skilled in the art will notice and appreciate that it is advantageous to use a 3D printing process to create the upper member 102, the lower member 302, the intermediate members 402, the lower support members 104, the upper support members 106, the upper cover members 108, the lower bar members 202, the hinge members 204, the bottom cover members 110, the space deployment arm attachment member 304, and the shelf members 602 so that one or a few 3D printing machines may be used to manufacture one or more of the components, members, and/or objects as described herein of an embodiment of the present invention rather than having to use multiple manufacturing machines that have less output configurability than a 3D printing machine. This is especially advantageous if multiple or many different embodiments of the present invention vary in demand, need, and/or market forces.

Those skilled in the art will notice and appreciate that the upper member 102, the lower member 302, the intermediate members 402, the lower support members 104, the upper support members 106, the upper cover members 108, the lower bar members 202, the hinge members 204, the bottom cover members 110, the space deployment arm attachment member 304, and the shelf members 602 may be made in whole or in part by continuous fiber fabrication (CFF) three-dimensional (3D) printing with micro-carbon fiber filled nylon composite material filament or made out of any other material as understood by those skilled in the art while still accomplishing all of the goals, features, and advantages of the present invention. For example, without limitation, metals, composites, plastics, ceramics, and silicone materials either in whole or in part.

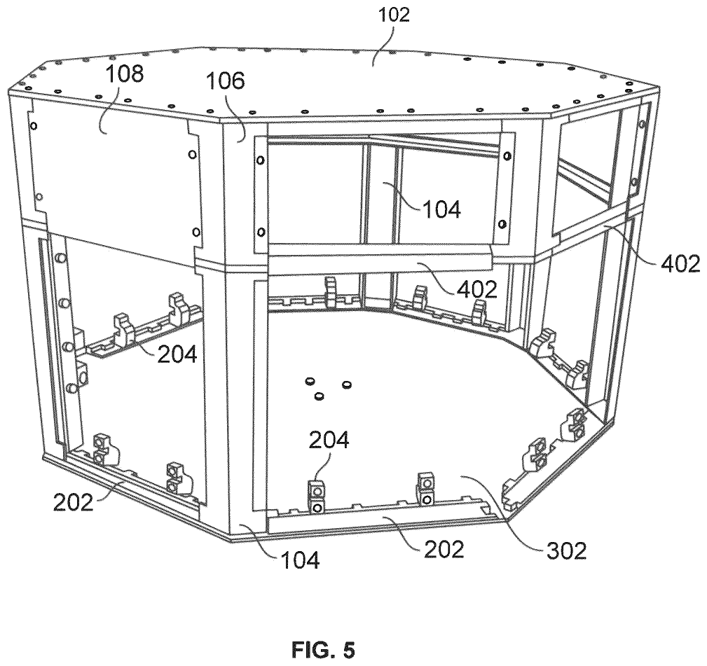

Referring now to FIG. 5, in some embodiments of the present invention the upper member 102 and the lower member 302 may illustratively be provided to have an octagonal shape. Those skilled in the art will appreciate, however, that the upper member 102 and the lower member 302 may be in a variety of different shapes while still accomplishing all the features, advantages, and goals of the present invention. Although an octagonal shape is shown in the appended figures, the present invention is not meant to be limited to an octagonal shape but may have any other shape as needed and/or required.

Referring now to FIG. 10, the modular satellite 100 may generally include a power unit 1002, a non-transitory computer readable memory 1012, a processor 1014, a hardware communication component 1016, a communications system 1004, a propulsion system 1006, a thermal control system 1010, a camera 1008, a photovoltaic member 112, and an antenna 902. Each of these components may be referred to herein separately or may collectively (or any number of components in combination) be referred to as electronic components 1000 of the modular satellite 100 according to the present invention.

The power unit 1002 may be connected to the non-transitory computer readable memory 1012, a processor 1014, a hardware communication component 1016, a communications system 1004, a propulsion system 1006, a thermal control system 1010, a camera 1008, a photovoltaic member 112, and an antenna 902 to supply, maintain, and control the electric power of the modular satellite 100. The power unit 1002, as illustratively shown, for example, in FIG. 13, may include one or more of a power distribution system 1308, a power generator 1302, a power management system 1306, and a power storage unit 1304 onboard the modular satellite 100. The power distribution system 1308 may be positioned in communication with the electronic components 1000 of the modular satellite 100 to distribute power and may be controlled by the processor 1014, the communications system 1004, or the power management system 1306 to control the power that is distributed to the electronic components 1000 of the modular satellite 100. The power generator 1302 may be used as a main, secondary, temporary, or emergency source of power for the modular satellite 100.

The power generator 1302 may be in communication with the power management system 1306, the power distribution system 1308, the power storage unit 1304, the processor 1014, the communications system 1004, and/or the antenna 902. The power generator 1302 may be adapted to be controlled by the power management system 1306, power distribution system 1308, the power storage unit 1304, processor 1014, communications system 1004, and/or the antenna 902 for automatic and/or manual activation, deactivation, and/or regulation. The power management system 1306 may be positioned in communication with the electronic components 1000 of the modular satellite 100, and may be adapted to regulate and/or monitor the electric power used, consumed, and supplied to the electronic components 1000 of the modular satellite 100.

The power storage units 29 may be in communication with the electronic components 1000 of the modular satellite 100. The power storage units 29 may be configured to supply electric power to the electronic components 1000 of the modular satellite 100, and may also be configured to be charged by the electronic components 1000 of the modular satellite 100 and to retain the charge received from the electronic components 1000 of the modular satellite 100. Specifically, the power storage units 29 may be charged by the photovoltaic member(s) 112, the power distribution system 1308, the power management system 1306, and the power generator 1302.

The power storage units 29 may comprise of a variety of different devices that store energy that may be used as an electrical power supply and that may be rechargeable, such as, without limitation, lead-acid batteries, nickel-cadmium batteries, nickel-metal hydride batteries, and/or lithium-ion batteries. Those skilled in the art will notice and appreciate that a variety of different devices that can store power may be used as the power storage units 29 while still accomplishing all the goals, features, and advantages of the present invention.

Continuing to reference FIG. 10, the non-transitory computer readable memory 1012 may be configured to be in communication with the processor 1014. The non-transitory computer readable memory 1012 may be configured to store computer-readable instructions or code for access and use by the processor 1014 and/or the electronic components 1000 of the modular satellite 100. The non-transitory computer-readable memory 1012 can be provided by a plurality of types of computer-readable memories. For example, without limitation, random access memory (RAM), static random-access memory (SRAM), dynamic random-access memory (DRAM), read-only memory (ROM), erasable programmable read-only memory (EPROM), electronically erasable programmable read-only memory (EEPROM), and marked read-only memory (MROM). Those skilled in the art will recognize and appreciate that the non-transitory computer readable memory 1012 can be provided for by a plurality of different types of computer-readable memories while still accomplishing at the features, goals, and advantages of the present invention.

The processor 1014 of the modular satellite 100 may be positioned in communication with the hardware communication component 1016, the communications system 1004, the antenna 902, the propulsion system 1006, the thermal control system 1010, the camera 1008, the photovoltaic member 112, the power unit 1002, and/or the non-transitory computer readable memory 1012. The processor 1014 may be used as the component that processes the commands, instructions, and signals to be received, transmitted, and computed by the electronic components 1000 of the modular satellite 100. Processors that may be used for example, without limitation, a microprocessor, microcontroller, embedded processor, and/or a digital signal processor. Those skilled in the art will appreciate that a plurality of different processors may be used as the processor 1014 for the modular satellite 100 while still accomplishing all the goals, features, and advantages of the present invention.

The hardware communication component 1016 may be positioned in communication with the communications system 1004, the propulsion system 1006, the thermal control system 1010, the antenna 902, the camera 1008, the photovoltaic member 112, the processor 1014, the non-transitory computer readable member 3024, and the power unit 1002. The hardware communication component 1016 may be used as the hub for receiving, directing, and managing the flow of computer-readable information and instructions to and/or from the electronic components 1000 of the modular satellite 100. The connections to and from the hardware communication component 1016 may be either through wired or wireless technology. For example, without limitation, the connection may be by land-line, ethernet, fiber-optic, Wi-Fi, or Bluetooth. Those skilled in the art will recognize and appreciate that there are a variety of different ways the hardware communication component 1016 may be connected in communication with the electronic components 1000 of the modular satellite 100 while accomplishing all the features, goals, and advantages of the present invention.

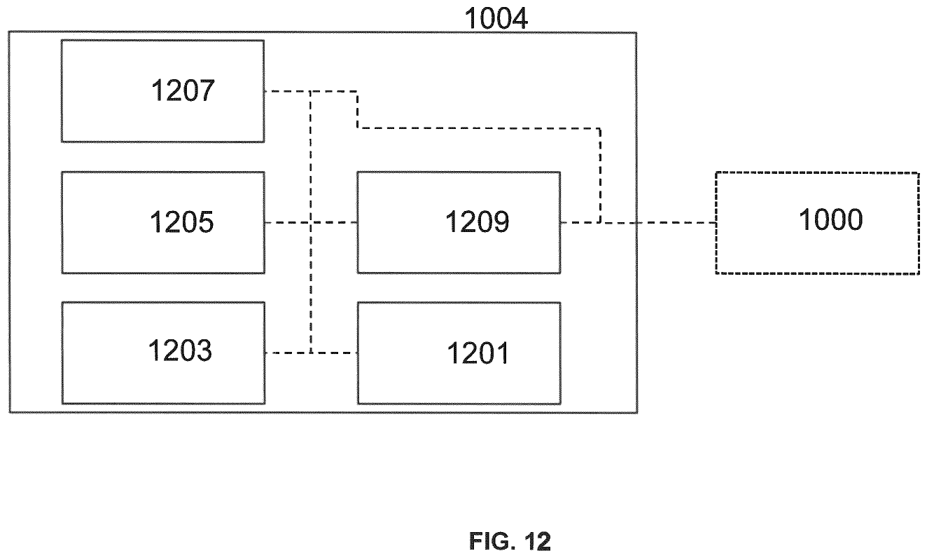

Referring now specifically to FIGS. 10 and 12, the communications system 1004 may be positioned in communication with the hardware communication component 1016, the processor 1014, the non-transitory computer readable memory 1012, the antenna 902, the propulsion system 1006, the thermal control system 1010, the camera 1008, and the photovoltaic member 112. The communications system 1004 may include a reaction wheel 1207, a star tracker 1205, a magnetorquer 1209, a global positioning satellite transceiver 1201, and a transponder 1203. Each of the reaction control wheel 1207, the star tracker 1205, the magnetorquer 1209, the global positioning satellite transceiver 1201, and the transponder 1203 may be in communication with each other, i.e., all may be in communication with one another, or one or more may be in communication with one or more of each other. The communications system 1004 may be used to receive and transmit data and information to and from the modular satellite 100 and other communication devices (not shown). The other communication devices may include, without limitation, antennas, space stations, communication towers, and other satellites or other devices capable of communication as understood by those skilled in the art.

The reaction wheel 1207 may be positioned in communication with the electronic components 1000 of the modular satellite 100. The reaction wheel 1207 may be configured to control the orientation of the modular satellite 100 while the modular satellite 100 is deployed in space either by automatic operation of the electronic components 1000 of the modular satellite 100 or by manual operation of a user communicating with the modular satellite 100 through the electronic components. The star tracker 1205 may be positioned in communication with the electronic components 1000 of the modular satellite 100 and configured to measure the positions of stars and export this data and receive data through the antenna 902, the transponder 1203, and/or the global positioning satellite transceiver 1201.

The magnetorquer 1209 may be positioned in communication with the electronic components 1000 of the modular satellite 100 and may be configured to control the attitude, tumbling, and/or stabilization of the modular satellite 100 unilaterally or by inputs from the electronic components 1000 of the modular satellite 100 or by manual user inputs a user inputs into the modular satellite 100 through the electronic components. The global positioning satellite (GPS) transceiver 1201 may be positioned in communication with the electronic components 1000 of the modular satellite 100 and may be configured to calculate, receive, and/or export data of the system's 1 geographical location either directly to or from a device (not shown) or through the electronic components 1000 of the modular satellite 100. The transponder 1203 may be positioned in communication with the processor 1014, the hardware communication component 1016, the antenna 902, and/or the communications system 1004. The transponder 1203 may be used to receive a signal and emit a same or different signal in response at a lower, same, or greater power level than the signal received by the transponder 1203.

The signals received and transmitted by the transponder 1203 may be of a variety of different types of signals, for example, without limitation, radio wave, microwave, infrared, or visible light signals. Those skilled in the art will recognize and appreciate that the transponder 1203 may be configured to receive and/or transmit a variety of different signal types while still accomplishing all the goals, features, and advantages of the present invention.

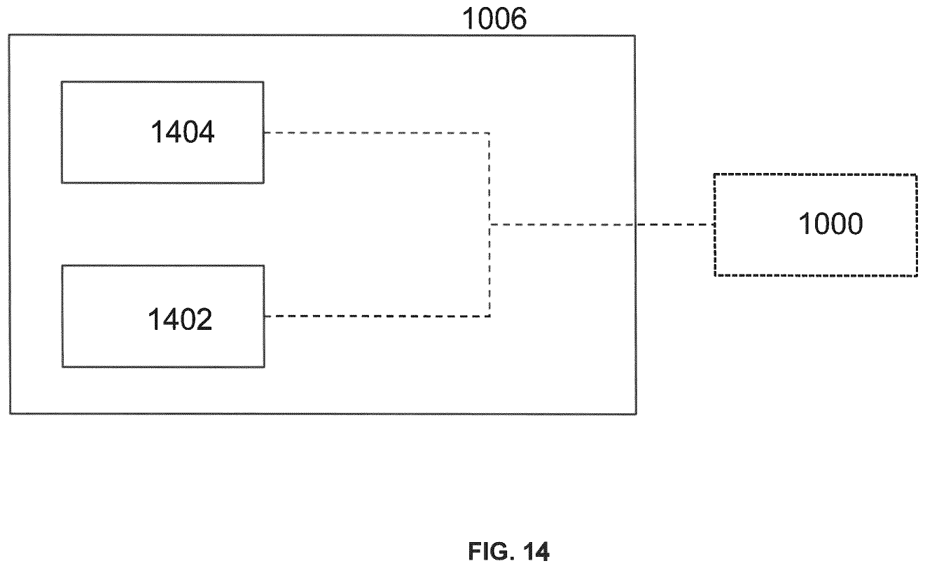

Now referring back to FIG. 10 and additionally to FIG. 14, the propulsion system 1006 may be positioned in communication with the processor 1014, the satellite antenna 902, the hardware communication component 1016, the camera 1008, and/or the communications system 1004. The propulsion system 1006 may be used to apply physical force to the modular satellite 100. The propulsion system 1 may include one or more thrusters 1402 and/or one or more pressure tanks 1404. The thrusters 1402 may be fluidically connected to the pressure tanks 1404 and the pressure tanks 1404 may be configured to house a medium or propellant that may be spent by the thrusters 1402 to create a thrust of force on the modular satellite 100. The thrusters 1402 may be affixed to a variety of locations on an outside surface of the modular satellite 100. The thrusters 1402 may be configured to directionally rotate or pivot about an axis to change the direction that the thrusters 1402 to change the directional orientation of the thrusters 1402 or the thrusters 1402 may be fixed and stationary so that the thrusters 1402 may not rotate or pivot about an axis. The thrusters 1402 may be configured to be controlled automatically by the processor 1014, the hardware communication component 1016, the communications system 1004, and/or the antenna 902. The thrusters 1402 may also be controlled by manual operation of a user by entering inputs through the modular satellite 100 via the communications system 1004, the antenna 902, the hardware communication component 1016, and/or the processor 1014.

Continuing to reference to FIG. 10 and additionally to FIG. 11, the thermal control system 1010 may be positioned in communication with the processor 1014, the hardware communication component 1016, the satellite 12, and/or the communications system 1004. The thermal control system 1010 may include one or more radiators 1105, heatsinks 1101, and/or heaters 1103. The radiators 1105 may be configured to transfer thermal energy to and/or from the modular satellite 100 through a variety of methods including, but not limited to, using a circulating flow of a medium to transfer, transport, and radiate thermal energy as infrared radiation or other form of energy. Those skilled in the art will appreciate that there are a number of different ways in which the radiators 1105 may transfer thermal energy to and/or from the modular satellite 100 while still accomplishing all the goals, features, and advantages of the present invention.

The heatsinks 1101 may be configured to absorb and/or dissipate thermal energy from the modular satellite 100. The heaters 1103 may be configured in communication with the power unit 1002 and/or the photovoltaic members 112 to transform electrical energy to thermal energy. The thermal control system 1010 may be attached to the upper member 102, the lower member 302, the intermediate members 402, the lower support members 104, the upper support members 106, the upper cover members 108, the lower bar members 202, the hinge members 204, the bottom cover members 110, and/or the shelf members 602.

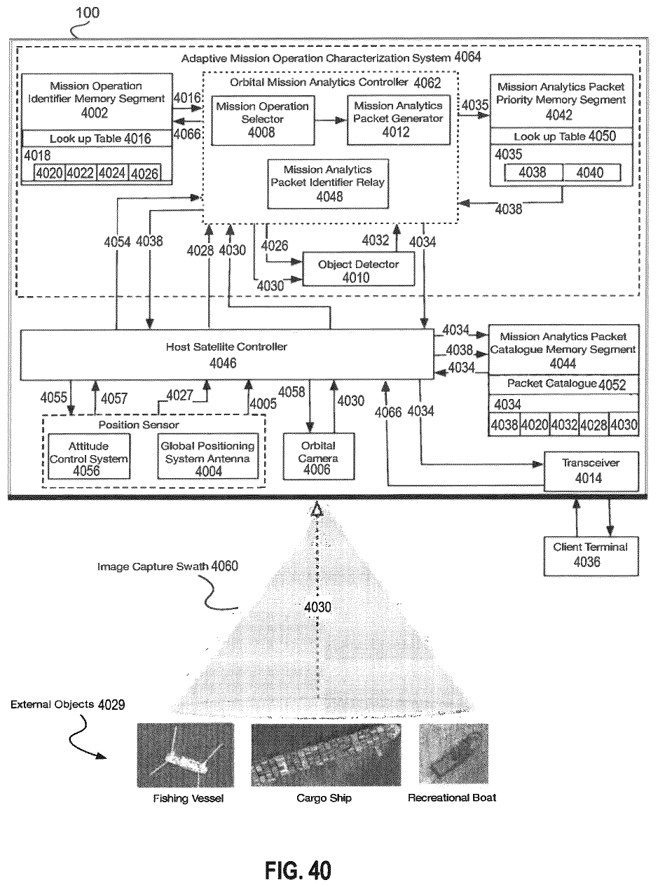

The thermal control system 1010 may also be attached to a payload (not shown) housed or installed in the modular satellite 100. Those skilled in the art will notice and appreciate that the thermal control system 1010 may be placed in a variety of locations throughout the modular satellite 100 to control the thermals of the modular satellite 100 and of the payload housed or installed into the modular satellite 100. Additionally, it is contemplated, without limitation, that in some embodiments of the present invention, that thermal control system 1010 may comprise one or more of, include one or more of the features of, and/or include one or more of the same or similar features as, a local thermal heatsink 4602, a local thermal heating pad 4604, and/or a local radiation shield 4606, described below and illustratively shown in FIG. 40. Additionally, the heatsinks 1101 may include, and/or be the same as or similar to the local thermal heatsinks 4602, and the heaters 1103 may include, and/or be the same as or similar to the local thermal heater pads 4604.

Referring specifically now to FIG. 10, the photovoltaic members 112 may be positioned in communication with the power unit 1002, the processor 1014, the camera 1008, the antenna 902, the communications system 1004, the hardware communication component 1016, the non-transitory computer readable memory 1012, the propulsion system 1006, and/or the thermal control system 1010. The photovoltaic members 112 may be configured to convert light energy into electrical energy to provide power to the modular satellite 100. The photovoltaic members 112 may be used as the main, secondary, or emergency source of power for the modular satellite 100. The photovoltaic members 112 may be configured so that they may be automatically or manually activated and/or deactivated for example, without limitation, when the power unit 1002 detects that the power storage units 29 are at full capacity it may send a signal to the photovoltaic members 112 to deactivate, or when the power unit 1002 detects that the power storage units 29 are less than fully charged the power unit 1002 may send a signal to the photovoltaic members 112 to activate. The photovoltaic members 112 may be, without limitation, monocrystalline silicon, polycrystalline silicon, passivated emitter and rear contact, or thin film photovoltaic devices. Those skilled in that art with identify and appreciate that a variety of types of photovoltaic devices and be used as the photovoltaic members 112 while still accomplishing all the features, advantages, and goals of the present invention.

Referring back to FIGS. 1 and 6, the modular satellite 100 may include a payload (not shown) that is housed by the system. The payload may include a variety of different objects, devices, and/or computer-readable information or code defined as modular payloads (not shown). The modular payloads may be attached to the shelf members 602, the lower support members 104, the upper support members 106, the intermediate support members 402, the upper member 102, the lower member 302, the bottom cover members 110, the lower bar members 202, or the upper cover members 108.

Now referring back to FIG. 10, if the modular payload is not a physical object but is instead computer-readable information or code, then the modular payload may be stored on the processor 1014, the hardware communication component 1016, the communications system 1004, the non-transitory computer readable memory 1012, the antenna 902, the camera 1008, the photovoltaic member 112, and/or the power unit 1002.

Continuing to reference FIG. 10, the electronic components 1000 of the modular satellite 100 may include a communication network (not shown) that may be in communication with the electronic components 1000 of the modular satellite 100, including, but not limited to, the communications system 1004, the antenna 902, the hardware communication component 1016, and the processor 1014. The communication network may also be in communication with other devices (not shown) that are not onboard the modular satellite 100, such as, without limitation, a personal computer, a tablet computer, a cellular device, a computer terminal, and/or any other device as understood by those skilled in the art that is capable of communication with the communication network.

The communication network may comprise of, without limitation, a satellite, an antenna, a communication tower, and/or a radio receiver or transceiver. Also, it should be understood, for the purposes of the description of the present invention, that reference to the processor 1014 may be used to refer to the processor 1014, the hardware communication component 1016, and/or the non-transitory computer-readable memory 1012, collectively, individually, and/or in any combination(s) thereof as may be understood by those who may have skill in the art. Additionally, in some embodiments of the present invention, without limitation, the processor 1014 may comprise and/or include one or more of the hardware communication component 1016, and/or the non-transitory computer-readable memory 1012.

Continuing to reference FIG. 10, the modular satellite 100 may include a camera 1008 that may be positioned in communication with the power unit 1002, the photovoltaic members 112, the processor 1014, the hardware communication component 1016, the communications system 1004, the antenna 902, and/or the non-transitory computer readable memory 1012. The camera 1008 may be configured to take images or videos that may be stored in the non-transitory computer readable memory 1012 as computer readable instructions or code. The camera may also be configured to send the images or videos to a device (not shown) through the communication network (not shown) via the antenna 902, the communications system 1004, the hardware communication component 1016, and/or the processor 1014. The camera 1008 may be configured to take images and/or videos of different spectrums of light such as, without limitation, x-ray, infrared, visible light, gamma rays, radar, and/or ultraviolet.

The modular satellite 100 and/or the attachment member 304 may be configured to have the robotic space arm release, launch, or push the modular satellite 100 or attachment member 304 so that the modular satellite 100 may be placed into space and/or the orbit of earth. The modular satellite 100 may be released, launched, or pushed by the robotic space arm releasing the attachment member 304, by the robotic space arm releasing the attachment member 304 and applying force against the attachment member 304 or the modular satellite 100, and/or by the robotic space arm releasing the attachment member 304 and force is applied on the modular satellite 100 by the propulsion system 1006. The force applied against the attachment member 304 or system 1 by the robotic space arm may be through the use of spring assisted hinged petals.

The modular satellite 100 and the electronic components 1000 of the modular satellite 100 may be controlled and communicated with by other devices (not shown). The other devices may be located on earth, in space, or anywhere in between earth and space. For example, without limitation, the modular satellite 100 may be controlled by a ground base station, a satellite, a space station, and/or any device as understood by those skilled in the art that may be used to communicated and control the modular satellite 100. The other devices may communicate with the electronic components 1000via the communication network (not shown), or through direct communication to and from the electronic components. The other devices, electronic components, and the communication network may and in communication with one another through various ways including, but not limited to, landline, DSL, Wi-Fi, Bluetooth, radio, microwave, fiber optic, ethernet, cable, or other way of connection and communication as understood by those skilled in the art.

The modular satellite 100 may be configured to be carried into space as cargo onboard the payload of a separate vehicle. The modular satellite 100 may be configured to be carried into space by a rocket, shuttle, air-launch-to-orbit vehicle, spaceplane, and/or any other launching device as understood by those skilled in the art that is capable of carrying a payload to space, the orbit of earth, and/or to an atmosphere of earth.

The modular satellite 100 may comprise a multilayer insulation (not shown) used throughout the apparatus to increase regulation and control over temperatures of the satellite testing platform system. The insulation may be a multilayer or single layer insulation and may be of a type of insulation as understood by those skilled in the art that may be used in the vacuum of space.

The modular satellite 100 may also comprise of a thermal coating (not shown) painted onto various locations of the modular satellite 100 to further increase regulation and control over the temperatures of the satellite testing platform system. The thermal coating may be used to affect reflection and absorption of various spectrums of light, for example, without limitation, visible light, radio-waves, gamma radiation, and ultraviolet light.

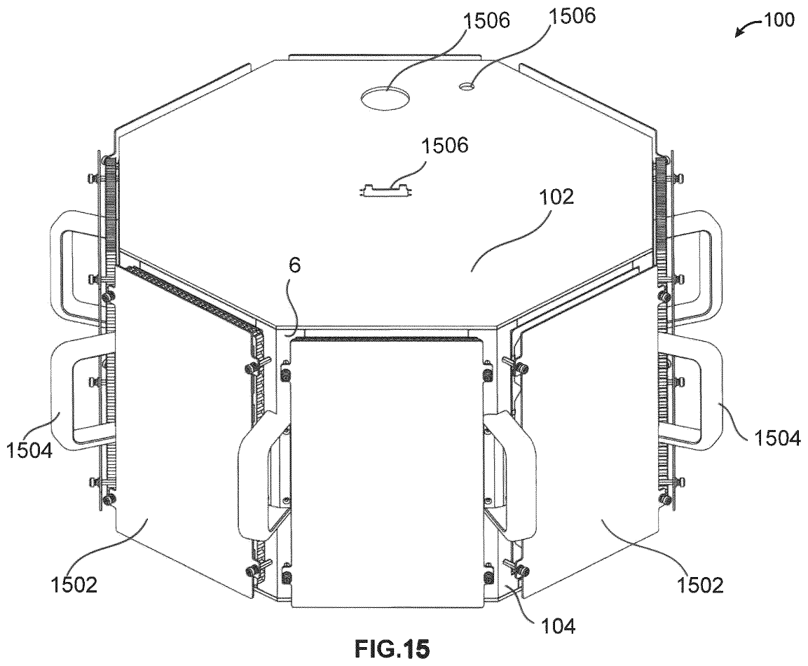

Referring now to FIG. 15, an embodiment of the present invention may include one or more U-shape members 1504, cover members 1502, and/or one or more through channels 1506. The cover members 1502 may be positioned to overlay the bottom cover members 110 and may cover the photovoltaic members 112 that are located on the bottom cover member 110. The cover members 1502 may be used to provide protection for the bottom cover members 110 and the photovoltaic members 112. The cover members 1502 may be attached to the upper support members 106, lower support members 104, upper member 102, and/or the lower member 302. The U-shape members 1504 may be adapted to be removed from the upper support members 106, lower support members 104, the upper member 102, and/or the lower member 302 after having been attached thereto.

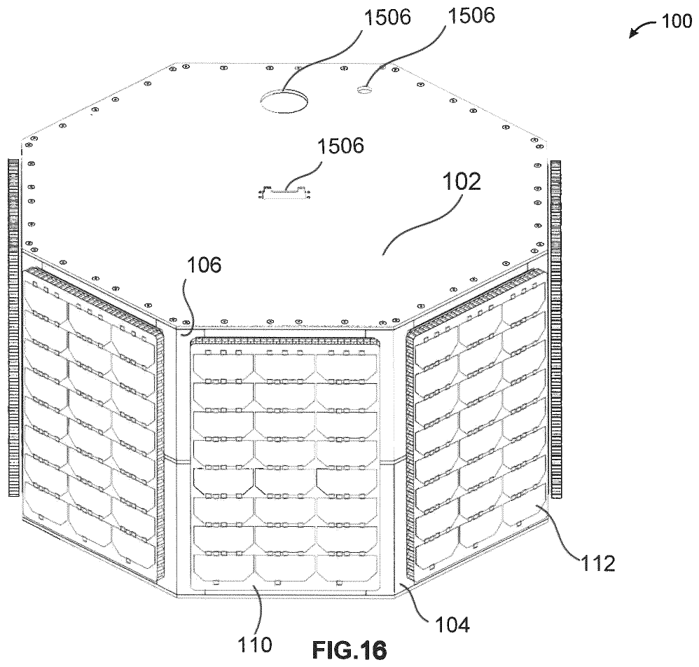

Now additionally referring to FIGS. 16 and 19-20, the through channels 1506 may be positioned on a face of the upper member 102 and/or the lower member 302. The through channels 1506 may be used to allow connections to travel through the upper member 102 and/or the lower member 302. The through channels 1506 may also be adapted to facilitate the attachment of a variety of components or members. For example, without limitation, the satellite antenna 902.

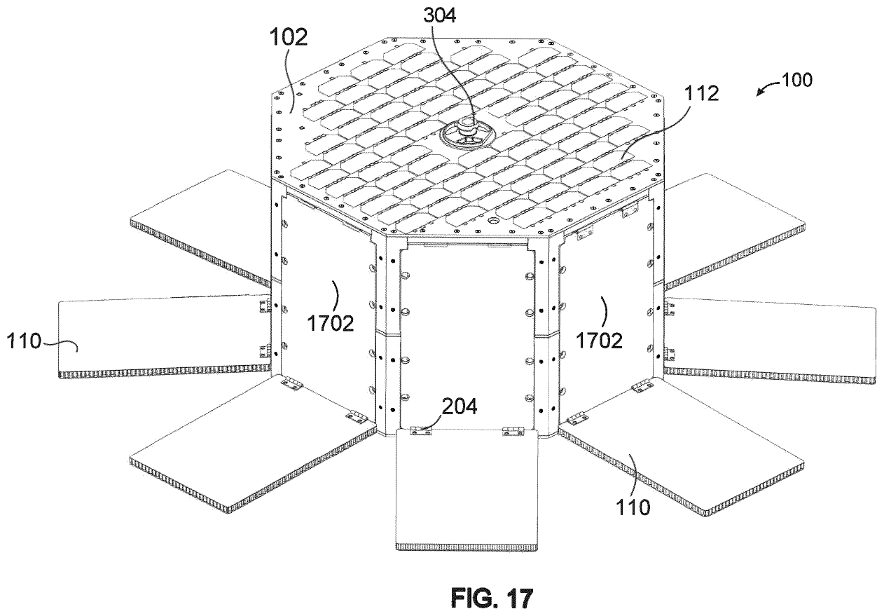

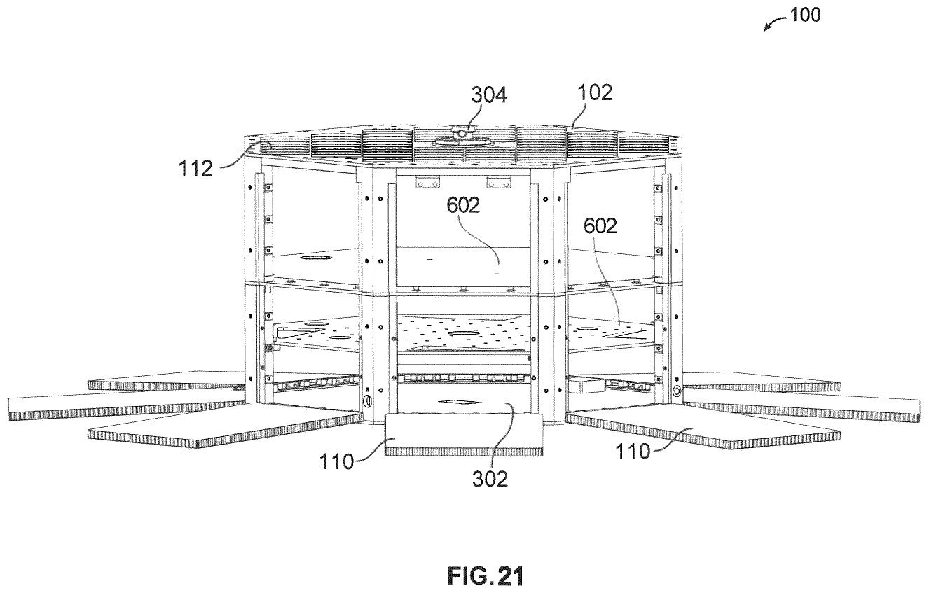

Now referring to FIGS. 17 and 21, in some embodiments of the present invention the photovoltaic members 112 may be attached to an outer facing surface of the upper member 102 and/or the lower member 302. Also, in some embodiments of the present invention the attachment member 304 may be attached to an outer facing surface of the upper member 102 instead of on the lower member 302. Those skilled in the art will notice and appreciate that there may also be an attachment member 304 located on both the upper member 102 and the lower member 302.

Now referring specifically to FIG. 17, the shield members 1702 may be configured to extend between to the upper member 102, the lower member 302, and lower support members 104, and the upper support members 106. The shield members 1702 may be attached or removably attached to the upper member 102, the lower member 302, and lower support members 104, and the upper support members 106.

Now referring to FIG. 19, in some embodiments of the present invention the photovoltaic members 112 may be positioned to cover only a portion of the outside or inside surface of the bottom cover members 110. Those skilled in the art will notice an appreciate that the photovoltaic member 112 may cover all or a portion of the bottom cover members 110, and/or vary in how the photovoltaic members 112 cover each bottom cover member 110 while still accomplishing all the goals, features, and advantages of the present invention.

The U-shape members 1504 may be attached to one or more of the upper support members 106, lower support members 104, and/or the cover members 1502. The U-shape members 1504 may be advantageously used, without limitation, as handles, spacers, bumpers, and/or points of attachment. The U-shape members 1504 may be adapted to be removed from the upper support members 106, lower support members 104, and/or the cover members 1502 after having been attached thereto.

An embodiment of the invention, as shown and described by the various figures and accompanying text, provides a light wavelength filtering device 2201 that may receive one or more wavelengths of light and filter the one or more wavelengths of light received thereby. Throughout this specification, a person skilled in the art should note that the light wavelength filtering device 2201 may be referred to as, for example and without limitation, a light wavelength filtering device 2201, a light wavelength filter device 2201, a light wavelength filter 2201, a filtering device 2201, a light filtering device 2201, a filter device 2201, a light filter device 2201, or a device 2201 and/or in any combination or combinations thereof and interchangeably. For the purposes of the description of the present invention, the term “light filtering system” may be used, without limitation, to refer to the light filter device 2201, one or more embodiments of the light filter device 2201, the various features of and/or features related to/associated with embodiments of the light filter device 2201, and/or embodiments of the present invention that may include more than one light filtering device 2201.

Those skilled in the art will appreciate that any of the above references is meant to include the present invention as will be described in greater detail hereinbelow. The light filter device 2201 may be advantageously utilized to filter light received by the light filter device 2201. The light filter device 2201 may receive light that may be directed from a portion of the surface of the Earth 2240, and the light filter device 2201 may selectively filter/allow one or more wavelengths of the received light to pass through the light filter device 2201.

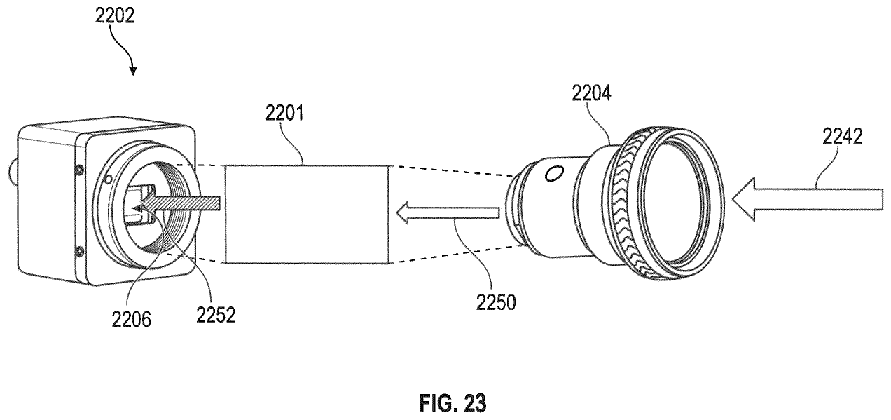

Initially referring to FIG. 22-24, the light filter device 2201 may be adapted to be used in connection with, carried by, and housed by, a light sensor 2202. The light sensor 2202 that is illustrated in the appended drawings is a camera, but those skilled in the art will appreciate that the light sensor 2202 may be provided by any other device suitable for sensing various wavelengths of light. Examples of the light sensor 2202 include, without limitation, a device for sensing light that comprises one or more of spectrophotometer, photodiode array (PDA), spectrometer, prism and diffraction grating, interferometer, fluorescence spectrometer, monochromator, Fourier transform infrared spectrometer, colorimeter, and/or a radiometer and any combination or combinations thereof. Additionally, the light sensor 2202 may include one or more of a housing, mounting components, a communication unit, a shutter, a processor, a data storage, a power unit, a photosensitive member, a communication interface, and any combination or combinations thereof as may be understood by those who may have skill in the art.

The light filter device 2201 may be adapted to be removably carried by the light sensor 2202. The light filter device 2201 may be configured to be positioned between a lens 2204, that may be carried by the light sensor 2202, and one or more sub-sensor(s) 2206, that may also be carried by the light sensor 2202. In exemplary embodiments of the present invention, the light filter device 2201 and/or the light sensor 2202 may be adapted to be carried by a modular satellite 100. It is contemplated, without limitation, that in some embodiments of the present invention, the light filter device 2201 may also include one or more of, and/or include one or more of the features of, the camera 1008 described above and illustratively shown in FIG. 10, and/or a second sensor/orbital camera 4006, an image capture command 4058, and/or an image capture swath 4058, as described herein and illustratively shown in FIGS. 10 and 40.

The modular satellite 100 may be configured to be at least temporarily suspended in space outside of one of the atmospheres of Earth 2240 and/or any other planet any may be understood by those who may have skill in the art, and/or the modular satellite 100 may be configured to be at least temporarily suspended in space orbiting the Earth 2240 and/or any other planet as may be understood by those who may have skill in the art. The modular satellite 100 may also be configured to be at least temporarily suspended within one of the atmospheres of Earth 2240 and/or of any other planet as may be understood by those who may have skill in the art, and/or the modular satellite 100 may be configured to be at least temporarily suspended orbiting the Earth 2240 within one of the atmospheres of Earth 2240 and/or of any other planet as may be understood by those who may have skill in the art. For the purposes of the present invention, the term Earth 2240 and/or atmosphere(s) of Earth 2240 may also, without any limitation, refer to any other planet, moon, celestial body and/or any atmosphere(s) thereof as may be understood by those who may be skilled in the art, such as, and without limitation, the moon, Mars, Jupiter, Venus, Mercury, Saturn, Neptune, Uranus, Pluto, asteroids, asteroid belts, and/or other moons.

In a preferred embodiment of the present invention, the modular satellite 100 is provided by a satellite, and the light sensor 2202 may be carried by an interior portion of the satellite. In such an embodiment, the satellite may include outer doors that may be moved between a closed position and an open position. The closed position of the outer doors may be one in which the light sensor 2202 is carried fully within the satellite and is not exposed to an area outside the satellite. The open position of the outer doors may be one in which the light sensor 2202 is exposed to an area outside the satellite, but it still carried by an interior portion of the satellite. As indicated above, the light sensor 2202 may be provided by a camera. It is contemplated that the satellite may travel in an orbital path about the Earth 2240. As the satellite is traveling in the orbital path, the camera or light sensor 2202 is positioned to collect data from the Earth 2240. It is also contemplated that the satellite may be adapted to change orientation to allow for different perspectives of the light sensor 2202. It is also contemplated that the satellite may be adapted to be moved to alternate orbit paths about the Earth 2240 to allow for the light sensor 2202 to collect alternative data.

In an exemplary embodiment of the present invention, the light filter device 2201 may be carried by a light sensor 2202 that is housed by a modular satellite 100 comprising modular satellite comprising one or more components that are made by three-dimensional fused filament fabrication using onyx infused filament. For example, the modular satellite 100 may be provided by an embodiment of the modular satellite platform described in U.S. patent application Ser. No. 17/828,233 filed on May 31, 2022, and titled SYSTEM FOR A MODULAR SATELLITE TESTING PLATFORM (attorney docket no. 6270.00019), of which the entire contents therein is incorporated herein by reference, except for where the content therein conflicts with the content herein. Similarly, to some of the embodiments of the modular satellite 100 described above, some embodiments of the light filter device 2201 may be configured and adapted to withstand, have resistance to, and/or be functional while in, the presence of an environment of space and/or of the atmospheres of the Earth 2240. The filter device(s) 2201 may comprise one or more of, without limitation, dielectric material such as silicon dioxide, color glass filter, metal oxide, and/or dye, a liquid crystal filter, an acousto-optic tunable filter, a prism, and/or a diffraction grating system and any combinations thereof as may be understood by those who may have skill in the art.

As mentioned above, and moreover, some embodiments of the modular satellite 100, the light filter device 2201, the light sensor 2202, and/or any one or more of the other components described herein may be adapted to survive in, operable while exposed to, and/or be configured to be substantially unaffected by, exposure to the environment of space/outer space, an orbit of Earth 2240, and/or the vacuum of space, for a predetermined period of time. The modular satellite 100 may be configured to orbit the Earth 2240 within and/or outside of an atmosphere of Earth 2240. More examples of the modular satellite 100 include, without limitation, a satellite, a shuttle, a rocket, a high-altitude aerial device, and any combinations thereof and any other device that may be utilized for high altitude or orbital photography as the modular satellite 100.

The modular satellite 100 may carry one or more of an orbital computer 2211. The orbital computer 2211 may include, for example, one or more of a processor 2212, a datastore 2214, a network device 2216, and a power unit 2218 as each may be understood by those who may have skill in the art. Also, the orbital computer 2211 may include one or more other components as may be understood by those who may have skill in the art. For example, without limitation, the orbital computer 2211 may also include one or more of a co-processor, a memory unit, a graphics processing unit, a chassis/housing, an input-output port, a cooling system, a sound processor, a network interface card, an expansion slot, an expansion card, an input-output device, a user interface, a graphical user interface, a display, a non-volatile computer-readable memory, a volatile computer-readable memory, and/or any combination or combinations thereof.

Additionally, it is contemplated, without limitation, that in some embodiments of the present invention, the orbital computer 2211 may comprise one or more of, include one or more of the features of, and/or include one or more of the same or similar features as, the processor 1014, the hardware communication component 1016, the non-transitory computer readable memory 1012, as described above an illustratively shown in FIG. 10, and/or one or more of a mission operation selector 4008, an object detector 4010, an analytics packet generator 4012, a modular satellite controller 4046, a mission analytics packet identifier relay 4048, and/or an adaptive mission operation characterization system 4064, as described below and illustratively shown in FIG. 40.

For increased terseness and for the purposes of the description of the present invention, the orbital computer 2211 and orbital computers 2211 may refer to the processor 2212, the datastore 2214, the network device 2216, and/or the power unit 2218 individually, in the entirety, and in any combinations thereof without any limitation intended or implied thereby. In an exemplary embodiment of the present invention, the orbital computer 2211 may at least comprise a portion of the components, members, and/or units described in U.S. patent application Ser. No. 18/175,977 filed Feb. 28, 2023 and titled HOST SATELLITE HAVING PRIORITIZED ANALYTICS ASSOCIATED WITH DETECTED OBJECTS AND MISSION CONSTRAINTS FOR COMMUNICATION WITH CLIENT TERMINAL (attorney docket no. 6270.00055), of which the entire contents therein is incorporated herein by reference except for where the content therein conflicts with the content herein.

The orbital computer 2211 and/or processor 2212 may utilized to receive, send, compute, analyze, read, write, and/or execute computer-readable data, code, signals, information, instructions, and/or executables. Examples of the processor 2212 include, without limitation, a central processing unit, a field-programmable gate array, a microprocessor, a microcontroller, a graphics processing unit, a non-volatile computer-readable memory, a volatile computer-readable memory, and any combinations thereof.

The datastore 2214 may be utilized to read, write, receive, send, and/or store computer-readable data, code, signals, information, instructions, and/or executables. Examples of the datastore 2214 include, without limitation, a hard drive, a solid-state drive, a disk drive, a compact-disc, a floppy disk, magnetic tape, nonvolatile computer-readable memory, volatile computer-readable memory, and any combinations thereof. In some embodiments of the present invention, the datastore 2214 may include, store, and/or be similar to the non-transitory computer readable memory 1012 as described herein. Additionally, the data store 2214 may include and/or store one or more of a mission operation identifier memory segment 4002, a mission operation lookup table 4016, a mission operation 4018, a mission operation identifier 4020, a mission parameter constraints 4022, a mission analytics packet priority memory segment 4042, a mission analytics packet catalogue memory segment 4044, a mission packet identifier 4038, mission priority characteristics 4040, and/or a mission analytics packet catalogue 4052, which are each described further below and illustratively shown in FIG. 40.

The network device 2216 may be utilized to read, write, convert, interpret, transmit, receive, transceive, send, detect, sense, and/or facilitate communication of computer-readable data, code, signals, information, instructions, and/or executables. Examples of the network device 2216 include, without limitation, a network card, a router, a modem, a hub unit, an antenna, a satellite dish, a transceiver, and any combinations thereof. Additionally, it is contemplated, without limitation, that the network device 2216 may also comprise and/or include one or more features of, one or more of the antenna 902, the transponder 1203, the global positioning satellite transceiver 1201, a first sensor/position sensor 4003, a transceiver 4014, and/or a global position system antenna 4004, as described herein and illustratively shown in FIGS. 9, 12, and 40.

The power unit 2218 may be utilized to provide, manage, monitor, generate, facilitate, store, and/or send electrical power to electronic components that the power unit 2218 may be in communication with. Examples of the power unit 2218 include, without limitation, a power storage device, a power generation device, a power management device, a battery, a photovoltaic device, a transformer, a rectifier, an inverter, a voltage regulator, an amperage regulator, a power signal generator, and any combinations thereof. It should be understood, without limitation, the in some embodiments of the present invention, the power unit 2218 may comprise one or more of, include one or more of the features of, and/or include one or more of the same or similar features as, the photovoltaic members 112, the power distribution system 13008, the power management system 1306, the power generator 1302, the power unit 1002, and/or the power storage unit 1304, as described herein and illustratively shown in FIGS. 1, 10, and/or 13.

In some embodiments of the present invention, the modular satellite 100 may be configured to carry one or more of the light sensors 2202 therein, and the filter device(s) 2201 may be carried by one of the light sensors 2202. The modular satellite 100 may be positioned in space and/or adapted to orbit the Earth 2240, and the modular satellite 100 may be oriented relative to Earth 2240 such that light may be receivable from at least a portion of the Earth 2240 by the modular satellite 100, the one or more sensors 2202, and/or the lens(es) 2204 of the one or more sensors 2202. The light received by the modular satellite 100, the one or more sensors 2202, and/or the lens(es) 2204 may comprise sunlight 2232 that may have been reflected by the Earth 2240 and from the Sun 2230 towards the modular satellite 100, towards the one or more sensors 2202, and/or towards the lens(es) 2204, which may be defined herein as, and referred to herein as, reflected light 2242. The reflected light 2242 may be received by the light sensors 2202 and/or lens(es) 2204, which may be defined herein, and referred to herein, as captured light 2250. The captured light 2250 by the light sensors 2202 and/or lens(es) 2204 may comprise reflected light 2242 received from one or more portions of the surface of the Earth 2240. The captured light 2250 by the light sensors 2202 and/or lens(es) 2204 may also comprise reflected light 2242 received from one or more areas of the Earth 2240.

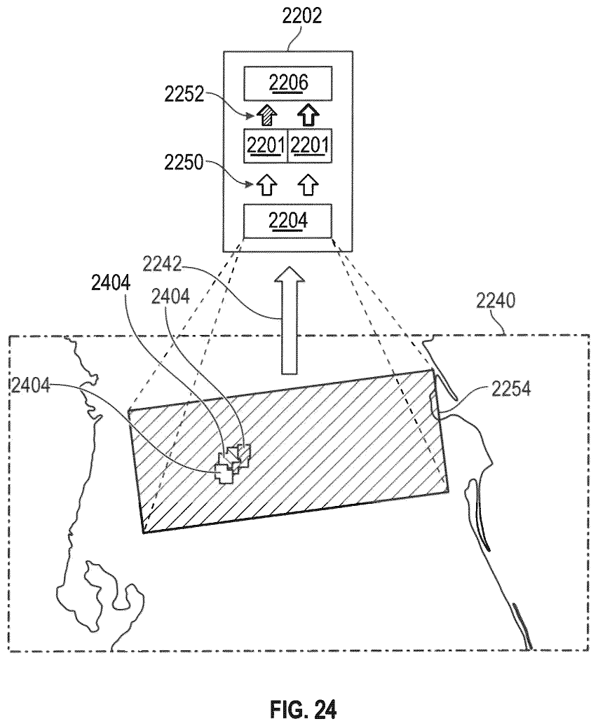

The modular satellite 100 and/or sensors 2202 carried by the modular satellite 100 may be orientable in orbit such that the modular satellite 100, sensors 2202, and/or lens(es) 2204 may be positioned to receive reflected light 2242 from either, or both, a predetermined portion of the surface of the Earth 2240 and from a predetermined area of the Earth 2240. The predetermined portion of the Earth 2240 and/or the predetermined area of the Earth 2240 may be defined as a target area 2254 of the Earth 2240, which may be best illustratively shown in FIG. 24. The modular satellite 100 may include orientation components 2213 that may be selectively controlled and/or activated to change and/or maintain the orientation and/or orbit of the modular satellite 100. For example, without limitation, the orientation components 2213 may comprise one or more of thrusters, boosters, gyroscopes, global positioning systems, and any combinations thereof. Also, for example, and without limitation, it should be understood that in some embodiments of the present invention, the orientation components 2213 may comprise one or more of the propulsion system 1006, the pressure tank(s) 1404, the thruster(s) 1402, the reaction wheel(s) 1207, and/or the magnetorquer(s) 1209 as described herein and illustratively shown in FIGS. 10, 12, and 14.

The reflected light 2242 received from the target area 2254 by the light sensors 2202 and/or lens(es) 2204 may be received, and/or selectively received, by the lens(es) 2204. The lens(es) 2204 may allow for the reflected light 2242 received by the lens(es) 2204 to pass through, refracted through, travel through, be focused through, and/or optically directed through the lens(es) 2204 to define captured light 2250. The lens(es) 2204 may send, pass, refract, focus, and/or optically direct the captured light 2250 to and/or towards one or more of filter devices 2201.

The light filter device 2201 may receive the captured light 2250 from the lens(es) 2204. The light filter device 2201 may be configured to filter and/or convert one or more portions and/or wavelengths of the captured light 2250 received thereby, and/or the light filter device 2201 may be configured to allow one or more portions and/or wavelengths of the captured light 2250 to pass through the light filter device 2201 substantially unchanged as may be understood by those who may have skill in the art. Captured light 2250 received by, filtered by, converted by, and/or allowed through, the light filter device 2201 may define filtered light 2252. The light filter device 2201 may be configured to send, pass, refract, focus, and/or optically direct and/or allow the filtered light 2252 to travel from the light filter device 2201 to and/or towards one or more sub-sensor(s) 2206.

The sub-sensor(s) 2206 may be configured to receive filtered light 2252 from the filter device(s) 2201. The sub-sensor(s) 2206 may be configured to sense, detect, and/or determine the wavelength(s) of light and/or wavelength range(s) of light of the filtered light 2252 received thereby. The sub-sensor(s) 2206 may be configured to generate and/or emit sensed light data related to the wavelength(s) and/or wavelength range(s) of light of the filtered 2252 light received and detected by the sub-sensor(s) 2206. For example, and without limitation, the sub-sensor(s) 2206 may be configured to receive the filtered light 2252 and sense, detect, and/or determine the wavelength(s) and/or wavelength range(s) of light with respect to the filtered light 2252 received including, without limitation, wavelength(s) and/or wavelength range(s) of one or more of visible light band(s), infrared light band(s), microwave band(s), radio wave band(s), ultraviolet light band(s), x-ray band(s), gamma ray band(s), and/or any combination or combinations thereof. However, it is contemplated that the sub-sensor(s) 2206 may be configured to sense, detect, and/or determine the wavelength(s) and/or wavelength range(s) of light of any light that may be received by the sub-sensor(s) 2206 including filtered light 2252, captured light 2250, reflected light 2242, sunlight 2232, and any other light as may be understood by those who may be skilled in the art. Examples of the sub-sensor(s) 2206 include, without limitation, photodiodes, photomultiplier tubes, charge-coupled devices, CMOS image sensors, phototransistors, avalanche photodiodes, fiber optic sensors, photonic integrated circuits, optical filters, and/or prisms and diffraction gratings and any combination or combinations thereof.

The sub-sensor(s) 2206 and/or light sensor(s) 2202 may be in communication with the orbital computer 2211. For example, without limitation, the sub-sensor(s) 2206 and/or light sensor(s) 2202 may be in communication with the processor 2212, the datastore 2214, and/or the network device 2216. In some embodiments, the sub-sensor(s) 2206 may be in communication with one another, and/or the sub-sensor(s) 2206 may be in communication with one or more of the light sensor(s) 2202. The sub-sensor(s) 2206 and/or light sensor(s) 2202 may be configured to emit and send the sensed light data to one or more of the orbital computer 2211. The orbital computer 2211 and/or the processor 2212 may receive the sensed light data and transmit the sensed light data to one or more communication stations 2222 that the orbital computer 2211 and/or the processor 2212 and/or network device 2216 may be in communication with. The orbital computer 2211 and/or the processor 2212 may also store the sensed light data in the datastore 2214. The communication stations 2222 may include one or more of, without limitation, a satellite, a datacenter, a ground station, a telecommunication device, a communication dish and/or antenna, and any combinations thereof.

In some embodiments of the present invention, the orbital computer 2211 and/or the processor 2212 may be configured to interpret, process, compute, read, and/or analyze the sensed light data received and the orbital computer 2211 and/or the processor 2212 may determine and/or identify if there is one or more of a target event 2404 present in the target area 2254 of Earth 2240. Additionally, it is contemplated, without limitation, that in some embodiments of the present invention, that a target event 2404 and/or target area 2254 may comprise one or more of, include one or more of the features of, and/or include one or more of the same or similar features as, a target object type 4024, object detection model parameters 4026, and/or a detected object 4032, which are described below an illustratively shown in FIG. 40.

In some embodiments of the present invention, upon the orbital computer 2211 and/or the processor 2212 determining that one or more target event(s) 2404 are present in the sensed light data, the orbital computer 2211 and/or the processor 2212 may associate the determined target event(s) 2404 with the sensed light data to define target event data. The orbital computer 2211 and/or the processor 2212 may be operable store the target event data in the datastore 2214. The orbital computer 2211 and/or the processor 2212 and/or the datastore 2214 may be operable to allow the orbital computer 2211 and/or the processor 2212 to access and receive target event data stored in the datastore 2214. The orbital computer 2211 and/or the processor 2212 may also be operable to send and/or transmit the target event data to a communication station 2222.

The orbital computer 2211 and/or the processor 2212 may interpret, process, compute, read, and/or analyze the sensed light data received and the orbital computer 2211 and/or the processor 2212 to determine if a target event 2404 is present in the sensed light data by determining if one or more target event criteria wavelength(s) are present in the sensed light data. The target event criteria wavelengths may be associated with an absorption band of a material, element, substance, composition of matter, mixture, and/or object. For example, without limitation, a target event criteria wavelength may comprise a wavelength within a range of about 1635 nanometers to about 1685 nanometers, which may be associated with the absorption band of methane, and thus may indicate that methane may be present within the target area 2254 of Earth 2240 from which reflected light 2242 has been received by the lens(es) 2204.

In some embodiments of the present invention, the orbital computer 2211 and/or the processor 2212 may also/instead send the sensed light data to one or more of the receiving stations 2222. The receiving station(s) 2222 may interpret, process, compute, read, and/or analyze the sensed light data received thereby to determine if a target event 2404 is present in the sensed light data by determining if one or more target event criteria wavelength(s) are present in the sensed light data. Additionally, it is contemplated, without limitation, that in some embodiments of the present invention, the communication station(s)/receiving station(s) 2222 may comprise one or more of, include one or more of the features of, and/or include one or more of the same or similar features as, a client terminal 4036, a terrestrial ground station, and/or a client satellite, as described further below and illustratively shown in FIG. 40.

In some embodiments of the present invention, it is preferable that the orbital computer 2211 and/or the processor 2212 of the modular satellite 100 processes the sensed light data to determine if target event(s) 2404 may be present in the target area 2254, rather than/instead of the orbital computer 2211 and/or the processor 2212 sending/transmitting the sensed light data to a communication station 2222 to be processed thereby to determine if target event(s) 2404 may be present in the target area 2254. Those who may have skill in the art may notice and appreciate that in these preferred embodiments, the computational power of the communication station(s) 2222 will thus advantageously enjoy a reduced demand for processing all the sensed light data from the modular satellite 100 and/or from multiple modular satellites 100 in comparison to the prior art limited to transmitting all the captured data from a satellite to a ground station for processing. Moreover, in these preferred embodiments, network bandwidth is greatly reduced by not requiring the modular satellite(s) 100 to send all the sensed light data to the communication station(s) 2222 for processing to identify possible target event(s) 2404 in target area(s) 2254.

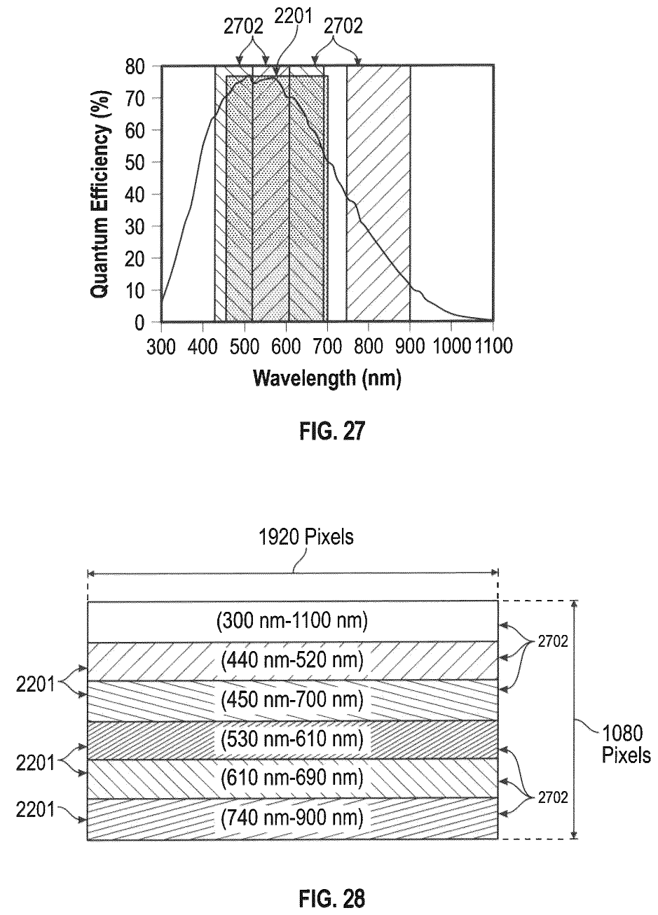

Now referring to FIGS. 22, and 24-29. the filter device(s) 2201 may be configured to filter out predetermined wavelength(s) of light and/or filter out predetermined range(s) of wavelengths of light from the captured light 2252 received thereby. For increased terseness and for the purposes of the description of the present invention, the terms “predetermined wavelength(s) of light,” “predetermined range(s) of wavelengths of light,” “predetermined wavelength(s),” and “predetermined ranges of wavelength(s),” and any grammatical forms thereof, may be used interchangeably without any limitation intended or implied thereby. The predetermined wavelength(s) of light filtered out by an embodiment of the filter device(s) 2201 may comprise wavelengths of light that are not within, different from, and/or dissimilar to one or more of a predetermined filter range 2702 (which, which limitation, may be interchangeably referred to as “filter range(s) 2702”). Thus, in contrast, the resulting filtered light 2252 from the captured light 2250 filtered by the filter device(s) 2201 may comprise wavelength(s) of light that are within, similar to, and/or about the same as one or more predetermined filter range(s) 2702/filter range(s) 2702.

For example, and without limitation, to form the filtered light 2252, the predetermined wavelength(s) filtered out from the captured light 2250 by the filter device(s) 2201 may comprise wavelength(s) of light outside of, different from, and/or dissimilar to filter range(s) 2702 that may comprise one or more of 440 to 520 nanometers (blue light), 450 to 700 nanometers (pan light), 530 to 610 nanometers (green light), 610 to 690 nanometers (red light), and/or 740 to 900 nanometers (near-infrared light) and any combination or combinations thereof. Thus, the filter device(s) 2201 may allow wavelength(s) of the captured light 2252 within, similar to, and/or about the same as the filter range(s) 2702 to pass through the light filter device 2201 and/or to be directed towards/to be received by the one or more sub-sensor(s) 2206 as the filtered light 2252.

Therefore, the predetermined wavelength(s) filtered out from the captured light 2250 by the filter device(s) 2201 to form the filtered light 2252 by filtering out wavelength(s) of light outside of one or more filter range(s) 2702, such that the predetermined wavelength(s) may be referred to as being inversely associated with the one or more filter range(s) 2702. For the purposes of the present invention, it should be understood that the term “inversely associated” means that the filtered out predetermined wavelength(s) in relation to one or more filter ranges 2702 comprises one or more of all wavelength(s) that are all not within the filter range(s) 2702, wavelength(s) with the majority being not within the filter range(s) 2702, and/or wavelength(s) substantially surrounding the filter range(s) 2702. Also, for the purposes of the present invention, it should be understood that the predetermined wavelength(s) filtered out from the captured light 2250 by the filter device(s) 2201 may alternatively be referred to as the filter range(s) 2702 of the filter device(s) 2201, without any limitation.

Also, it is known and understood that the filter device(s) 2201 may be configured to filter out and allow any wavelength(s) and/or range(s) of light of the captured light 2252 received by the light filter device 2201 including any wavelength and/or any range of the visible light band(s), infrared light band(s), microwave band(s), radio wave band(s), ultraviolet light band(s), x-ray band(s), gamma ray band(s), and any combinations thereof.

The filtered out predetermined wavelength(s) outside of the filter range(s) 2702 may comprise wavelength(s) of light that may not associated with wavelength(s) of reflected light 2242 which are related to one or more target events 2404. More specifically, the filter device(s) 2201 may be configured to allow one or more predetermined wavelength(s) within the filter range(s) 2702 of the captured light 2250 to pass through the light filter device 2201 unchanged as filtered light 2252, with the resulting filtered light 2252 then comprising wavelength(s) of light that may be associated with one or more target event(s) 2404. For the purposes of the present invention, the predetermined wavelength(s) of light being allowed to pass through the light filter device 2201 unchanged is understood mean that the wavelength(s) of the captured light 2250 travel through the filter device(s) 2201 with their wavelength(s) substantially unchanged and defined as filtered light 2252.

For example, without limitation, the wavelength(s) not filtered out from the captured light 2252 and/or the filter range(s) 2702 not filtered out from the captured light 2252 may include one or more wavelength(s) inversely related to/inversely associated with the light wavelength absorption band(s) of one or more of an element, composition, substance, chemical, gas, and any combinations thereof. For example, and without limitation, the predetermined wavelength(s) and/or filter range(s) 2702 not filtered out from the captured light 2252 may include one or more wavelength(s) correlated to the light wavelength absorption band(s) of one or more of water and water vapor (around 0.94 micrometers, 1.13 micrometers, and 1.38 micrometers), carbon dioxide (around 2 micrometers, and 4.3 micrometers), ozone (lower than about 0.3 micrometers), methane (between about 1.65 micrometers and 2.3 micrometers), carbon monoxide (around 4.6 micrometers) nitrous oxide (around 4.5 micrometers), sulfur dioxide (around 7.3 micrometers), ammonia (around 23.8 micrometers), oxygen (lower than about 0.24 micrometers), and chlorophyll (around about 0.665 micrometers to 0.68 micrometers, about 0.43 micrometers to 0.45 micrometers, about 0.64 micrometers to 0.66 micrometers, and about 0.45 micrometers to 0.47 micrometers), and any combinations thereof.

As may be understood by those who may have skill in the art, the absorption band of a substance is the band/range of wavelength(s) of light that the substance absorbs, such that a substantial portion of the wavelength(s) within the substance's absorption band will not pass through that substance and/or be detectable from light passing through and/or traveling from that substance. Therefore, by detecting which bands of light are least present, and/or that are not present, within reflected light 2242 from a target area 2254, a target event 2404 may be identified thereby with the orbital computer 2211 and/or the processor 2212 and/or the communication station(s) 2222 based on the sensed light data emitted from the sub-sensor(s) 2206. Specifically, by determining which wavelength(s) of light of the sensed light data are abnormally low in comparison to a predetermined wavelength presence with the orbital computer 2211 and/or the processor 2212 and/or the communication station(s) 2222, one or more target event(s) 2404 may be identified and indicative of the presence of a substance, material, composition, and/or element within the target area 2254 having an absorption band associated with that/those wavelength(s) of light abnormally low within the sensed light data.

According to an exemplary embodiment of the present invention, the filter device(s) 2201 may be configured to filter out wavelength(s) of light from the captured light 2250 received that are outside the absorption band wavelength(s) of water vapor, carbon dioxide, methane, and/or chlorophyll such that, the sub-sensor(s) 2206 may be restricted to sensing the presence, and/or absence, of the wavelength(s) within the absorption band(s) of those substance(s) upon receiving the filtered light 2252 from the filter device(s) 2201. The sub-sensor(s) 2206 may send the sensed light data to the orbital computer 2211 and/or the processor 2212 and/or communication station(s) 2222 that may then determine if target event(s) 2404 relating to, and indicative of, water vapor, carbon dioxide, methane, and/or chlorophyll is/are present within the target area 2254 based on the sensed light data.

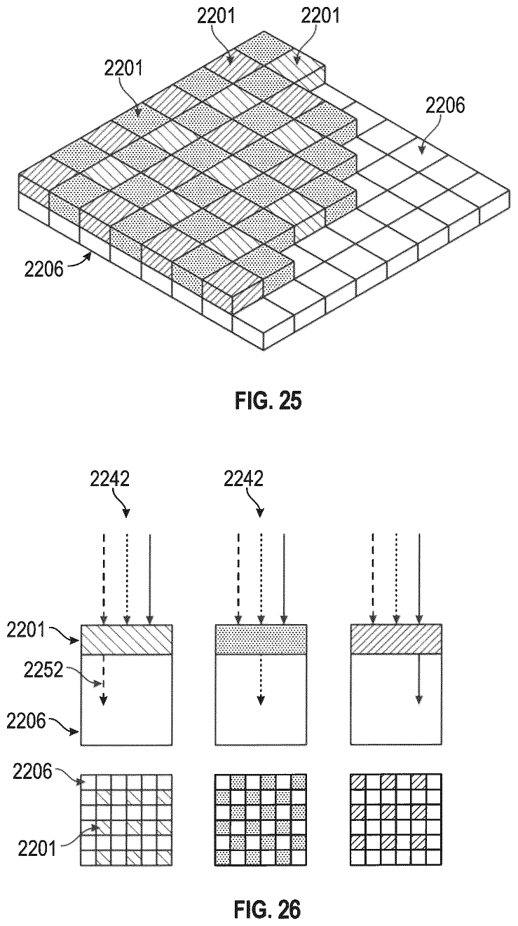

Now referring to FIGS. 22 and 25, some embodiments of the light filtering system and/or the light filter device 2201 may comprise a filter device 2201 pattern, which perhaps is best illustratively shown in FIG. 25. The light filter device 2201 pattern may comprise a plurality of filter devices that may be positioned adjacent to and/or in close proximity with one another. Each filter device 2201 of the light filter device 2201 pattern may have filter range(s) 2702 that may be the same, similar to, different than, and/or differ from the filter range(s) 2702 of the other filter devices 2201 of the light filter device 2201 pattern. The light filter device 2201 pattern may comprise a plurality of filter devices 2201 in an organized and/or a disorganized pattern. For example, and without limitation, the filter devices 2201 of the light filter device 2201 pattern may be arranged in a pattern such that filter devices 2201 with the same and/or similar filter range(s) 2702 are not adjacent to one another, and such that each filter device 2201 is positioned adjacent to other filter devices 2201 of the light filter device 2201 pattern that have different filter range(s) 2702.

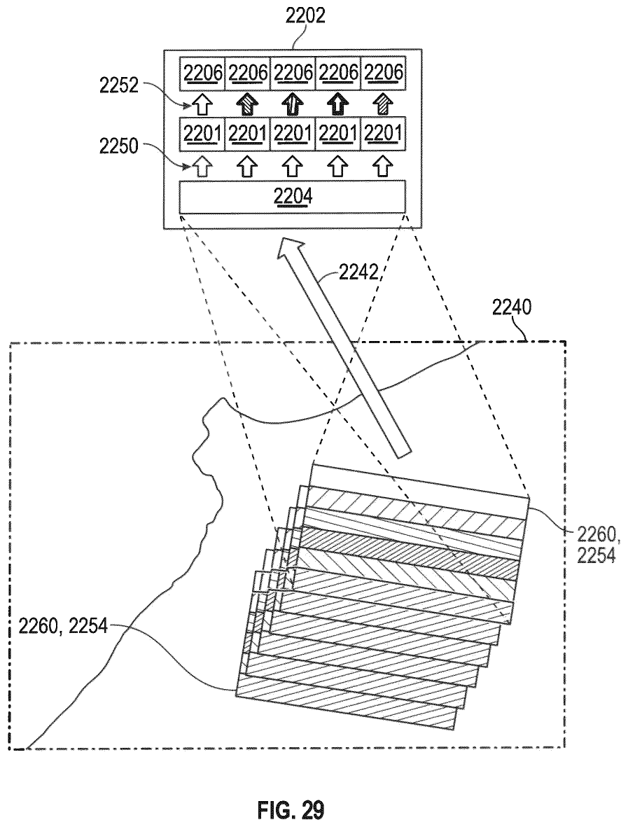

Now referring to FIGS. 28-29, some embodiments of the present invention may include multiple filter devices 2201 stacked on one another in a sort of layered arrangement, which may form, and may be referred to herein as, a layering of filter devices 2201. The layering of filter devices 2201 is perhaps best illustratively shown in FIG. 28. The layering of filter devices 2201 may each receive captured light 2242 from the lens(es) 2204. Each filter device 2201 of the layering of filter devices 2201 may filter range(s) 2702 different from the other filter devices 2201 of the layering of filter devices 2201. For example, without limitation, each filter device 2201 of the layering of filter devices 2201 may be configured to filter captured light 2242 to allow light to pass through the light filter device 2201 which is within one or more filter range(s) 2702 comprising 440 to 520 nanometers (blue light), 450 to 700 nanometers (pan light), 530 to 610 nanometers (green light), 610 to 690 nanometers (red light), or 740 to 900 nanometers (near-infrared light).

In some embodiments of the present invention that comprise more than one filter device 2201, including filter devices 2201 of a filter device 2201 pattern and/or filter devices 2201 of a layering of filter devices 2201, each filter device 2201 may be associated with a respective sub-sensor 2206 to which the light filter device 2201 may allow and/or directed filtered light 2252 thereto. In other embodiments of the present invention, each filter device 2201 may allow and/or direct filtered light 2252 to a single sub-sensor 2206 that may be shared with one or more other filter devices 2201. The single sub-sensor 2206 may be configured to sense and/or detect multiple wavelengths of light within multiple filter range(s) 2702 of the filtered light 2252 received by the sub-sensor 2206.

Some embodiments of the present invention may include a single filter device 2201 that may be configured to direct filtered light 2252 therefrom to a plurality of sub-sensors 2206. For example, without limitation, the light filter device 2201 may be configured to act as a light wavelength filter and may also split the wavelength(s) of light of captured light 2250 received by the light filter device 2201 into a respective number of filter lights 2252 by wavelength, with each being directed to a respective sub-sensor 2206. Another example, and without limitation, the light filter device 2201 may receive captured light 2250 that may include one or more wavelengths within the absorption band(s) of one or more elements, compositions, substances, chemicals, gases, and any combinations thereof. The light filter device 2201 may be configured to filter out wavelength(s) of light that are not included in one or more of the absorption band(s), and the light filter device 2201 may direct each of the filtered light 2252 wavelength(s) based on their associated absorption band(s) towards a respective sub-sensor 2206. Each respective sub-sensor 2206 may be associated with the filter range and/or absorption band of the filtered light 2252 directed towards the sub-sensor 2206.

Now referring more specifically to FIG. 28, in some embodiments of the present invention, one or more filter device(s) 2201 may be sized and/or configured to filter captured light 2250 and/or direct filtered light 2252 in a dimension that may be equivalent to a resolution size and/or pixel size of a light sensor 2202 and/or sub-sensor(s) 2206 of a light sensor 2202. For example, without limitation, the filter device(s) 2201 and/or filter device 2201 pattern may be sized and/or configured to filter captured light 2250 and/or direct filtered light 2252 in a dimension that may be equivalent to a resolution size and/or pixel size of a light sensor 2202 and/or sub-sensor(s) 2206 of a light sensor 2202 that may comprise about 1920 pixels by 1080 pixels. However, it is contemplated and understood that filter device(s) 2201 and/or filter device 2201 pattern(s) may be sized and/or configured to filter captured light 2250 and/or direct filtered light 2252 in a dimension that may be equivalent to any resolution size and/or pixel size.

In some embodiments of the present invention, the light sensor 2202 and/or lens 2204 may be configured to selectively allow reflected light 2242 to be received and/or captured by the lens 2204 during one or more moments of time, which may be defined as taking a frame. In some embodiments of the present invention, the light sensor 2202 and/or lens 2204 may be configured to selectively and/or consecutively and successively allow, reflected light 2242 to be received and/or captured by the lens 2204 as captured light 2250 for one or more moments of time, which may be referred to as a performing a frame rate and/or taking a series of frames 2260. Each frame may be related to the reflected light 2242 from the particular portion, area, and/or target area 2254 of the Earth 2240 captured by the lens(es) 2204 as captured light 2250 at a particular instance of time. The orbital computer 2211 and/or the processor 2212 may associate each frame with its related reflected light 2242, the geolocation of the related reflected light 2242, the time stamp of the related reflected light 2242, and the sensed light data generated by the sub-sensor(s) 2206 from the filtered light 2252 that resulted from the captured light 2250 and/or the reflected light 2242 received from an area and/or target area 2254 of the surface of the Earth 2240. The orbital computer 2211 and/or the processor 2212 may also associate each frame with one or more target event(s) 2404 that are determined by the orbital computer 2211 and/or the processor 2212 to be present in the resulting sensed light data of the frame.

The light sensor 2202 and/or lens 2204 may be selectively controlled by the orbital computer 2211 and/or the processor 2212 to take a frame and/or take a series of frames 2260 upon the orbital computer 2211 and/or the processor 2212 determining that the modular satellite 100, light sensor 2202, and/or lens 2204 is oriented towards a target area 2254 of the Earth 2240. In some embodiments of the present invention, the processor 2212 may be configured to selectively control the light sensor 2202 and/or the lens 2204 to take a frame and/or take a series of frames 2260 based on a mission instruction that may be related to one or more target area(s) 2254. The orbital computer 2211 and/or the processor 2212 may be configured to selectively control the light sensor 2202 and/or the lens 2204 to take a frame and/or take a series of frames 2260 upon the orbital computer 2211 and/or the processor 2212 determining that the modular satellite 100, light sensor 2202, and/or lens 2204 is/are oriented towards a target area 2254 related to the mission instruction. The mission instruction may be received by the orbital computer 2211 and/or the processor 2212 from a communication station 2222, and/or the mission instruction may be generated by the orbital computer 2211 and/or the processor 2212 based on mission data stored in the datastore 2214. More details on the orbital computer 2211 and/or the processor 2212 and the mission instruction follows further below.

In some embodiments of the present invention, the light sensor 2202 and/or lens 2204 may be selectively controlled by the orbital computer 2211 and/or the processor 2212 to take a series of frames 2260 upon the orbital computer 2211 and/or the processor 2212 determining that the modular satellite 100, light sensor 2202, and/or lens 2204 is oriented towards a plurality of target areas 2254 of the Earth 2240 which may at least partially overlap with one another, with each frame of the series of frames 2260 being associated with one target area 2254 of the plurality of target areas 2254. The orbital computer 2211 and/or the processor 2212 and/or a communication station 2222 may determine if a target event 2404 is present in one or more of the plurality of target areas 2254 based on the resulting series of sensed light data received via the series of frames 2260.

In some embodiments of the present invention, the light sensor 2202 and/or lens 2204 may be selectively controlled by the orbital computer 2211 and/or the processor 2212 to take a series of frames 2260 and/or perform a frame rate, based on a ground speed of the modular satellite 100 relative to the surface of Earth 2240 and based on the view swath of the lens 2204 and/or the view swath of the filter device(s) 2201. For example, without limitation, the orbital computer 2211 and/or the processor 2212 may determine and/or receive ground speed data related to the ground speed of the modular satellite 100 relative to the surface of the Earth 2240 and selectively control the light sensor 2202 and/or lens 2204 to take a series of frames 2260 and/or to perform a frame rate to receive reflected light 2242 (and thus capture light 2250) such that the view swath of the lens 2204 and/or the view swath of the filter device(s) 2201 at least partially overlap with one another between each frame of the series of frames 2260. The frames 2260 of the series of frames 2260 may overlap with one another such that, in embodiments of the present invention that include multiple filter devices 2201 as a pattern of filter devices 2201 and/or a layering of filter devices 2201, the frames 2260 of the series of the frames 2260 may include a filtered light 2252 (and thus sensed light data) from each of the multiple filter devices 2201 related to the same portion and/or area of the surface of Earth 2240. Which is perhaps as best illustratively shown in FIG. 29.

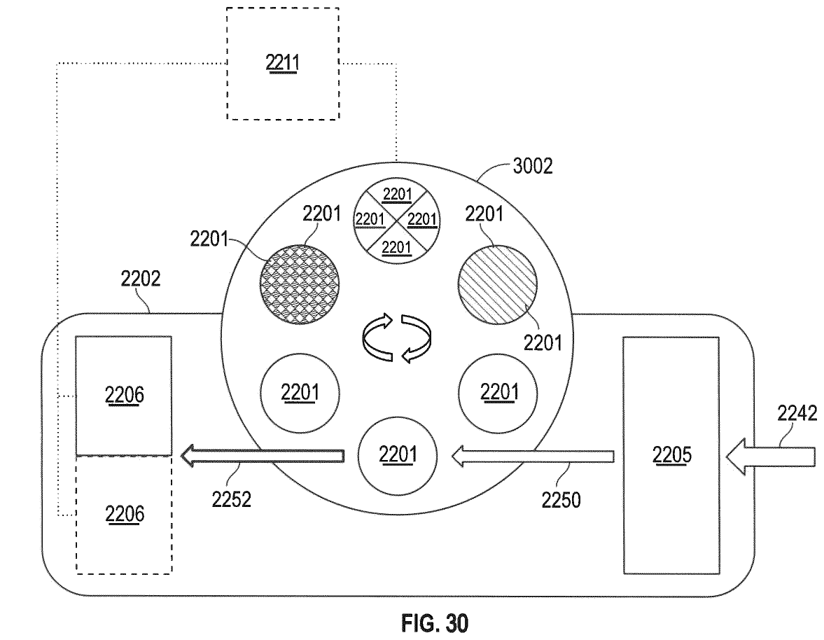

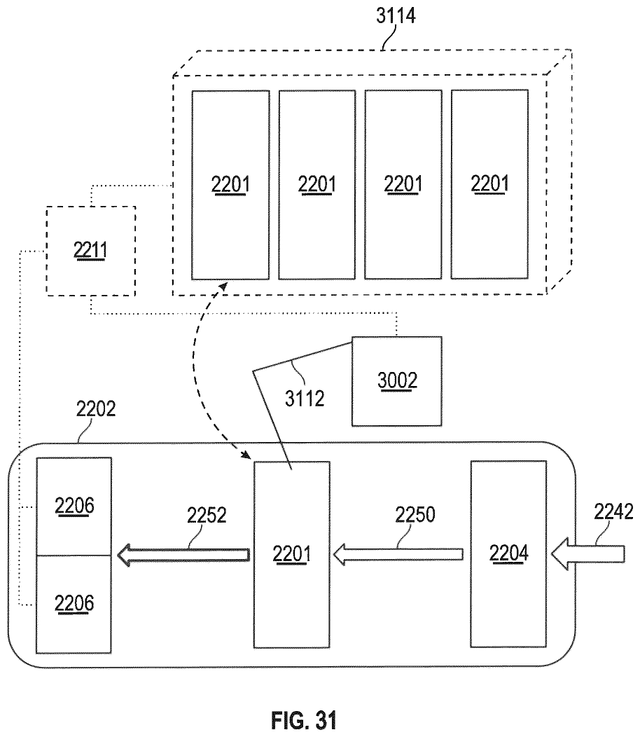

Now referring to FIGS. 22, 30, and 31, some embodiments of the present invention may include a filter selection device 3002. The filter selection device 3002 may be configured to be carried by a modular satellite 100, and the filter selection device 3002 may be positioned and configured to selectively moveably position and/or swap-out one or more filter device(s) 2201 between one or more lens(es) 2204 and the sub-sensor(s) 2206. The filter selection device 3002 may be configured to moveably position and store filter device(s) 2201 that are not being utilized by the light sensor(s) 2202 to be stored and/or housed by a filter library 3114. In some embodiments of the present invention, the orbital computer 2211 and/or the processor 2212 may be configured to selectively control the filter selection device 3002 to selectively moveably position and/or swap-out one or more filter device(s) 2201 between one or more lens(es) 2204 and the sub-sensor(s) 2206. The filter selection device 3002 may comprise a main body that may be configured to carry and/or hold a plurality of filter devices 2201 in a uniform and/or non-uniform pattern, which may be referred to as a pattern of filter devices 2201.

The filter selection device 3002 and/or the main body may be operable and/or selectively operable to move (and/or rotatably move) relative to the modular satellite 100 and/or an adjacent light sensor 2202. The movement of the filter selection device 3002 and/or the main body may cause the pattern of filter devices 2201 to correspondingly move, such that one of the filter devices 2201 of the pattern of filter devices 2201 may be selectively and/or movably positioned between the lens(es) 2204 and the sub-sensor(s) 2206.

In some embodiments of the present invention, the filter selection device 3002 may comprise a rotatably moveable structure carrying more than one filter device(s) 2201, and configured to selectively rotatably move such that one of the filter device(s) 2201 may be selectively moveably positioned 2201 between one or more lens(es) 2204 and the sub-sensor(s) 2206. In other embodiments of the present invention, the filter selection device 3002 may comprise an actuation device and configured to selectively grasp, move, and/or position the filter device(s) 2201 between one or more lens(es) 2204 and the sub-sensor(s) 2206, and to selectively grasp, move, and/or position the filter device(s) 2201 to be stored and/or housed by the filter library 3114.

The filter device(s) 2201 carried by the one or more sensor(s) 2202 may be chosen by the processor 2212 depending upon a mission instruction. The mission instruction may comprise one or more of a mission type and/or a mission parameter. The mission type may relate to one or more of a search mission, a map mission, a report mission, a standby mission, a vigilance mission, a self-diagnostics mission, and/or a statistical analysis mission. The mission parameter may relate to one or more of a target event 2404, target events 2404, a time constraint (e.g., time range, execution time(s), and/or periodic time(s), periodic time ranges), absorption band(s), portion(s) of the surface of the Earth 2240, area(s) of the Earth 2240, predetermined target area 2254 of Earth 2240, and/or exclusion instructions. The orbital computer 2211 and/or the processor 2212 may determine a predetermined wavelength range based on the mission type and/or mission parameters of the mission instruction. For example, based on the mission instruction, the orbital computer 2211 and/or the processor 2212 may match one or more filter range(s) 2702 to the mission instruction to identify one or more matching filter device(s) 2201 having the matched filter range(s) 2702 and the processor 2212 may selectively control the filter selection device 3002 to selectively moveably position and/or swap-out one or more filter device(s) 2201 between one or more lens(es) 2204 and the sub-sensor(s) 2206 with the one or more matching filter device(s) 2201.

In some embodiments of the present invention, the filter device(s) 2201 may be configured to also convert one or more wavelength(s) of light and/or captured light 2250 received by the filter device(s) 2201 into one or more other wavelengths of light to form the filtered light 2252. In some embodiments of the present invention, the filter device(s) 2201 may be configured to also amplify one or more wavelength(s) of light and/or captured light 2250 received by the filter device(s) 2201 to form the filtered light 2252 directed towards the sub-sensor(s) 2206. In other embodiments of the present invention, the filter device(s) 2201 may be configured to also change the range of the wavelength(s) of the captured light 2250 received to form the filtered light 2252. For example, without limitation, the filter device(s) 2201 may expand the range of the wavelength(s) of the captured light 2250 received to form filtered light 2252 with wavelengths within the filter range(s) 2702 of the light filter device 2201 converted to a wider wavelength range.

The orbital computer 2211 and/or the processor 2212 may be configured to determine, identify, and perform a course of action based on mission instruction(s). The mission instruction may be received by the orbital computer 2211 and/or received by the processor 2212 from a communication station 2222. In some embodiments of the present invention the mission instruction may be generated by the orbital computer 2211 and/or by the processor 2212 based off of mission data stored in the datastore 2214. The mission data may be accessible by the orbital computer 2211 and/or the processor 2212 and the orbital computer 2211 and/or the processor 2212 may selectively access the datastore 2214 to receive at least a portion of the mission data therefrom. The mission data may comprise saved data of past and/or current/present: mission instruction(s), frames 2260, series of frames 2260, performed frame rates, timestamps, geolocations, sensed light data, detected target event(s) 2404, predetermined target area(s) 2254, detected/identified target event(s) 2404 and/or courses of action. The orbital computer 2211 and/or the processor 2212 may be configured to update the mission data stored in the datastore 2214 with mission instructions, frames 2260, series of frames 2260, performed frame rates, timestamps, geolocations, sensed light data, detected target event(s) 2404, and/or courses of action upon its occurrence and/or periodically.

The course of action determined and identified based on the mission instructions by the orbital computer 2211 and/or the processor 2212 may be executable by the orbital computer 2211 and/or the processor 2212 to cause the orbital computer 2211 and/or the processor 2212 to, without limitation, selectively communicate with, selectively communicate via, and/or selectively control one or more of the filter device(s) 2201, the light sensor(s) 2202, the sub-sensor(s) 2206, the lens(es) 2204, the datastore 2214, the network device 2216, the power unit 2218, the orientation components 2213, the communication station(s) 2222, filter selection device 3002, selection arm 3112, filter library 3114, and/or other modular satellite(s) 100 to perform an action and/or perform a series of actions based on the mission instructions. The course of action may comprise a search course of action, a map course of action, a report course of action, a standby course of action, a vigilance course of action, a self-diagnostics course of action, and/or a statistical analysis course of action.

For example, the orbital computer 2211 and/or the processor 2212 may selectively control the orientation components 2213 to orient the modular satellite 100, sensor(s) 2202, and/or lens(es) 2204 to face towards a predetermined target area 2254 of Earth 2240 that may be related to the mission instructions. The orbital computer 2211 and/or the processor 2212 may also selectively control the light sensor(s) 2202 and/or lens(es) 2204 to cause the light sensor(s) 2202 and/or lens(es) 2204 to rotatably move to face towards a predetermined target area 2254 of Earth 2240 from the mission parameters. The orbital computer 2211 and/or the processor 2212 may be utilized in concert with the orientation components 2213 and/or the network device 2216 to determine and monitor the orientation of the modular satellite 100, the light sensor(s) 2202, and/or the lens(es) 2204 relative to the Earth 2240, an area of Earth 2240, and/or to a target area 2254 and/or predetermined target area 2254. For another example, based on the mission instructions, the orbital computer 2211 and/or the processor 2212 may selectively control the filter selection device 3002 to cause the filter selection device 3002 to selectively moveably position and/or swap-out one or more filter device(s) 2201 between one or more lens(es) 2204 and the sub-sensor(s) 2206 related to a mission parameter, such as, related to absorption band(s) and/or predetermined target event(s) 2404.

Additionally, based on the mission instructions, the orbital computer 2211 and/or the processor 2212 may selectively control one or more of the light sensor(s) 2202 and/or lens(es) 2204 to take a frame, perform a frame rate, and/or take a series of frames 2260 to receive reflected light 2242 from multiple portions and/or areas of the surface of the Earth 2240 as the modular satellite 100 follows its current orbital path. The orbital computer 2211 and/or the processor 2212 may determine if one or more target event criteria wavelength(s) and/or target event(s) 2404 are present in one or more of the frame(s) 2260 and/or the sensed light data of the frame(s) 2260, and upon the orbital computer 2211 and/or the processor 2212 determining and identifying that one or more target event criteria wavelength(s) and/or target event(s) 2404 are present in one or more of the frame(s) 2260 and/or sensed light data of the frame(s) 2260, the orbital computer 2211 and/or the processor 2212 may transmit those frame(s) 2260 and/or sensed light data of those frame(s) 2260 to a communication station 2222 or other modular satellite 100, and/or store those frame(s) 2260 and/or sensed light data of those frame(s) 2260 in the datastore 2214. The orbital computer 2211 and/or the processor 2212 may also determine and identify if one or more target event criteria wavelength(s) and/or target event(s) 2404 are present in one or more of the frame(s) 2260 and/or the sensed light data of the frame(s) 2260 that match a predetermined target event 2404 of the mission instructions.

The orbital computer 2211 and/or the processor 2212, based on the course of action identified from the mission instructions, may selectively control the orientation components 2213 to cause the modular satellite 100 to change its current orbit path to a new orbit path. The orbital computer 2211 and/or the processor 2212 may be utilized in concert with the orientation components 2213 and/or the network device 2216 to determine and monitor the current orbit path of the modular satellite 100 relative to Earth 2240. The orbital computer 2211 and/or the processor 2212 may determine at least one new orbit path based on one or more of the mission instructions, predetermined target area(s) 2254, predetermined target event(s) 2404, absorption band(s) of target event(s) 2404 and/or substance(s), mission data, sensed light data, and/or weather data from the network device 2216 and/or GPS data from the orientation components 2213. The orbital computer 2211 and/or the processor 2212 may determine multiple new orbit paths and identify at least one relevant matching new orbit path from the new orbit paths based on one or more of the mission instructions, predetermined target area(s) 2254, absorption band(s) of target event(s) 2404 and/or substance(s), predetermined target event(s) 2404, mission data, sensed light data, and/or weather data from the network device 2216 and/or GPS data from the orientation components 2213.

In some embodiments, the orbital computer 2211 and/or the processor 2212 may determine if the filter device(s) 2201 utilized in the light sensor(s) 2202 have filter range(s) 2702 that match the absorption band(s) of target event(s) 2404 of the mission instructions. In embodiments that include a filter selection device 3002 and/or a filter library 3114, the orbital computer 2211 and/or the processor 2212 may determine if there are filter device(s) 2201 not being utilized in the light sensor(s) 2202 that have filter range(s) 2702 that match the absorption band(s) of target event(s) 2404 of the mission instructions, and selectively control the filter selection device 3002 to cause the filter selection device 3002 to selectively moveably position and/or swap-out one or more filter device(s) 2201 being utilized in the light sensor(s) 2202 that do not have filter range(s) 2702 that match the absorption band(s) with the one or more filter device(s) 2201 that have at least one of the matching filter range(s) 2702.

In some embodiments of the present invention, the orbital computer 2211 and/or the processor 2212 may determine if there are other modular satellites 100 which the orbital computer 2211 and/or the processor 2212 is, and/or can operably be, in communication therewith. Upon the orbital computer 2211 and/or the processor 2212 determining that the filter device(s) 2201 do not match one or more of the absorption band(s) of the predetermined target event(s) 2404 of the mission instructions, the orbital computer 2211 and/or the processor 2212 may couple in communication with the other modular satellite(s) 100 and/or relay at least a portion of the mission instructions to the other modular satellite(s) 100 for the other modular satellite(s) 100 to perform a course of action based thereupon. For example, without limitation, for the other modular satellite(s) 100 to perform a course of action to take frame(s) 2260 of predetermined target area(s) 2254 of the mission instructions with filter device(s) 2201 that have filter range(s) 2702 which the original modular satellite 100 does not include, and to relay the frame(s) 2260 and/or sensed light data associated with the predetermined target area(s) 2254 to the original modular satellite 100.

Upon the orbital computer 2211 and/or the processor 2212 determining that the filter device(s) 2201 do not match one or more of the absorption band(s) of the predetermined target event(s) 2404 of the mission instructions, the orbital computer 2211 and/or the processor 2212 may emit a filter range error signal to be received by a communication station 2222 that may have originally sent the mission instructions to the modular satellite 2222. In some embodiments, upon the orbital computer 2211 and/or the processor 2212 determining that the filter device(s) 2201 do not match any of the absorption band(s) of the predetermined target event(s) 2404 of the mission instructions, the orbital computer 2211 and/or the processor 2212 may emit a mission error signal to be received by a communication station 2222 that may have originally sent the mission instructions to the modular satellite 2222.

In some embodiments of the present invention, the orbital computer 2211 and/or the processor 2212 may count and track the number of failed attempts that the modular satellite 2222 and/or the light sensor(s) 2202 have been unable to receive reflected light from an area of Earth 2240 and/or from a target area 2254 during each orbit passing of the modular satellite 100 relative to the area of Earth 2240 and/or target area 2254. Upon the orbital computer 2211 and/or the processor 2212 counting each failed attempt, the orbital computer 2211 and/or the processor 2212 may: determine if the modular satellite 100 should change to a new orbit path; and/or determine if the modular satellite 100 and/or light sensor(s) 2202 are facing the area of Earth 2240 and/or target area 2254; and/or determine whether another attempt should be made after waiting a predetermined period of time; and/or determine if the count of failed attempts is equal to an upper failed attempts limit. Upon the orbital computer 2211 and/or the processor 2212 counting and determining that the number of fail attempts is equal to an upper failed attempts limit, the processor may generate and emit a mission error notification signal to the communication station 2222 that may have sent the current mission instructions that have led up to the failed attempts by the modular satellite 100.

In some embodiments of the present invention, the orbital computer 2211 and/or the processor 2212 may parse the mission data stored in the datastore 2214 to determine and match at least a portion of the mission data to at least a portion of a mission instruction received from a communication station 2222. The orbital computer 2211 and/or the processor 2212 may send the matched mission data to the communication station 2222, with the match mission data including one or more of prior or current: mission instruction(s), frames 2260, series of frames 2260, performed frame rates, timestamps, geolocations, sensed light data, detected target event(s) 2404, predetermined target area(s) 2254, detected/identified target event(s) 2404 and/or courses of action that have been matched to at least a portion of the mission instruction received from the communication station 2222.

In some embodiments of the present invention, the orbital computer 2211 and/or the processor 2212 may determine a high priority area of Earth 2240 based on mission instructions received and/or generated. The high priority area of Earth 2240 may be determined by the orbital computer 2211 and/or the processor 2212 based one or more portions of the mission data stored in the datastore 2214 and the mission parameters of the mission instructions, such as a predetermined target event 2404 of the mission instructions. The high priority target area of Earth 2240 may define a portion of the surface of the Earth 2240 that may have been calculated by the orbital computer 2211 and/or the processor 2212 to have a high probability of having the predetermined target event 2404 of the mission instructions therein. In some embodiments of the present invention, the orbital computer 2211 and/or the processor 2212 may be operable to generate a statistical analysis and/or history map at predetermined periodic periods of time and/or based on a mission instruction received from a communication station 2222. For example, upon receiving on the mission instruction, the orbital computer 2211 and/or the processor 2212 may generate a statistical analysis and/or history map based on mission data related to one or more target events 2404 detected and identified by the orbital computer 2211 and/or the processor 2212 to that have and/or were present in one or more areas and/or target areas 2254 of the Earth 2240 at and/or during one or more periods of time based on the mission instruction. The orbital computer 2211 and/or the processor 2212 may emit the statistical analysis to be received by the communication station 2222.

In some embodiments of the present invention, upon the orbital computer 2211 and/or the processor 2212 selectively controlling the lens(es) 2204 and/or light sensor(s) 2202 to take one or more frame(s) 2260, the orbital computer 2211 and/or the processor 2212 may determine a data computation size of the frame(s) 2260 taken, which includes the associated sensed light data of the frame(s) 2260. The orbital computer 2211 and/or the processor 2212 may determine if the data computation size is equal to and/or above a predetermined upper data computation size. Upon the orbital computer 2211 and/or the processor 2212 determining that the data computation size is equal to and/or above the predetermined upper data computation size, the orbital computer 2211 and/or the processor 2212 may send at least a portion of the frame(s) 2260 to other modular satellite(s) 100 for the other modular satellite(s) 100 to process the frame(s) 2260 and identify any target event(s) 2404 from the frame(s) 2260 received, and send any data relating to identified target event(s) 2404 from the frame(s) 2260 received back to the original modular satellite 100. The orbital computer 2211 and/or the processor 2212 may also determine and identify any target event(s) 2404 from the frame(s) 2260 that were not/are not sent to the other modular satellite(s) 100 for processing.

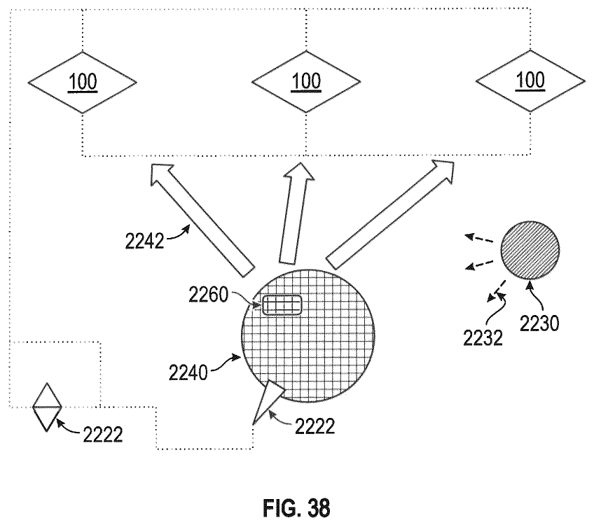

Now referring to FIG. 38, in some embodiments of the present invention the modular satellite 100 may be operable in a mesh network configuration. The mesh network configuration may comprise a plurality of modular satellites 100 in communication with one another, and/or may comprise the processors 2212 and/or network devices 2216 of each of the plurality of modular satellites 100 in communication with at least one of another modular satellite's 100 orbital computer 2211 and/or the processor 2212 and/or network device 2216 of the plurality of modular satellites 100. In the mesh network configuration, the modular satellites 100 may send, receive, and/or transceive signals and/or data with one another such as, and without limitation, mission instructions, mission types, mission parameters, mission data, frame(s) 2260, frame data, sensed light data, predetermined target area(s) 2254, predetermined target event(s) 2404, geolocations, orbit paths, current orbit path, new orbit path(s), orbit trajectory (ies), the filter range(s) 2702 of the filter device(s) 2201 carried by the modular satellite 100, courses of action, the target area 2254 of the mission instruction of the modular satellite 100, target event 2404 data, and/or any combinations thereof, which may be referred to as mesh data. Based on the shared mesh data, one or more of the modular satellites 100 of the mesh network configuration may operate in cooperation to perform a course of action identified from mission instructions received by one or more of the modular satellites 100.

For example, without limitation, based on the shared mesh data, one or more of the modular satellites 100 of the mesh network configuration may operate in cooperation to perform a course of action identified from mission instructions that includes one or more predetermined target events 2404 and/or predetermined target portions 2254 to search for, such that one or more of the modular satellites will share the mission instructions and each search for the predetermined target event(s) 2404 and/or each search the predetermined target portion(s) 2254 for target event(s) 2404. In some embodiments, the modular satellites 100 of the mesh network configuration may share the processing power of each of their processors 2212, such that any frames 2260 to be processed to determine any if target event(s) 2404 can be identified from the sensed light data of the frames 2260 may be shared so that the processing power burden is spread to multiple processors 2212 across two or more modular satellites 2212 of the mesh configuration.

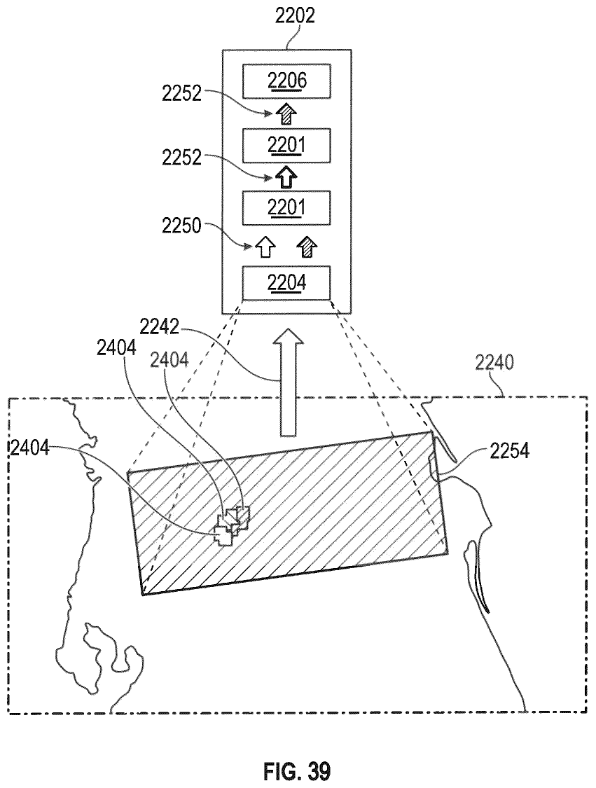

Now referring to FIG. 39, in some embodiments of the present invention, the light sensor(s) 2202 of the modular satellite 100 may include multiple filter devices 2201 positioned in series relative to one another, which, without limitation, may interchangeably be referred to as a series of filter devices 2201. The series of the filter devices 2201 may be configured to filter captured light 2250 and/or filtered light 2252 as it is received by each filter device 2201 of the series of filter devices 2201. For example, without limitation, the lens(es) 2204 may receive reflected light 2242 from an area of the surface of the Earth 2240, a target area 2254, and/or a predetermined target area 2254 and capture the reflected light 2242 as captured light 2250 which is directed by the len(es) 2204 at a first one of the filter devices 2201 in the series of filter devices 2201.

The first one of the filter devices 2201 may filter the captured light 2250 to form filtered light 2252 that may be directed to a second filter device 2201 in the series of filter devices 2201. The second filter device 2201 may receive the filtered light 2252 from the first one of the filter devices 2201 and filter that filtered light 2252 received to form a second filtered light 2252 which is also then directed towards one or more sub-sensor(s) 2206 of the light sensor 2202. The sub-sensor(s) 2206 may receive the filtered light from the second filter device 2201 of the series of filter devices 2201 to sensed and/or detect the one or more wavelengths of light that comprise the filtered light 2252 and sensed light data.

Despite the above description, it is also contemplated that the series of light filter devices 2201 may include two or more light filter devices 2201 positioned in series with adjacent light filter devices 2201 to form and/or define the series of light filter devices 2201. Each light filter device 2201 of the series of light filter devices 2201 may be configured to filter out at least one wavelength of light from light received thereby, including, without limitation, one or more of captured light 2250 and filtered light 2252. Each light filter device 2201 of the series of light filter devices 2201 may be configured to filter one or more wavelengths of light that may differ from the one or more wavelengths of light filtered by the other light filter devices 2201 of the series of light filter devices 2201.

The filtered light 2252 may be received by a light filter device 2201 from another light filter device 2201 of the series of light filter devices 2201, which may be referred to as a partially filtered light 2252. Also, the captured light 2252 received and filtered by a first light filter device 2201 of the series of light filter devices 2201 may also be referred to as a partially filtered light 2252 and/or a first partially filtered light 2252. The filtered light 2252 and/or partially filtered light 2252 may be referred to a “particular number” of filtered light 2252 associated with the position of the light filter device 2201 in the series of light filter devices 2201.

For example, without limitation, the partially filtered light 2252 from a light filter device 2201 positioned second or third in the series of light filter devices 2201 relative to the lens 2204, may be referred to as a second or third partially filtered light 2252. Additionally, the filtered light 2252 and/or partially filtered light 2252 for a last one of the light filter devices 2201 of the series of light filter devices 2201 may be referred to as filtered light 2252, last filtered light 2252, resulting filtered light 2252, and/or final filtered light 2252, without limitation.

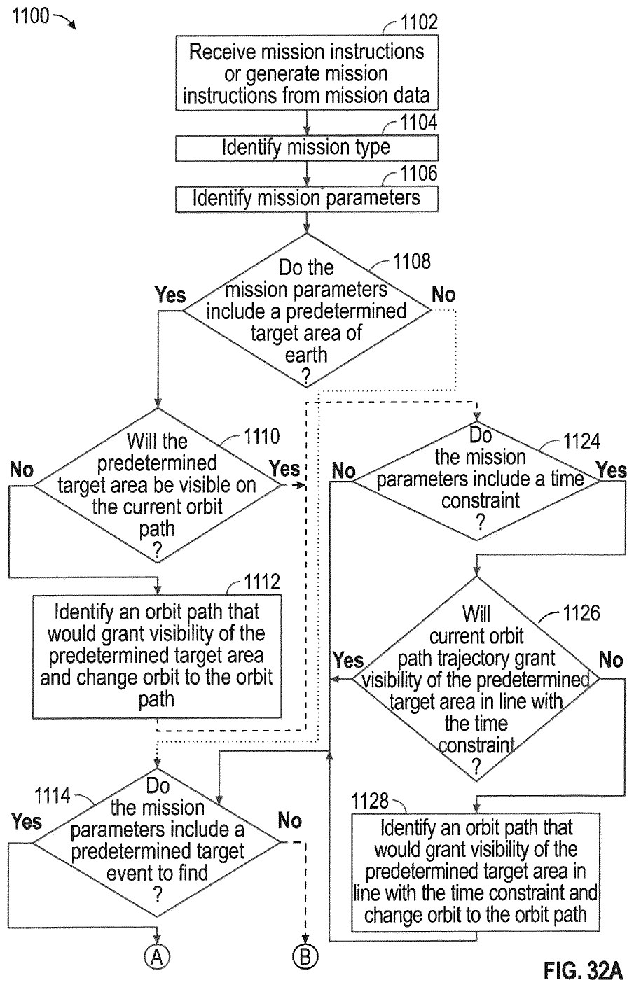

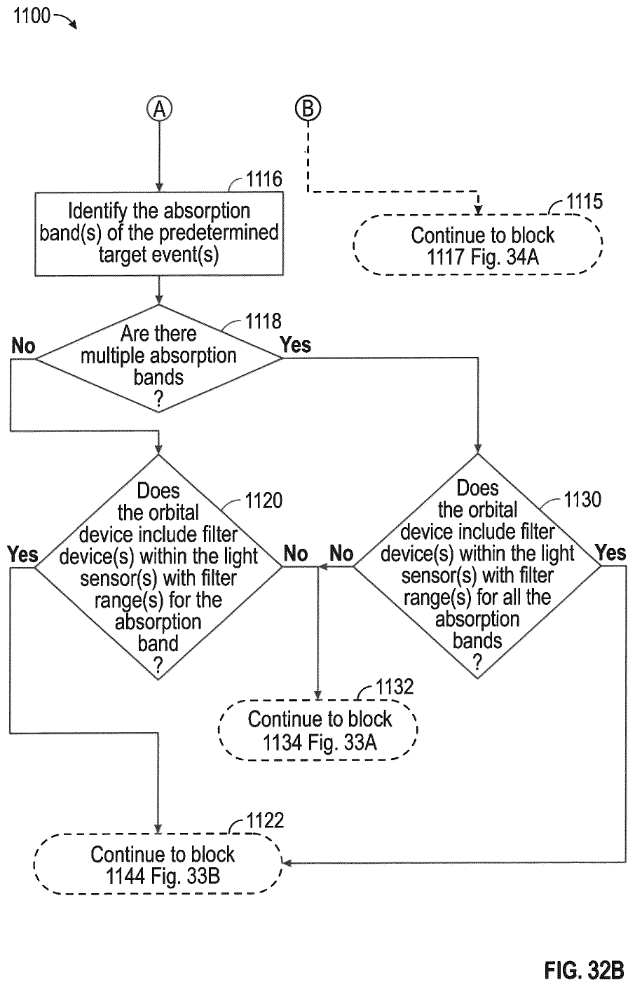

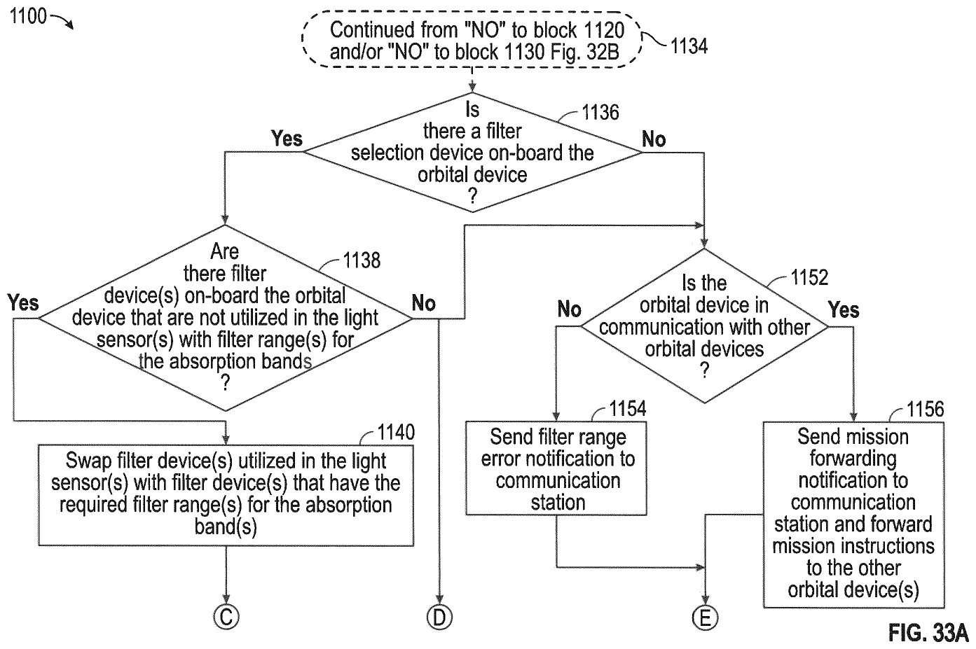

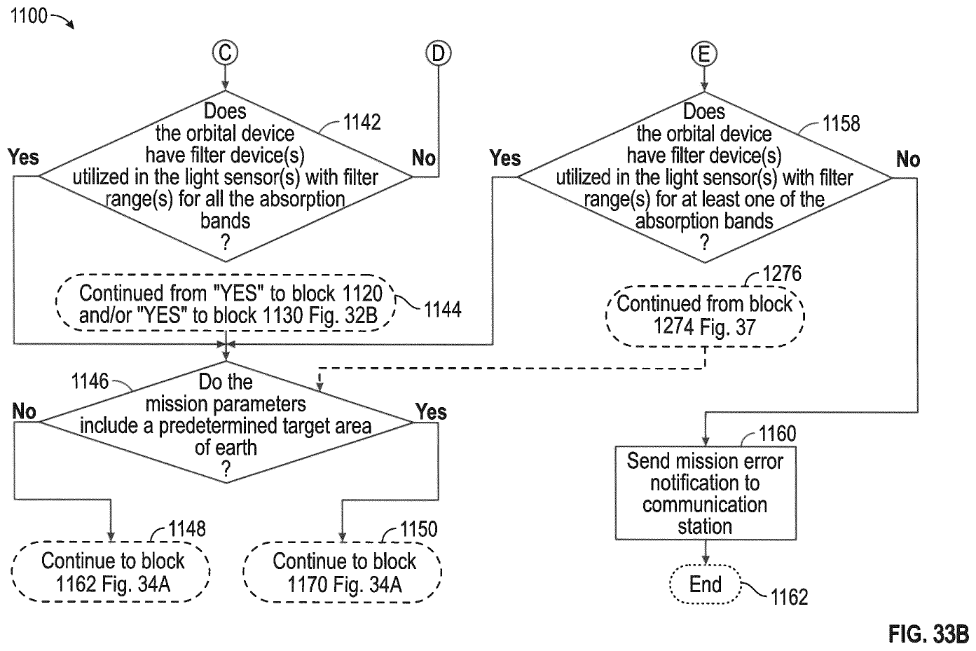

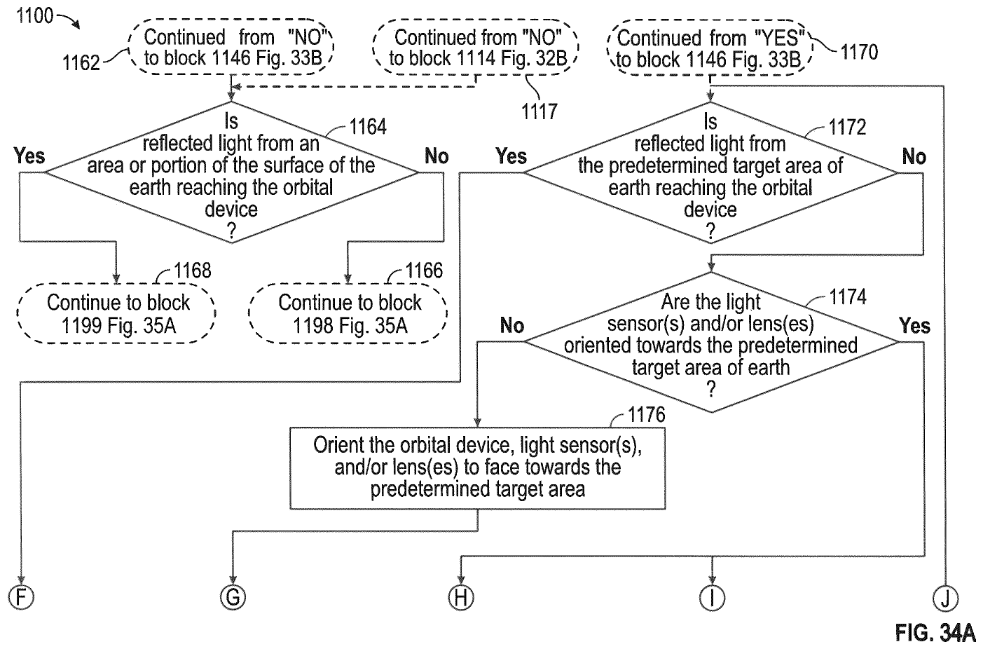

Now referring to FIGS. 32A-37, a method aspect 1100 of some embodiments of the present invention is illustratively shown. The method aspect 1100 may be performed by some embodiments of a modular satellite 100 as described herein upon receiving and/or generating mission instructions. For further increased terseness, and for the purposes of the description of method aspect 1100 of embodiments of the present invention, it should be understood that the terms modular satellite 100 and orbital computer 2211 may be used interchangeably and may be used to reference any one of the filter device(s) 2201, the light sensor(s) 2202, the lens(es) 2204, the sub-sensor(s) 2206, the processor 2212, the datastore 2214, the network device 2216, the power unit 2218, the orientation component(s) 2213, the filter selection device(s) 3002, the selection arm(s) 3112, and the filter library (ies) 3114 individually, entirely all together, and/or in any combination or combinations thereof without limitation.

Starting at Block 1102 illustratively shown in FIG. 32A, modular satellite 100 may receive mission instructions, and/or the modular satellite 100 may generate mission instructions based on the mission data that may include one or more of saved data of past and/or current/present: mission instruction(s), frames 2260, series of frames 2260, performed frame rates, timestamps, geolocations, sensed light data, detected target event(s) 2404, predetermined target area(s) 2254, detected/identified target event(s) 2404 and/or courses of action. The modular satellite 100 may then continue to Block 1104 and identify a mission type of/from the mission instructions and may then continue to Block 1106 and identify mission parameters of/from the mission instructions. The modular satellite 100 may then continue to Block 1108 and determine whether the mission parameters include a predetermined target area 2254 of Earth 2240. If, at Block 1108 the modular satellite 100 determines that the mission parameters do not include a predetermined target area 2254 of Earth 2240, then the modular satellite 100 may continue to Block 1114 to determine whether the mission parameters include a predetermined target event 2404 to find. If, however, at Block 1108 the modular satellite 100 determines that the mission parameters do include a predetermined target area 2254 of Earth 2240, the modular satellite 100 may then continue to Block 1110 and determine whether the predetermined target area 2254 will be visible on the current orbit path of the modular satellite 100. However, at Block 1110, if the modular satellite 100 determines that the predetermined target area 2254 will not be visible from the current orbit path of the modular satellite 100, then the modular satellite 100 may move to Block 1112 to identify and orbit path that would grant visibility of the predetermined target area 2254 and change its orbit to that identified orbit path.

The modular satellite 100 may then continue to Block 1124 to determine whether the mission parameters include a time constraint. If, at Block 1124 the modular satellite 100 determines that the mission parameters include a time constraint, the modular satellite 100 may continue to Block 1126 to determine if the current orbital path trajectory of the modular satellite 100 will grant visibility of the predetermined target area in line with the time constraint. If, at Block 1126 the modular satellite 100 determines that the current orbital path trajectory of the modular satellite 100 will grant visibility of the predetermined target area in line with the time constraint, the modular satellite 100 may then continue to Block 1114 to determine whether the mission parameters include a predetermined target event 2404 to find. If, however, at Block 1126, the modular satellite 100 determines that determines that the current orbital path trajectory of the modular satellite 100 will not grant visibility of the predetermined target area in line with the time constraint, then the modular satellite 100 may continue to Block 1128 to identify an orbit path that would grant visibility of the predetermined target area in line with the time constraint and change orbit to that orbit path. Then, from Block 1128, the modular satellite 100 may continue to Block 1114. If, however, at Block 1124 the modular satellite 100 determined that the mission parameters do not include a time constraint, then the modular satellite 100 may continue directly to Block 1114 to determine if the mission parameters include a predetermined target event to find.

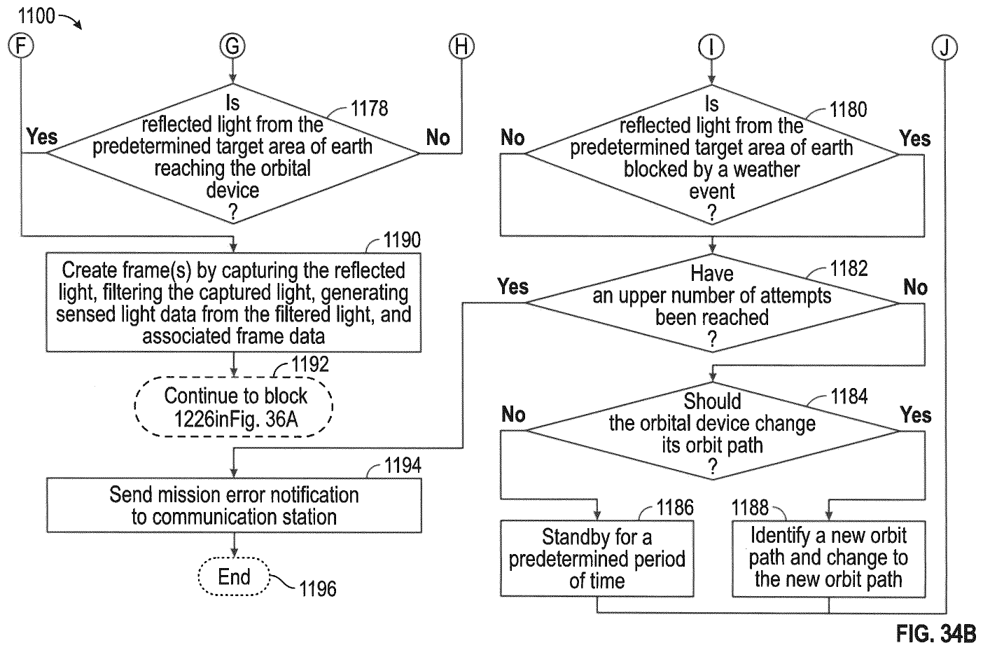

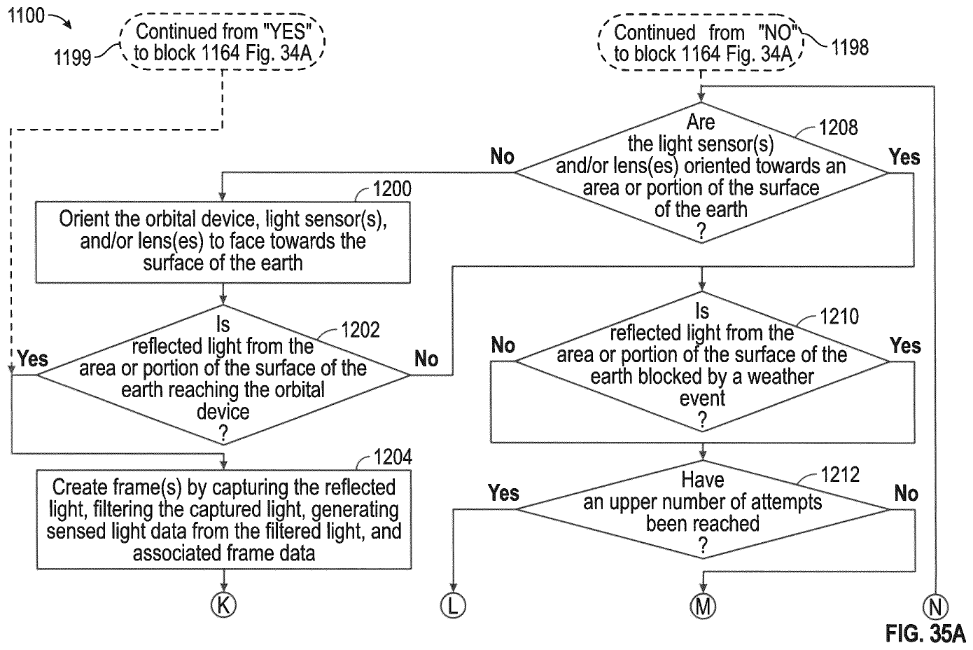

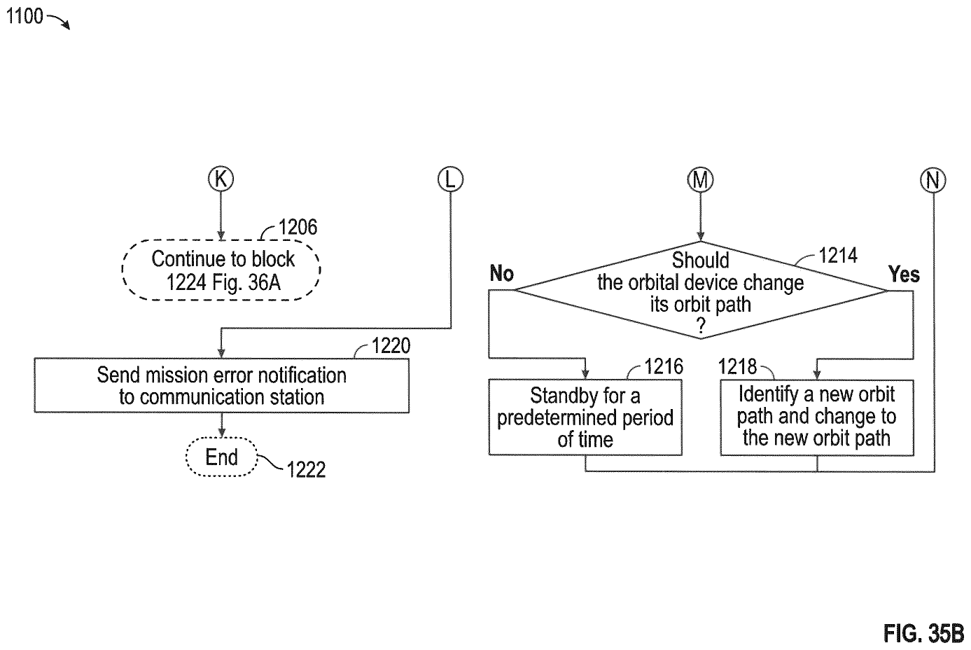

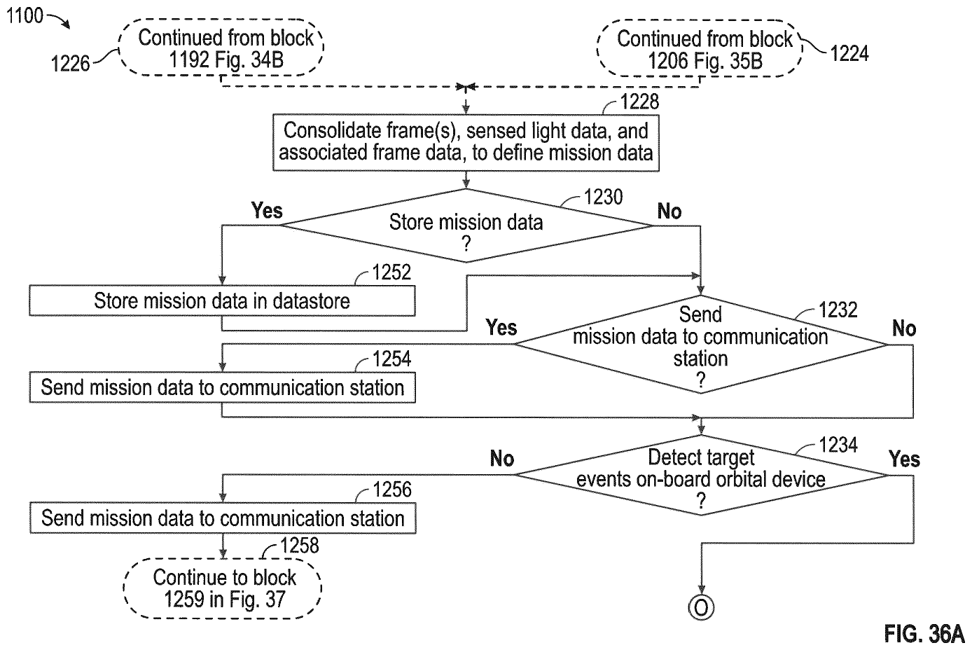

At Block 1114, if the modular satellite 100 determines that the mission parameters do not include a predetermined target event to find, then the modular satellite 100 may continue to Block 1115 and move to Block 1117 in FIG. 34A. If, however, at Block 1114 the modular satellite 100 determined that the mission parameters do include a predetermined target event to find, then the modular satellite 100 may continue to Block 1116 to identify the absorption pant(s) of the predetermined target event(s). From Block 1116, the modular satellite 100 may then continue to Block 1118 to determine if there are multiple absorption bands identified from the predetermined target event(s). if, at Block 1118, the modular satellite 100 determines that there are multiple absorption bands identified from the predetermined target event(s), then the modular satellite 100 may continue to Block 1130 to determine if there are filter device(s) 2201 carried by the light sensor(s) 2202 of the modular satellite 100 have filter range(s) 2702 for all of the identified absorption bands. If, at Block 1130 the modular satellite 100 determines that there are filter device(s) 2201 carried by the light sensor(s) 2202 of the modular satellite 100 have filter range(s) 2702 for all of the identified absorption bands, then the modular satellite 100 may continue to Block 1122 to move to Block 1144 on FIG. 33B. If, however, at Block 1130 the modular satellite 100 determines that there are filter device(s) 2201 carried by the light sensor(s) 2202 of the modular satellite 100 do not have filter range(s) 2702 for all of the identified absorption bands, then the modular satellite 100 may continue to Block 1132 to move to Block 1134 in FIG. 33A.

If, however, at Block 1118 the modular satellite 100 determines that there is only a single absorption band identified from the predetermined target events of the mission parameters, then the modular satellite 100 may continue to Block 1120 to determine if the modular satellite 100 includes filter device(s) 2201 carried by the light sensor(s) 2202 that have the filter range(s) 2702 for the single absorption band identified. If, at Block 1120, the modular satellite 100 determines that there are filter device(s) 2201 carried by the light sensor(s) 2202 of the modular satellite 100 have filter range(s) 2702 for the identified absorption band, then the modular satellite 100 may continue to Block 1122 to move to Block 1144 on FIG. 33B. If, however, at Block 1120 the modular satellite 100 determines that there are filter device(s) 2201 carried by the light sensor(s) 2202 of the modular satellite 100 do not have filter range(s) 2702 for the identified absorption band, then the modular satellite 100 may continue to Block 1132 to move to Block 1134 in FIG. 33A.

Now referring to FIG. 33A, at Block 1134, the modular satellite 100 continues the method 1100 from a determination of “no” to either Block 1120 or Block 1130 and may then move to Block 1136 to determine if there is a filter selection device 3002 onboard the modular satellite 100. If, at Block 1136, the modular satellite 100 determined that there is a filter selection device 3002 onboard the modular satellite 100, then the modular satellite 100 may continue to Block 1138 to determine if there are filter device(s) 2201 on board the modular satellite 100 that are not currently utilized in the light sensor(s) 2202 that have filter range(s) 2702 for the absorption band(s) to replace any filter device(s) 2201 that are currently utilized in the light sensor(s) 2202 which have filter range(s) 2702 inapplicable to the identified absorption band(s). If, at Block 1138, the modular satellite 100 determines that there are filter device(s) 2201 on board the modular satellite 100 that are not currently utilized in the light sensor(s) 2202 that have filter range(s) 2702 for the absorption band(s), then the modular satellite 100 may continue to Block 1140 to swap the filter device(s) 2201 utilized in the light sensor(s) 2202 with filter device(s) that have the required filter range(s) 2702 for the identified absorption band(s). Then, from Block 1140, the modular satellite 100 may continue the method 1100 to move to Block 1142 to determine if the modular satellite 100 now has filter device(s) 2201 utilized in the light sensor(s) 2202 with filter range(s) 2702 for all the identified absorption band(s).

If, at Block 1142, the modular satellite 100 determines that the modular satellite 100 now has filter device(s) 2201 utilized in the light sensor(s) 2202 with filter range(s) 2702 for all the identified absorption band(s), then the modular satellite 100 may continue to Block 1146 to determine if the mission parameters include a predetermined target area of Earth 2240. If, however, the modular satellite 100 determines and answer of “no” to any of Blocks 1136, 1138, or 1142, then the modular satellite 100 may move to Block 1152 to determines if the modular satellite 100 is in communication with other modular satellite(s) 100. If, at Block 1152 the modular satellite 100 determines that the modular satellite 100 is in communication with other modular satellite(s) 100, then the modular satellite 100 may continue to Block 1156 to send a mission forwarding notification to the communication station(s) 2222 and to forward the mission instructions to the other modular satellite(s) 100 for the other modular satellite(s) 100 to perform at least a portion thereof. Then, the modular satellite 100 may continue the method 1100 to Block 1158 to determine if the modular satellite 100 has filter device(s) 2201 utilized in the light sensor(s) 2202 having filter range(s) 2702 for at least one of the identified absorption band(s). If, at Block 1158, the modular satellite 100 determined that it does not have filter device(s) 2201 utilized in the light sensor(s) 2202 having filter range(s) 2702 for at least one of the identified absorption band(s), then the modular satellite 100 may continue to Block 1160 to send a mission error notification to the communication station(s) 2222 and then move to Block 1162 to end the method 1100.

If, however, at Block 1158, the modular satellite 100 determines that the modular satellite 100 has filter device(s) 2201 utilized in the light sensor(s) 2202 that have filter range(s) 2702 for at least one of the identified absorption band(s), then the modular satellite 100 may instead move to Block 1146 to determine if the mission parameters include a predetermined target area of Earth 2240. If, however, the modular satellite 100 determines an answer of “no” to either of Blocks 1120 or 1130, then the modular satellite 100 may continue directly to Block 1146 from Blocks 1120 or 1130. If, at Block 1146, the modular satellite 100 determines that the mission parameters do not include a predetermined targe area of Earth 2240, then the modular satellite 100 may continue to Block 1148 to then move to Block 1162 in FIG. 34A. If, however, at Block 1146, the modular satellite 100 determines that the mission parameters do include a predetermined targe area of Earth 2240, then the modular satellite 100 may continue to Block 1150 to then move to Block 1170 in FIG. 34A.

Now referring to FIG. 34A, the modular satellite 100 may continue to Block 1162 upon determining an answer of “no” to Block 1146 in FIG. 33B to determine if reflected light 2242 from an area or portion of the surface of the Earth 140 is reaching the modular satellite 100. If, however, at Block 1114 in FIG. 32A, the modular satellite 100 determined an answer of “no,” then the modular satellite 100 may proceed directly to Block 1164 from Block 1114. If, at Block 1164, the modular satellite 100 determined that reflected light 2242 from an area or portion of the surface of the Earth 2240 is reaching the modular satellite 100, then the modular satellite 100 may continue to Block 1168 to move to Block 1199 in FIG. 35A. If, however, at Block 1164 the modular satellite 100 determines that reflected light 2242 from an area or portion of the surface of the Earth 2240 is not reaching the modular satellite 100, then the modular satellite 100 may continue to Block 1166 to move to Block 1198 in FIG. 35A.

If, however, at Block 1146, the modular satellite 100 determined an answer of “no,” then the modular satellite 100 may instead continue to Block 1170 and move to Block 1172 from Block 1146. At Block 1172, the modular satellite 100 may determine if reflected light 2242 from a predetermined target area 2254 of Earth 2240 is reaching the modular satellite 100. If, the modular satellite 100 determines that reflected light 2242 from a predetermined target area 2254 of Earth 2240 is reaching the modular satellite 100, then the modular satellite 100 may continue to Block 1190 to create frame(s) 2260 by capturing the reflected light 2242 to form captured light 2250, filtering the captured light 2250 to form filtered light 2252, generating sensed light data from the filtered light 2252, and associating frame data with each frame 2260. If, however, at Block 1172, the modular satellite 100 determines that the reflect light 2242 from the predetermined target area 2254 of Earth 2240 is not reaching the modular satellite 100, then the modular satellite 100 may instead move to Block 1174 from Block 1172.

At Block 1174, the modular satellite 100 may determine if the light sensor(s) 2202 and/or lens(es) 2204 are oriented towards the predetermined target area 2254 of Earth 2240. If, the modular satellite 100 determines that the light sensor(s) 2202 and/or lens(es) 2204 are not oriented towards the predetermined target area 2254 of Earth 2240, then the modular satellite 100 may move to Block 1176 to selectively control the orientation components 2213, the light sensor(s) 2202, and/or the lens(es) 2204 to orient the light sensor(s) 2202 and/or the lens(es) 2204 to face towards the predetermined target area 2254. Then, from Block 1176, the modular satellite 100 may continue to Block 1178 to again determine if reflected light 2242 is reaching the modular satellite 100 from the predetermined target area 2254. If, the modular satellite 100 determines that reflected light 2242 is reaching the modular satellite 100 from the predetermined target area 2254, then the modular satellite 100 may continue to Block 1190 to create frame(s) 2260 by capturing the reflected light 2242 to form captured light 2250, filtering the captured light 2250 to form filtered light 2252, generating sensed light data from the filtered light 2252, and associating frame data with each frame 2260.

If, however, at Block 1178, the modular satellite 100 determines that reflected light 2242 from the predetermined target area 2254 is not reaching the modular satellite 100, then the modular satellite 100 may instead move to Block 1180 to determine if the reflected light 2242 from the predetermined target area 2254 of Earth 2240 is Block by a weather event. However, if at Block 1174, the modular satellite 100 determines that the light sensor(s) 2202 and/or the lens(s) 2204 are not oriented towards the predetermined target area 2254 of Earth 2240, then the modular satellite 100 may continue directly to Block 1180 from 1174 to determine if the reflected light 2242 from the predetermined target area 2254 of Earth 2240 is Block by a weather event. At Block 1180, whether the modular satellite 100 determines and answer of “yes” or “no” whether the reflected light 2242 from the predetermined target area 2254 of Earth 2240 is blocked by a weather event, the modular satellite 100 may continue to Block 1182 to determine if a number of attempts by the modular satellite 100 to receive reflected light 2242 from the predetermined target area 2254 of Earth 2240 has reach a number that is equal to or greater than an upper number of attempts. If the modular satellite 100 determines an answer of “yes” to Block 1182, then the modular satellite 100 may continue to Block 1194 to send a mission error notification to the communication station(s) 2222 and then move to Block 1196 to end the method 1100.

If, however, the modular satellite 100 determines an answer of “no” to Block 1182, then the modular satellite 100 may instead continue to Block 1184 from Block 1182. At Block 1184, the modular satellite 100 may determine if the modular satellite 100 should change its orbit path. If the modular satellite 100 determines that the modular satellite 100 should not change its orbit path, then the modular satellite 100 may move to Block 1186 to continue its current orbit path and standby for a predetermined period of time. The, from Block 1186, the modular satellite 100 may continue to Block 1172 to again determine if reflected light 2242 from the predetermined target area 2254 of Earth 2240 is reaching the modular satellite 100 and continue the method 1100. If, however, at Block 1184 the modular satellite 100 determines that it should not change its orbit path, then the modular satellite 100 may instead continue to Block 1188 to identify a new orbit path and to change its orbit path to the new orbit path. Then, from Block 1188, the modular satellite 100 may continue to Block 1172 to again determined if reflected light 2242 from the predetermined target area 2254 of Earth 2240 is reaching the modular satellite 100 and continue the method 1100.

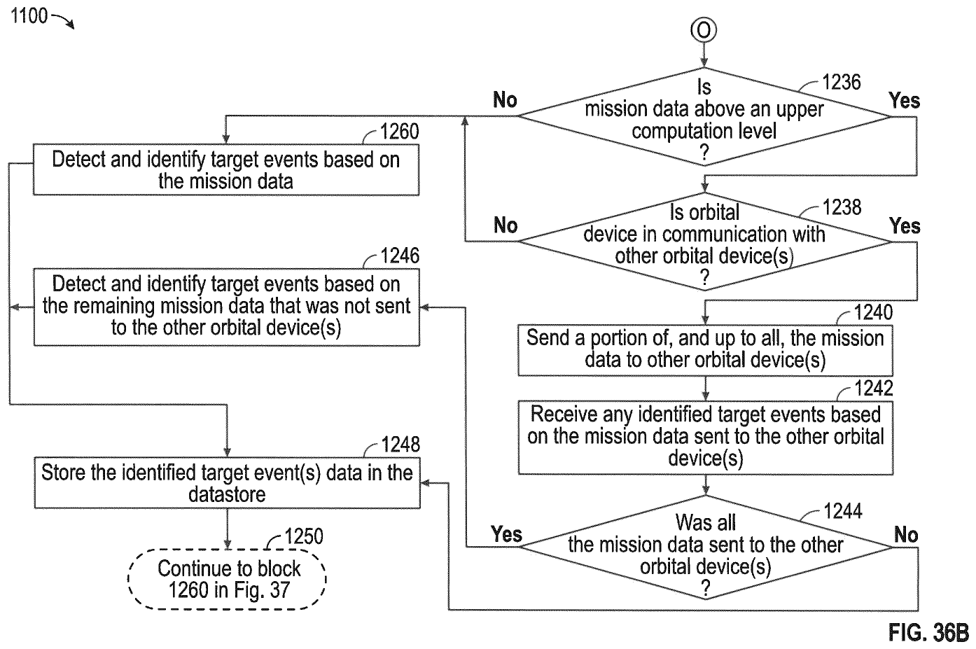

Now referring to FIG. 35A, if the modular satellite 100 determined an answer of “yes” to Block 1164 in FIG. 34A, then the modular satellite 100 may continue directly to Block 1199 from Block 1164 to then move to Block 1204 to create frame(s) 2260 from the reflected light 2242 received from an area/portion of the surface of the Earth 2240 by capturing the reflected light 2242 to form captured light 2250, filtering the captured light 2250 to form filtered light 2252, generating sensed light data from the filtered light 2252, and associating frame data with each frame 2260. Then, from Block 1204, the modular satellite 100 may continue the method 1100 to Block 1206 to then move to Block 1224 in FIG. 36A.

If, however, the modular satellite 100 determined an answer of “no” back at Block 1164 in FIG. 34A, then the modular satellite 100 may instead continue to Block 1198 from Block 1164 to then move to Block 1208 to determine if the light sensor(s) 2202 and/or lens(es) 2204 of the modular satellite 100 are oriented towards an area/portion of the surface of the Earth 2240. If, the modular satellite 100 determines that the light sensor(s) 2202 and/or lens(es) 2204 of the modular satellite 100 are not oriented towards an area/portion of the surface of the Earth 2240, then the modular satellite 100 may continue to Block 1200 to selectively control the orientation components 2213, the light sensor(s) 2202, and/or the lens(es) 2204 to orient the light sensor(s) 2202 and/or the lens(es) 2204 to face towards an area/portion of the surface of the Earth 2240. Then, from Block 1200, the modular satellite 100 may continue to Block 1202 to again determine if reflected light 2242 is reaching the modular satellite 100 from an area/portion of the surface of the Earth 2240. If, at Block 1202, the modular satellite 100 determines that reflected light 2242 is reaching the modular satellite 100 from an area/portion of the surface of the Earth 2240, then from Block 1202 the modular satellite 100 may move to Block 1204 to create frame(s) 2260 from the reflected light 2242 received from an area/portion of the surface of the Earth 2240 by capturing the reflected light 2242 to form captured light 2250, filtering the captured light 2250 to form filtered light 2252, generating sensed light data from the filtered light 2252, and associating frame data with each frame 2260.

If, however, at Block 1202, the modular satellite 100 determines that reflected light 2242 is not reaching the modular satellite 100 from an area/portion of the surface of the Earth 2240, then from Block 1202 the modular satellite 100 may instead move to Block 1210 to determine if reflected light 2242 from an area/portion of the surface of the Earth 2240 is being blocked by a weather event. If, however, at Block 1208, the modular satellite 100 determined that the light sensor(s) 2202 and/or lens(es) 2204 of the modular satellite 100 are oriented towards an area/portion of the surface of the Earth 2240, then the modular satellite 100 may proceed directly to Block 1210 from Block 1208. At Block 1210, whether the modular satellite 100 determines an answer of “yes” or “no” to whether reflected light 2242 from an area/portion of the surface of the Earth 2240 is being blocked by a weather event, the modular satellite 100 may continue to Block 1212 to determine if a number of attempts by the modular satellite 100 to receive reflected light 2242 from an area/portion of the surface 2254 of Earth 2240 has reach a number that is equal to or greater than an upper number of attempts. If the modular satellite 100 determines an answer of “yes” to Block 1212, then the modular satellite 100 may continue to Block 1220, to send a mission error notification to the communication station(s) 2222 and then move to Block 1222 to end the method 1100.

If, however, the modular satellite 100 determines an answer of “no” to Block 1212, then the modular satellite 100 may instead continue to Block 1214 from Block 1212. At Block 1214, the modular satellite 100 may determine if the modular satellite 100 should change its orbit path. If the modular satellite 100 determines that the modular satellite 100 should not change its orbit path, then the modular satellite 100 may move to Block 1216 to continue its current orbit path and standby for a predetermined period of time. Then, from Block 1216, the modular satellite 100 may continue to Block 1208 to again determine if reflected light 2242 from an area/portion of the Earth 2240 is reaching the modular satellite 100 and continue the method 1100. If, however, at Block 1214, the modular satellite 100 determines that it should not change its orbit path, then the modular satellite 100 may instead continue to Block 1218 to identify a new orbit path and to change its orbit path to the new orbit path. Then, from Block 1218, the modular satellite 100 may continue to Block 1208 to again determined if reflected light 2242 from an area/portion of the Earth 2240 is reaching the modular satellite 100 and continue the method 1100.

Now referring to FIG. 36A, the method 1100 may be continued by the modular satellite 100 to Block 1228 from either, Block 1226 from Block 1192 of FIG. 34B, or also to Block 1228 from Block 1224 from Block 1206 of FIG. 35B. At Block 1228, the modular satellite 100 may consolidate the frame(s) 2260, the sensed light data, and the associated frame data to define mission data. Then the modular satellite 100 may continue to Block 1230 to determine whether to store the mission data in the datastore 2214. If, at Block 1230, the modular satellite 100 determines that is should store the mission data, then the modular satellite 100 may move to Block 1252 to store the mission data in the datastore 2214 and then move to Block 1232. If, however, at Block 1230, the modular satellite 100 determines that it should not store the mission data, then the modular satellite 100 may proceed directly to Block 1232 from Block 1230.

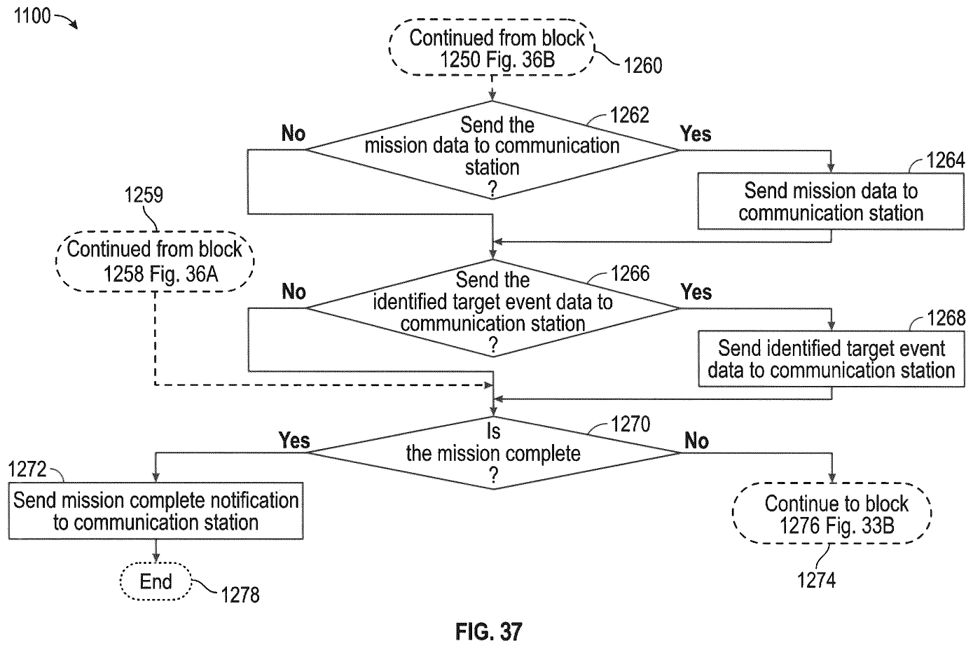

At Block 1232, the modular satellite 100 may determine whether to send the mission data to the communication station(s) 2222. If, at Block 1232, the modular satellite 100 determines that it should send the mission data to the communication station(s) 2222, then the modular satellite 100 may continue to Block 1254 to send the mission data to the communication station(s) 2222. From Block 1254 the modular satellite 100 may continue to Block 1234 to determine if target events 2404 are to be identified from the mission data, frames, and/or sensed light data by the modular satellite 100. However, if at Block 1232 the modular satellite 100 determines that it should not send the mission data to the communication station(s) 2222, then the modular satellite 100 may continue the method 1100 directly to Block 1234. If, at Block 1234, the modular satellite 100 determines that it should not identify target events 2404 from the mission data, frames, and/or sensed light data by the modular satellite 100, then the modular satellite 100 may continue to Block 1256 and send the mission data, frame(s), frame data, and/or sensed light data to the communication station(s) 2222 for the communication station(s) 2222 to parse the mission data, frame(s), frame data, and/or sensed light data to identify any target event(s) 2404 therefrom. Then, from Block 1256, the modular satellite 100 may continue to Block 1258 to then move to Block 1259 illustratively shown in FIG. 37.

If, however, at Block 1234 the modular satellite 100 determines that target event(s) 2404 are to be detected and identified by the modular satellite 100, and not by another system, then the modular satellite 100 may continue to Block 1236 to determine whether the mission data has a file data size that is equal to and/or above an upper computation level. If the modular satellite 100 determines that the mission data has a file data size that is equal to and/or above an upper computation level, then the modular satellite 100 may continue to Block 1238 to determine whether the modular satellite 100 is in communication with one or more other modular satellite(s) 100. If the modular satellite 100 determines that it is in communication with one or more other modular satellite(s) 100, then the modular satellite 100 may move to Block 1240 to send a portion of, and up to all, the mission data, frame(s), frame data, and/or sensed light data to the other modular satellite(s) 100 for the other modular satellite(s) 100 to parse the mission data, frame(s), frame data, and/or sensed light data to identify any target event(s) 2404 therefrom. From Block 1240, the modular satellite 100 may then continue to Block 1242 to receive any identified target event(s) 2404 from the other modular satellite(s) 100 that were identified by the other modular satellite(s) 100 from the mission data, frame(s), frame data, and/or sensed light data that was sent thereto.

From Block 1242, the modular satellite 100 may move to Block 1244 to determine if all the mission data, frame(s), frame data, and/or sensed light data was sent to the other modular satellite(s) 100 for the other modular satellite(s) 100 to parse the mission data, frame(s), frame data, and/or sensed light data to identify any target event(s) 2404 therefrom. If, at Block 1242, the modular satellite 100 determines that it did not send all the mission data, frame(s), frame data, and/or sensed light data to the other modular satellite(s) 100, then the modular satellite 100 may continue to Block 1246 to detect and identify target event(s) 2404 based on the remaining mission data, frame(s), frame data, and/or sensed light data that was not sent to the other modular satellite(s) 100. Then, from Block 1246, the modular satellite 100 may continue to Block 1248 to store the identified target event(s) 2404 data in the datastore 2214. If, however, at Block 1244, the modular satellite 100 determines that all the mission data, frame(s), frame data, and/or sensed light data was sent to the other modular satellite(s) 100, then the modular satellite 100 may continue directly to Block 1248 from Block 1244 and continue the method 1100 therefrom.

If, however, that modular satellite 100 determines an answer of “no” to either of Block 1236 or 1238, then the modular satellite 100 may continue the method 1100 to Block 1260 to detect and identify target events 2404 from the mission data, frame(s), frame data, and/or sensed light data. Then, from Block 1260, the modular satellite 100 may continue to Block 1248 to store the identified target event(s) 2404 data in the datastore 2214.

Now additionally referring to FIG. 37, from Block 1248, the modular satellite 100 may continue the method 1100 to Block 1250 and move to Block 1260. From Block 1260, the modular satellite 100 may continue to Block 1262 to determine whether to send the mission data, frame(s), frame data, and/or the sensed light data to the communication station(s) 2222. If the modular satellite 100 determines that it should send the mission data, frame(s), frame data, and/or the sensed light data to the communication station(s) 2222, then the modular satellite 100 may move to Block 1264 to send the mission data, frame(s), frame data, and/or the sensed light data to the communication station(s) 2222. Then from Block 1264, the modular satellite 100 may continue to Block 1266 to determine whether to send the identified target event(s) 2404 data to the communication station(s) 2222.

If, however, at Block 1262, the modular satellite 100 determines that it should not send the mission data, frame(s), frame data, and/or the sensed light data to the communication station(s) 2222, the modular satellite 100 may then continue directly to Block 1266 to determine whether to send the identified target event(s) 2404 data to the communication station(s) 2222. At Block 1266, if the modular satellite 100 determines that it should send the identified target event(s) 2404 data to the communication station(s) 2222, then the modular satellite 100 may move to Block 1268 to send the identified target event(s) 2404 data to the communication station(s) 2222. Then, from Block 1268, the modular satellite 100 may continue to Block 1270 to determine whether the mission has been completed based on the mission instructions, the identified mission type, the identified mission parameters, the mission data, frame(s), the frame data, and/or the sensed light data.

If, however, at Block 1266, the modular satellite 100 determines that it should not send the identified target event(s) 2404 data to the communication station(s) 2222, then from Block 1266 the modular satellite 100 may continue directly to Block 1270 to determine whether the mission has been completed based on the mission instructions, the identified mission type, the identified mission parameters, the mission data, frame(s), the frame data, and/or the sensed light data. As mentioned above, if the modular satellite 100 is at Block 1258, the modular satellite 100 may continue the method 1100 from Block 1258 in FIG. 36A to Block 1259 in FIG. 37 to then move to Block 1270 to determine whether the mission has been completed based on the mission instructions, the identified mission type, the identified mission parameters, the mission data, frame(s), the frame data, and/or the sensed light data.

At Block 1270, if the modular satellite 100 determines that the mission has been completed based on the mission instructions, the identified mission type, the identified mission parameters, the mission data, frame(s), the frame data, and/or the sensed light data, then the modular satellite 100 may continue to Block 1272 to send a mission complete notification to the communication station(s) 2222. Then from Block 1272, the modular satellite 100 may continue to Block 1278 to end the method 1100. However, if at Block 1270 the modular satellite 100 determines that the mission has not been completed based on the mission instructions, the identified mission type, the identified mission parameters, the mission data, frame(s), the frame data, and/or the sensed light data, then the modular satellite 100 may continue to Block 1274 to move to Block 1276 illustratively shown in FIG. 33B to continue and repeat at least a portion of the method 1100 as described herein.

Referring to FIG. 40, a modular satellite 100 according to one embodiment includes a first memory segment such as mission operation identifier memory segment 4002, a first sensor such as a position sensor 4003, a second sensor such as orbital camera 4006, a mission operation selector 4008, an object detector 4010, an analytic generator such as mission analytics packet generator 4012, and a communication interface such as transceiver 4014. Also, the communication interface and/or the transceiver 4014 may comprise one or more of other components described herein, such as, and without limitation, one or more of the communications system 1004, the antenna 902, the transponder 1203, and/or the network device 2216.

The mission operation identifier memory segment 4002 stores a mission operation lookup table 4016 that includes at least one mission operation 4018 having a mission operation identifier 4020 associated with mission parameter constraints 4022, a target object type 4024 and object detection model parameters 4026 associated with the target object type 4024.

In one embodiment, the position sensor 4003 provides satellite sensor data 4027 that represents orbital mission characteristics 4028. The satellite sensor data 4027 may represent satellite telemetry data. The orbital camera 4006 captures images 4030. The mission operation selector 4008 is responsive to the orbital mission characteristics 4028 and the mission parameter constraints 4022 for selecting the mission operation identifier 4020 associated with the mission parameter constraints 4022 for the at least one mission operation 4018.

The object detector 4010 is responsive to the captured images 4030 and the object detection model parameters 4026 associated with the selected mission operation identifier 4020 for detecting objects 4032 from the captured images 4030. The detected objects 4032 having an object classification associated with the target object type 4024. The mission analytics packet generator 4012 is responsive to the detected objects 4032, the orbital mission characteristics 4028, and the mission operation identifier 4020 for creating a mission analytics packet 4034. The transceiver 4014 transfers the mission analytics packet 4034 to a client terminal 4036.

In one embodiment, the mission analytics packet generator 4012 may create mission analytics priority packet 4035 associated with the mission analytics packet 4034. The mission analytics priority packet 4035 includes the mission packet identifier 4038 and mission priority characteristics 4040. For example, the mission priority characteristics 4040 is based on the mission parameter constraints 4022 for the mission packet identifier 4038 and the orbital mission characteristics 4028.

The modular satellite 100 may include a second memory segment such as a mission analytics packet priority memory segment 4042, a third memory segment such as a mission analytics packet catalogue memory segment 4044, a modular satellite controller 4046, and a mission analytics packet identifier relay 4048. The mission analytics packet priority memory segment 4042 may store a mission analytics lookup table 4050 that includes the mission packet identifiers 4038 and the mission priority characteristics 4040. The mission analytics packet catalogue memory segment 4044 may store a mission analytics packet catalogue 4052 that includes each mission analytics packet 4034 associated with the mission operation identifier 4020 selected by the mission operation selector 4008. In one embodiment, each mission analytics packet 4034 includes the packet mission identifier 4038, the mission operation identifier 4020, the detected objects 4032, the orbital mission characteristics 4028, and the captured images 4030. Alternatively, the captured images 4030 may be omitted from the mission analytics packet 4034.

It is contemplated, without limitation, that in some embodiments of the present invention, that the modular satellite controller 4046 may comprise one or more of, include one or more of the features of, and/or include one or more of the same or similar features as, the processor 1014, the hardware communication component 1016, the non-transitory computer readable memory 1012, the orbital computer 2211, and/or the processor 2212, as described above an illustratively shown in FIGS. 10 and 22. The modular satellite controller 4046 may provide a packet identifier request 4054, and the mission analytics packet identifier relay 4048 is responsive to the packet identifier request 4054 for providing at least one of the mission packet identifiers 4038 to the modular satellite 100 controller 4046. The modular satellite controller 4046 is responsive to the mission packet identifiers 4038 for selecting one of the mission analytics packets 4034 from the mission analytics packet catalogue 4052.

The at least one mission operation 4018 may be an application-specific mission operation. In one embodiment, (a) the client terminal 4036 may be a terrestrial ground station, (b) the mission parameter constraints 4022 may represent terrestrial mission parameter constraints, and (c) the application-specific mission operation is for monitoring target object 4024 (such as methane leaks, oil spills, wildfire and flood hazards, unauthorized fishing, mining, or wood-cutting, or railway system integrity and malfunctions) when the terrestrial mission parameter constraints satisfy orbital mission characteristics 4028. According to another embodiment, (a) the client terminal 4036 may be a client satellite, (b) the mission parameter constraints 4022 may represent an orbital mission parameter constraints, and (c) the application-specific mission operation is for monitoring target object 4024 (such as rendezvous and proximity operations and docking (RPOD) and orbital servicing including refueling, assembly and manufacturing (OSAM) when the terrestrial mission parameter constraints satisfy orbital mission characteristics 4028. Additionally, it is contemplated, without limitation, that in some embodiments of the present invention, that the client terminal 4036 may comprise one or more of, include one or more of the features of, and/or include one or more of the same or similar features as, the communication station(s)/receiving station(s) 2222 described above and illustratively shown in FIG. 22.

The orbital mission characteristics 4028 may include satellite telemetry data (such as provided by sensor signal 4027) for inclination, right ascension of ascending node, eccentricity, argument of perigee, mean anomaly, and mean motion. Position sensor 4003 may include a global position system antenna 4004 and an attitude control system 4056 that provides the satellite telemetry data. It should be understood that it is contemplated, without limitation, that the global position system antenna 4004 may comprise, be similar to, and/or be the same as one or more of the communications system 1004, the antenna 902, the transponder 1203, the global positioning satellite transceiver 1201, and/or the network device 2216, as described herein and illustratively shown in FIGS. 9-10, 12, and/or 22. Additionally, it should be understood that it is also contemplated, without limitation, that the attitude control system 4056 may comprise, be similar to, and/or be the same as one or more of the propulsion system 1006, the pressure tank(s) 1404, the thruster(s) 1402, the reaction wheel(s) 1207, the magnetorquer 1209, and/or the orientation components 2213, as described herein and illustratively shown in FIGS. 10, 12, 14, and/or 22.

The global position system antenna 4004 may provide position signal 4005 representing three-dimensional coordinate location with time stamps. The attitude control system 4056 may be responsive to attitude command signal 4055 from the modular satellite controller 4046 (based on position signal 4005) for pointing the modular satellite 100 in a direction that satisfies the mission parameter constraints 4022. The attitude control system 4056 may provide an attitude pointing signal 4057 to the modular satellite controller 4046 for updating the modular satellite pointing information.

The orbital camera 4006 may have an image capture command 4058 and the captured images 4030 are within the image capture swath 4060. The captured images 4030 may be asynchronously provided in response to the orbital camera 4006 receiving a capture command 4058 independent from the mission parameter constraints 4022 to create a library of captured images. Alternatively, the captured images 4030 may be synchronously provided in response to the orbital camera 4006 receiving the capture command 4058 depending on the mission parameter constraints 4022.

For example, the capture command 4058 is provided when the orbital mission characteristics 4028 satisfy the mission parameter constraints 4022. In one embodiment, modular satellite 100 includes an orbital mission analytics controller 4062 connected to the object detector 4010, the modular satellite controller 4046, the mission operation identifier memory segment 4002, and the mission analytics packet priority memory segment 4042. The modular satellite controller 4046 includes the mission operation selector 4008, the mission analytics packet generator 4012, and the mission analytics packet identifier 4048.

According to another embodiment, modular satellite 100 includes an adaptive mission operation characterization system 4064 connected to the modular satellite controller 4046. The adaptive mission operation characterization system 4064 includes the orbital mission analytics controller 4062, the object detector 4010, the mission operation identifier memory segment 4002, and the mission analytics packet priority memory segment 4042.

According to one embodiment, the adaptive mission operation characterization system 4064 may perform a tip and cue process for the modular satellite 100 to generate attitude command signal 4055 and image capture command 4058 based on each mission analytics packet 4034. Accordingly, the modular satellite 100 is adapted to point the orbital camera 4006 to capture images of external objects 4029 in regions of interest that may be determined from each mission analytics packet 4034.

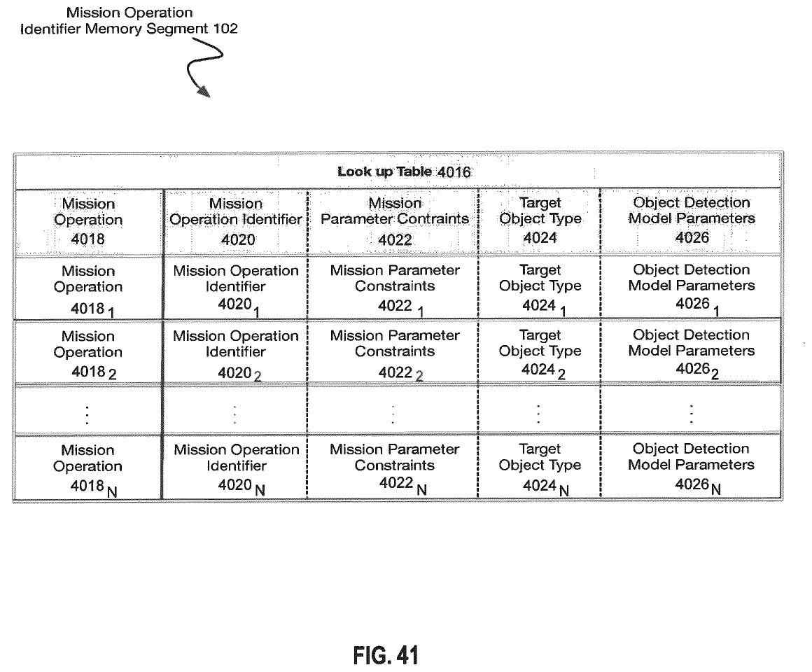

FIG. 41 illustrates an embodiment of the lookup table 4016 in the mission operation identifier memory segment 4002 of FIG. 40. The lookup table 4016 includes a set of mission operations 40181 to 4018N, mission operation identifiers 40201 to 4020N, mission parameter constraints 40221 to 4022N, target object types 40241 to 4024N, and object detection model parameters 40261 to 4026N.

Each mission operation 4018n has a mission operation identifier 4020n associated with a mission parameter constraints 4022n, a target object type 4024n and object detection model parameters 4026n for the target object type 4024n, where n is the nth mission operation in the set of application-specific mission operations 40181 to 4018N. The mission parameter constraints 4022n provide conditions (such as satellite orbital location, region of interest, and time of day) for satisfying the orbital mission characteristics 4028 before the object detector 4010 is configured with the object detection model parameters 4026n to detect object from the captured images 4030 of external objects 4029. The detected objects have an object classification associated with target object type 4024n.

In one embodiment, lookup table 4016 may be updated to add or edit any of mission operations 40181 to 4018N. The client terminal 4036 may provide a command 4066 to modular satellite 100 for updating lookup table 4016. Command 4066 may also provide instructions from client terminal 4036 to prioritize mission operations or request a mission analytics packet.

For example, mission operation 4018n may represent a fire detection mission when mission parameter constraints 4022n satisfy orbital mission characteristics 4028. Mission operation 4018n+1 may represent an unauthorized fishing vessel detection mission when mission parameter constraints 4022n+1 satisfy orbital mission characteristics 4028. Mission operation 4018n+2 may represent an RPOD mission for tracking an incoming satellite during a docking and refueling maneuver when mission parameter constraints 4022n+2 satisfy orbital mission characteristics 4028.

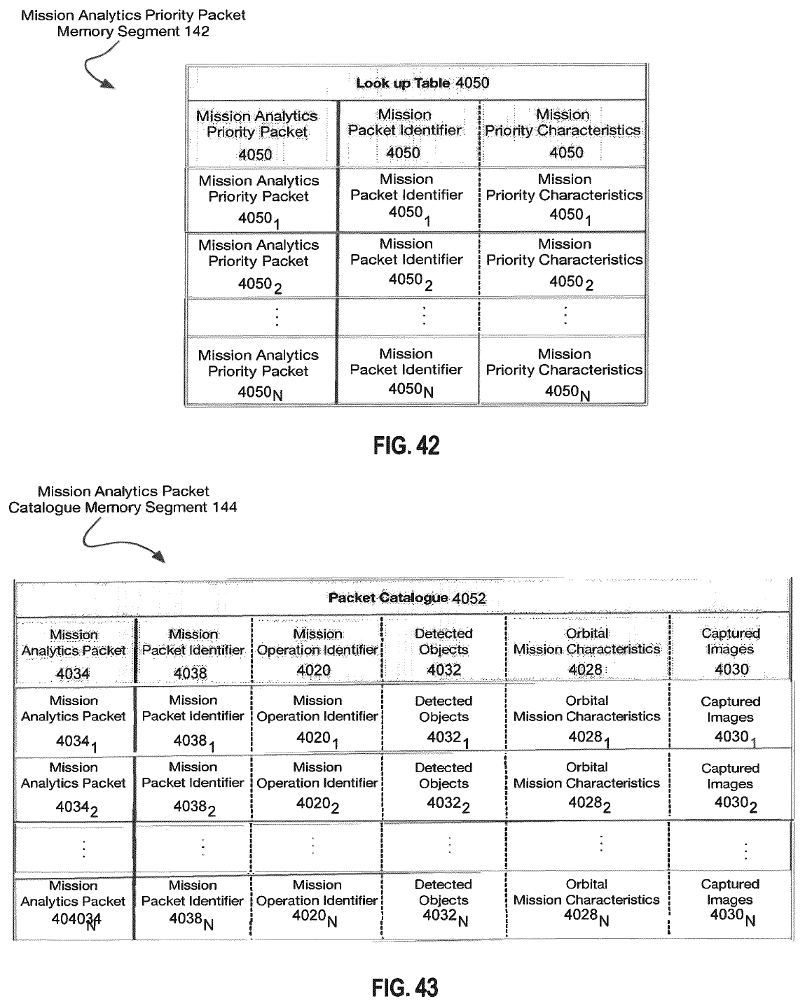

FIG. 42 illustrates an embodiment of the lookup table 4050 in the mission analytics packet priority memory segment 4042 of FIG. 40. The lookup table 4050 includes a set of mission packet identifiers 40381 to 4038N associated with a set of mission priority characteristics 40401 to 4040N.

FIG. 43 illustrates an embodiment of the mission analytics packet catalogue 4052 of mission analytics packet catalogue memory segment 4044 of FIG. 40. The mission analytics packet catalogue 4052 includes a set of mission analytics packets 40341 to 4034N associated with the set of mission packet identifiers 40381 to 4038N, the set of mission operation identifiers 40201 to 4020N, a set of detected objects 40321 to 4032N, a set of orbital mission characteristics 40281 to 4028N, and a set of captured images 40301 to 4030N.

For example, the orbital mission characteristics 4028 may include telemetry data such as name and mission characteristics including attitude control system (ACS), global positioning system (GPS), start time, end time, duration, operation dates, camera peripheral device data (e.g., synthetic aperture radar (SAR), hyper spectral, multispectral, red-green-blue (RGB), ground sample distance (GSD), resolution, etc.), satellite operation health and status, and frequency of operations. Also, the telemetry data may include number of captured images, the captured images, the frame rate for captured images, the image resolution (pixels), the time stamp, and weather conditions. The telemetry data may also include target captured image analytics (e.g., priority, trends, density, size, speed, direction, μl analytics/predictions), frame rate for captured images, image resolution (e.g., pixels), time stamp, and weather conditions.

In one embodiment, memory segments 4002, 4042, and 4044 are non-volatile memory. Memory segments 4002, 4042, and 4044 may be located on separate memory devices or integrated in any combination on the same memory device. Also, each of memory segments 4002, 4042, and 4044 may be located on a memory device in the adaptive mission operation characterization system 4064.

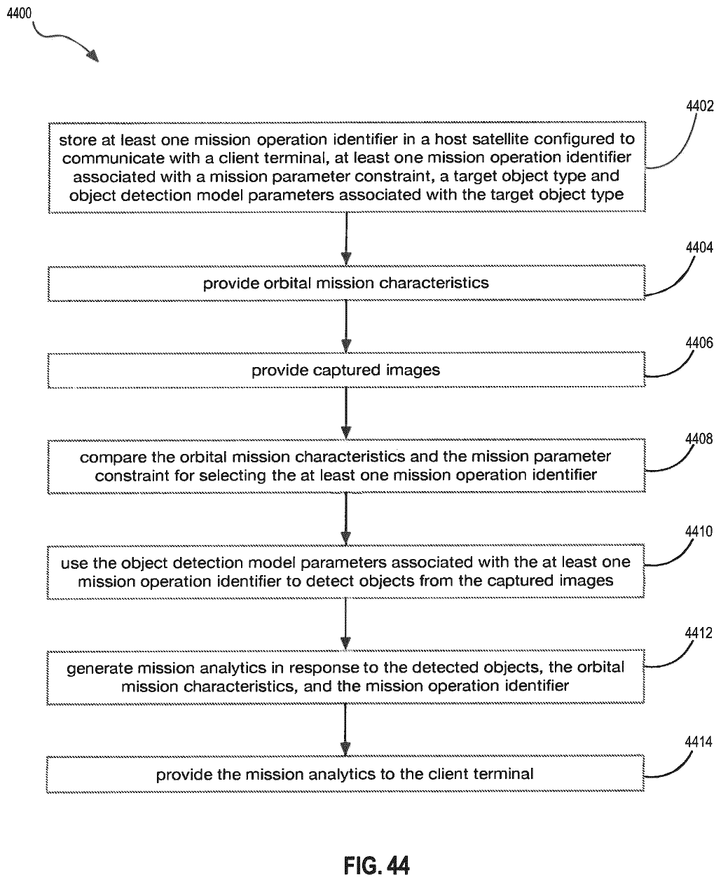

FIG. 44 illustrates a method 4400 of generating orbital mission analytics for communication from a modular satellite 100 to a client terminal. The method includes a step 4402 that stores at least one mission operation identifier in the modular satellite 100, the at least one mission operation identifier being associated with mission parameter constraints, a target object type and object detection model parameters associated with the target object type. Step 4404 provides orbital mission characteristics and step 4406 provides captured images. Step 4408 compares the orbital mission characteristics and the mission parameter constraints for selecting the at least one mission operation identifier. Step 4410 uses the object detection model parameters associated with the at least one mission operation identifier to detect objects from the captured images. Step 4412 generates mission analytics in response to the detected objects, the orbital mission characteristics, and the mission operation identifier. Step 4414 provides the mission analytics to the client terminal.

Now referring to FIG. 45, as mentioned further above, some embodiments of the modular satellite 100 may be configured as a cube satellite 4502 that may include a satellite enclosure 4504 and/or a payload enclosure 4506. The payload enclosure 4506 may include a printed circuit board 4514 having the adaptive mission operation characterization system 4064 of FIG. 40. The satellite enclosure 4504 may include a global thermal and radiation protection structure that may provide first level protection for components in the satellite enclosure 4504. The payload enclosure 4506 may include a localized thermal and radiation protection structure that may provide second level protection for electronics such as the object detector 4010 on the adaptive mission operation characterization system 4064. In one embodiment, the payload enclosure 4506 may have a form factor and interface that satisfies printed circuit board form factor and interface requirements for the satellite enclosure 4504.

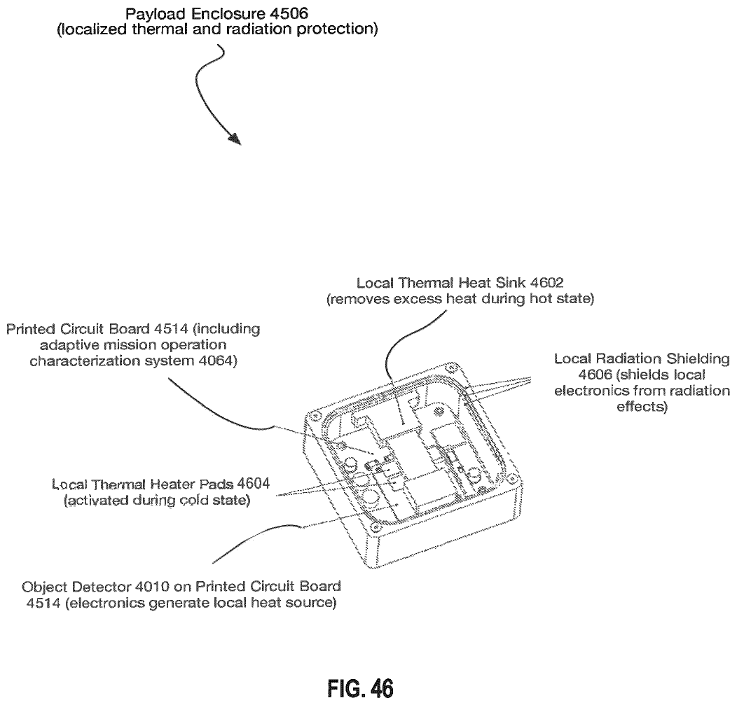

FIG. 46 illustrates an active thermal and radiation structure for the payload enclosure 4506 of FIG. 45, according to one embodiment. Payload enclosure 4506 includes printed circuit board 4514 with the adaptive mission operation characterization system 4064 of FIG. 40, a local thermal heatsink 4602, a local thermal heater pads 4604, and a local radiation shield 4606. While in orbit, the local thermal heatsink 4602 removes excess heat (such as resistive heating) generated from electronics such as object detector 4010 on the printed circuit board 4514, as well as removes excess solar radiation. Local thermal heater pads 4604 are activated during a cold state of the electronics. Local radiation shield 4606 shields the electronics from radiation effects. The shielding material for the local radiation shield 4606 may include graded-Z shielding with layers of aluminum, polyethylene, and tungsten to help protect the electronics from radiation effects such as electrostatic discharge (ESD), single-event effects (SEEs), and cumulative radiation damage.

Additionally, it is contemplated, without limitation, that in some embodiments of the present invention, that the local thermal heatsink 4602 may comprise one or more of, include one or more of the features of, and/or include one or more of the same or similar features as, the thermal control system 1010 and/or the heatsinks 1101 described above and illustratively shown in FIGS. 10-11. Also, it is contemplated, without limitation, that in some embodiments of the present invention, that the local thermal heater pads 4604 may comprise one or more of, include one or more of the features of, and/or include one or more of the same or similar features as, the heaters 1103 and/or radiators 1105 described above and illustratively shown in FIGS. 10-11.

The local radiation shield 4606 provides additional localized radiation shielding to compensate for typical structure of a cube satellite enclosure 4504 which does not provide sufficient radiation and thermal protection required for the electronics on the printed circuit board 4514 in the payload enclosure 4506. Without the thermal system of the payload enclosure 4506, the electronics would be exposed to a temperature range of around-30 to +100° C. in low-earth orbit, which is outside of operating conditions for electronics such as object detector 4010 on the printed circuit board 4514. With the active thermal and radiation structure for the payload enclosure 4506, the electronics are exposed to a temperature range that may be reduced to −10 to +55° C. Also, the electronics exposure (such as object detector 4010) to single-event effects from radiation may be reduced by 98%, from 4020 events/year to 2 events/year, and the total ionizing dose may be reduced by 95%, from 20 krad to 1 krad over a 5-year mission (where the ionizing dose limit is between 2 to 10 krad to avoid damage to the electronics in the payload enclosure 4506).

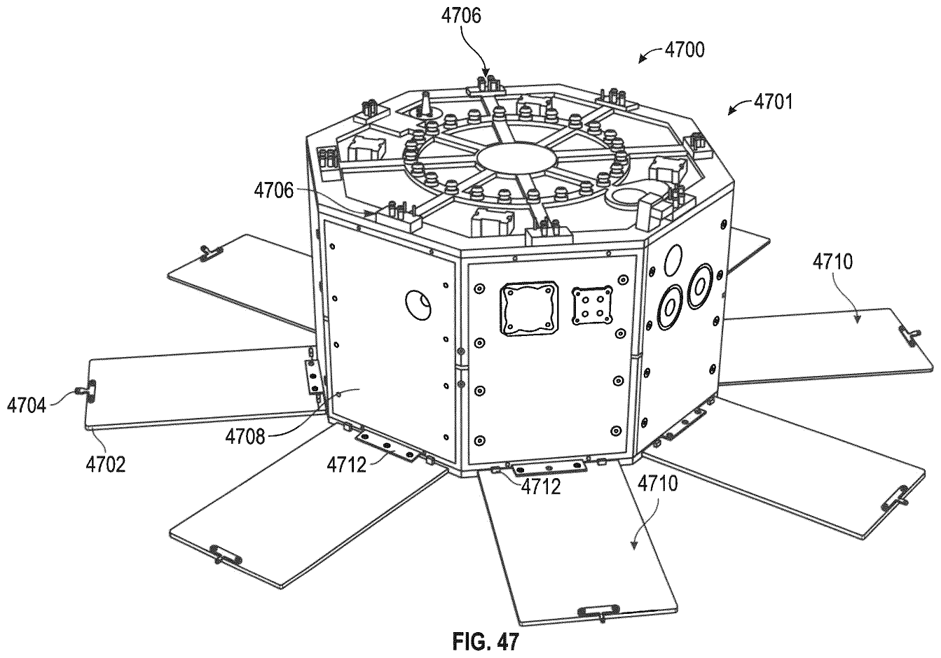

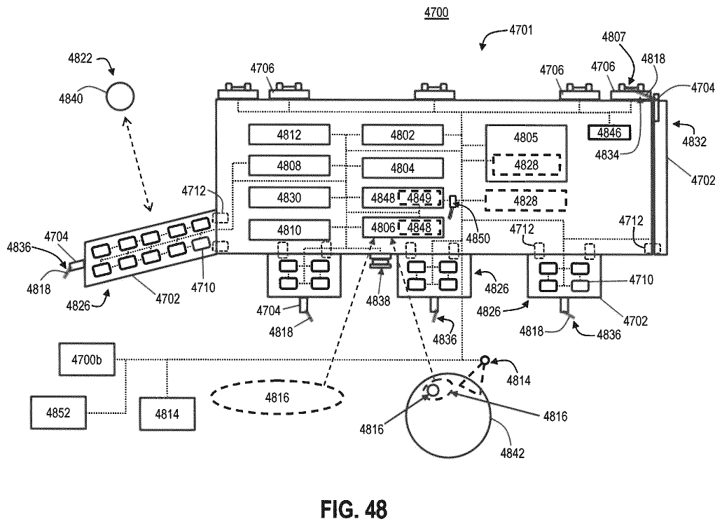

Now referring to FIGS. 47-48, some embodiments of the present invention may be directed to a modular satellite 4700 which may include one or more additional and/or alternative features as the one or more of the embodiments of the modular satellite 100 described above and herein. For example, without limitation, embodiments of the modular satellite 4700 may be capable of, utilized for, and/or provide for advantages and effective data collection, advantageous and effective data transmission, autonomous and/or near-autonomous satellite swarm cooperation, advantageous and effective power management, advantageous and effective deployment of moveable parts, such as, satellite panels, advantageous and effective thermal and/or radiation protection of on-board components, and/or advantageous machine learning capabilities, which one who may have skill in the art may notice, appreciate, and may find to be novel and advantageous features over the embodiments of the modular satellite 100 described above and over any prior art that may be found analogous to the embodiments of the present invention and/or the modular satellite 4700.

Embodiments of the modular satellite 4700 may include, without limitation, one or more of, and/or all of, the same and/or similar, system(s), structure(s), component(s), member(s), capabilities), operation(s), feature(s), and/or advantage(s) of such same and/or similar items of embodiments of the modular satellite 100 and/or the cube satellite 4502 as shown and described above and herein. For example, such correlating and/or comparable items between embodiments of the modular satellite 4700 and embodiments of the modular satellite 100 may include, without limitation, one or more of cover members 4702, a shield member 4708, hinge member(s) 4712, a communication system 4802, a datastore 4805, an attitude control system 4804, an orbital camera 4806, a power unit 4808, a star tracker 4810, a controller 4812, photovoltaic members 4710, a thermal system 4830, an attachment member 4838, a filter selection device 4848, a filter library 4849, and/or a protection member 5003.

As such, embodiments of the modular satellite 4700 may include a main body member 4701. The main body member 4701 may have a three-dimensional geometric shape, such as, and without limitation, a hexagonal prism, a rectangular prism, and/or an octagonal prism. The main body member 4701 may comprise one or more shelf members 602, which may be the same and/or similar to the shelf members 602 of the modular satellite 100 illustratively shown in FIG. 6. Moreover, the main body member 4701 of the modular satellite 4700 may include one or more other structural components as described above regarding embodiments of the modular satellite 100 and illustratively shown in FIGS. 1-9, 15-21, and 45-46. For example, without limitation, the main body member 4701 of the modular satellite 4700 may include one or more of upper members 102, lower members 302, intermediate members 402, lower support members 104, upper support members 106, upper cover members 108, lower bar members 202, bottom cover members 110, through channels 1506, a satellite enclosure 4504, and/or a payload enclosure 4506.

Embodiments of the modular satellite 4700 may include one or more controllers 4812. The controller(s) 4812 may be carried by the main body member 4701, and the controller(s) 4812 may be operable to perform a mission instruction. The mission instruction may comprise one or more of a mission type and/or a mission parameter. The mission type may relate to one or more of a search mission, a map mission, a report mission, a standby mission, a vigilance mission, a self-diagnostics mission, and/or a statistical analysis mission. The mission parameter may relate to one or more of a target event, a time constraint (e.g., time range, execution time(s), and/or periodic time(s), periodic time ranges), absorption band(s), portion(s) of the surface of the Earth 4842, area(s) of the Earth 4842, a predetermined object 4816, a detected predetermined object 4816, an identified predetermined object 4816, a predetermined target object 4816 area of Earth 4842, and/or exclusion instructions.

Examples of a predetermined object 4816 include, without limitation, one or more of an object and/or area to be captured and/or to that is captured in at least one image by the orbital camera 4806 and/or by the modular satellite 4700. Examples of an object include, without limitation, one or more of an object in space, such as a space vessel, a satellite, space debris, a space station, a shuttle, a rocket, a planet, an asteroid, a moon, a meteor, a star, and/or a grouping/area of matter and/or any combination(s) thereof. Examples of an area include, without limitation, one or more of a predetermined sector/area/scope/section of space, a portion of a surface of a mass such as a portion of a surface of the Earth 4842, and/or any combination(s) thereof as may be understood by those who may have skill in the art.

Additionally, it is contemplated, without limitation, that in some embodiments of the present invention, that predetermined object 4816 may comprise one or more of, include one or more of the features of, and/or include one or more of the same or similar features as, a target event 2404, a target area 2254, a target object type 4024, object detection model parameters 4026, and/or an object 4032, target object type 4024, and/or any combination(s) thereof as described herein and illustratively shown in, but not limited to, FIGS. 22, 24, and 40.

The mission instruction may be received by the at least one controller 4812 from one or more client terminal(s) 4814. In some embodiments of the present invention the mission instruction may be generated by the at least one controller 4812 and/or by the modular satellite 4700 based on mission data stored in the datastore 4805. The mission data may be accessible by the at least one controller 4812 and the at least one controller 4812 may selectively access the datastore 4805 to receive at least a portion of the mission data therefrom. The mission data may comprise saved data of past and/or current/present: mission instruction(s), timestamps, geolocations, captured image(s), detected predetermined object(s) 4816, identified predetermined object(s) 4816, mission analytics packet(s), mission performance factor, and/or status data and/or any combination(s) thereof. The at least one controller 4812 may be configured to update the mission data stored in the datastore 4805 with mission instruction(s), timestamps, geolocations, captured image(s), detected predetermined object(s) 4816, identified predetermined object(s) 4816, mission analytics packet(s), mission performance factor, and/or status data and/or any combination(s) thereof responsive to the occurrence thereof and/or periodically at one or more predetermined intervals of time.

The controller(s) 4812 may be operable to process, compute, execute, run, read, write, save, delete, store, interpret, and/or translate commands, instructions, signals, code, data, and/or computer-readable information. Examples of the controller(s) 4812 include, without limitation, one or more of a central processing unit (CPU), a graphics processing unit (GPU), a microprocessor, a microcontroller, an embedded processor, a digital signal processor, an application specific integrated circuit (ASIC), a field-programmable gate array (FPGA), and/or a non-field programmable gate array.

Some embodiments of the modular satellite 4700 may include a communication system 4802. The communication system 4802 may be carried by the main body member 4701. The communication system 4802 may be in communication with at least one of the controller(s) 4812. The communication system 4802 may be utilized to read, write, convert, interpret, transmit, receive, transceive, send, detect, sense, and/or facilitate communication of computer-readable data, code, signals, information, instructions, and/or executables. Examples of the communication system 4802 include, without limitation, a network card, a router, a modem, a hub unit, an antenna, a satellite dish, a receiver, a transmitter, a transceiver, and/or a communication array and/or any combination(s) thereof. Additionally, it is contemplated, without limitation, that the communication system 4802 may also comprise and/or include one or more features of, one or more of the antenna 902, the transponder 1203, the global positioning satellite transceiver 1201, the first sensor/the position sensor 4003, the transceiver 4014, and/or the global position system antenna 4004, as described herein and/or above and illustratively shown in FIGS. 9, 12, and 40.

The communication system 4802 may also be in communication with a client terminal 4814, as illustratively shown in FIGS. 47-48. The client terminal 4814 may comprise one or more of a telecommunication system, satellite communication system, a computer terminal, a personal computer system, a mobile smart phone device, a communication terminal, a communication tower, a communication array system, and/or a data center, and/or any combination(s) thereof as may be understood by those who may have skill in the art.

Some embodiments of the modular satellite 4700 may include a datastore 4805. The datastore 4805 may be carried by the main body member 4701 and the datastore 4805 may be operable to store data that may be accessible by one or more of the controller(s) 4812. The datastore 4805 may be in communication with one or more of the controller(s) 4812, the communication system 4802, and/or the power unit 4808. The datastore 4805 may be utilized to read, write, receive, send, and/or store computer-readable data, code, signals, information, instructions, and/or executables. Examples of the datastore 4805 may include, without limitation, one or more of a hard drive, a solid-state drive, a disk drive, a compact-disc, a floppy disk, magnetic tape, nonvolatile computer-readable memory, volatile computer-readable memory, and any combinations thereof. In some embodiments of the present invention, the datastore 4805 may include, store, and/or be similar to the non-transitory computer readable memory 1012 described above. Additionally, the datastore 4805 may include and/or store one or more of a mission operation identifier memory segment 4002, a mission operation lookup table 4016, a mission operation 4018, a mission operation identifier 4020, a mission parameter constraints 4022, a mission analytics packet priority memory segment 4042, a mission analytics packet catalogue memory segment 4044, a mission packet identifier 4038, mission priority characteristics 4040, and/or a mission analytics packet catalogue 4052, described above and further below, and which are illustratively shown in FIG. 40.

Some embodiments of the modular satellite 4700 may also include a power unit 4808. The power unit 4808 may be carried by the main body member 4701 and the power unit 4808 may be in communication with one or more of the controller(s) 4812, the communication system 4802, the datastore 4805, the main body member 4701, the cover members 4702, and/or one or more other members, components, and/or units of and embodiment of the modular satellite 4700 as described herein. The power unit 4808 may be utilized to provide, store, generate, transform, regulate, monitor, manage, and/or control power, such as electrical power. Examples of the power unit 4808 include, without limitation, a generator, a battery, a solar cell, a photovoltaic cell, an alternator, a rectifier, a power transformer, a power regulator, a voltage regulator, an amperage regulator, a power distribution harness, and/or a power store and/or any combination(s) thereof.

Some embodiments of the present invention may include one or more of an orbital camera 4806. The orbital camera 4806 may be carried by the main body member 4701, and the orbital camera 4806 may be in communication with one or more of the controller(s) 4812, the communication system 4802, the datastore 4805, and/or the power unit 4808. The orbital camera 4806 may be operable to capture at least one image. The at least one image captured by the orbital camera 4806 may be associated with the mission instruction. The at least one image captured by the orbital camera 4806 may define a captured at least one image.

In some embodiments of the modular satellite 4700, one or more of the controller(s) 4812 may be operable to detect at least one predetermined object 4816 in the image(s) captured by the orbital camera 4806, which may define a detected at least one predetermined object 4816. Also, in some embodiments of the modular satellite 4700 one or more of the controller(s) 4812 may be operable to identify the detected predetermined object(s) 4816, which may define at least one identified predetermined object 4816. Additional details regarding the orbital camera 4806 follows further below.

One or more of the controller(s) 4812 may be operable to generate one or more mission analytics packets, such as, and without limitation, the mission analytics packet 4034 described above. One or more of the controller(s) 4812 may be operable to generate a mission analytics packet based on the captured at least one image, the detected at least one predetermined object 4816, the identified at least one predetermined object 4816, and/or the mission instruction. One or more of the controller(s) 4812 may be operable to store the mission analytics packet(s) in the datastore 4805, and the datastore 4805 may be operable to store the mission analytics packet(s). The mission analytics packet(s) stored in the datastore 4805 may be accessible by one or more of the controller(s) 4812 and/or the communication system 4802. One or more of the controller(s) 4812 and/or the communication system 4802 may be operable to transmit one or more of the mission analytics packet(s) to the client terminal 4814.

Some embodiments of the modular satellite 4700 may include a plurality of cover members 4702. Each of the cover members 4702 may include a retention member 4704. The main body member 4701 may include a respective plurality of release members 4706. The cover members 4702 may be carried by the main body member 4701, and the cover members 4702 may be movable between an opened position 4826 and a closed position 4832. The closed position 4832 of a cover member 4702 may be defined as when the cover member 4702 is substantially longitudinally aligned and/or vertically parallel with the main body member 4701. The cover member 4702 may be substantially vertically parallel and/or aligned with the main body member 4701 when and/or while a longitudinal axis of the cover member 4702 is parallel and/or aligned with a vertical axis that extends directly and vertically from the lower face of the main body member 4701 toward the upper face of the main body member 4701.

Additionally, and/or alternatively, the closed position 4832 of a cover member 4702 may be defined as when and/or while the cover member 4702 is positioned longitudinally parallel with one or more of a shield member 4708 that may extend between lower and upper portions of the main body member 4701. Also, additionally and/or alternatively, the closed position 4832 of a cover member 4702 may be defined as when and/or while the cover member 4702 is substantially covering and/or occluding a shield member 4708 adjacent to the cover member 4702.

The opened position 4826 of a cover member 4702 may be defined as when the cover member 4702 is not longitudinally aligned with, not vertically parallel with, and/or is longitudinally shewed with the vertical axis of the main body member 4701. Additionally, and/or alternatively, the opened position 4826 of a cover member 4702 may be defined as when and/or while the cover member 4702 is not longitudinally aligned with, not vertically parallel with, and/or is longitudinally shewed with one or more of the shield member(s) 4708 that may be extending between lower and upper portions of the main body member 4701. Also, additionally and/or alternatively, opened position 4826 of a cover member 4702 may be defined as when and/or while the cover member 4702 is substantially not covering and/or not substantially occluding a shield member 4708 adjacent to the cover member 4702. Moreover, additionally and/or alternatively, the opened position 4826 of a cover member 4702 may be defined as when the shield member 4708 adjacent to the cover member 4702 is at least partially revealed and/or visible from an environment outside of and/or surrounding the main body member 4701.

Some embodiments of the present invention may include one or more retention lines 4818. A retention line 4818 may be positioned extending between and/or physically connected the retention members 4704 and the release members 4706. The retention line 4818 may be extended between the retention member 4704 and a retention line connection point 4807. The retention line connection point 4807 may be positioned on and/or carried by the release member 4706. The retention line 4818 may be configured and/or adapted to be in contact with the release member 4706 when, while, and/or during the adjacent cover member 4702 in the closed position 4832.

Each retention line 4818 may be moveable between a retention state 4834 and a released state 4836. The retention state 4834 may be defined as when the retention line 4818 is extended between the retention member 4704 and the release member 4706/retention line connection point 4807/main body member 4701. When, while, and/or during the retention line 4818 being in the retention state 4834, the respective and/or adjacent cover member 4702 may be prevented from moving to the opened position 4826 and/or prevented from moving to the opened position 4826 from the closed position 4832.

In some embodiments of the present invention, it is contemplated that the retention line 4818 may have a shape similar to a V-shape when and/or while the retention line 4818 is in the retention state 4834. Additionally, in some embodiments of the present invention, when and/or while the retention line 4818 is in the retention state 4834, the retention line 4818 may be in a state of tension such that the retention line 4818 may have a total length in the retention state 4834 that is longer than a total length of the retention line 4818 while the retention line 4818 is not in the retention state 4834. For example, without limitation, while in the retention state 4834 the retention line 4818 may have both ends thereof attached to portion(s) of the release member 4706 while a medial portion of the retention line 4818 is extending towards and attached to one of the retention member 4704 such that the retention line 4818 may have a shape similar to a V-shape.

The released state 4836 of the retention line 4818 may be defined as the retention line 4818 not being extended/being positioned extending between the retention member 4704 and the release member 4706/main body member 4701/retention line connection point 4807. The released state 4836 of the retention line 4818 may also and/or alternatively be defined as the retention line 4818 being severed, cut, broken, separated, and/or parted such that the retention line 4818 does not extend between and/or no longer extends between the retention member 4704 and the release member 4706/main body member 4701/retention line connection point 4807, and/or such that the retention line 4818 is separated into two retention lines 4818 that are separate, spaced a part from one another, and/or are not connected to one another. When, while, and/or during the retention line 4818 being in the released state 4836, the respective and/or adjacent cover member 4702 may be moved and/or moveable to the opened position 4826, and/or moved and/or moveable to the opened position 4826 from the closed position 4832.

The hinge members 4712 may be attached, hingedly attached, and/or rotatably attached to the main body member 4701 and/or to a lower portion of the main body member 4701. Each of hinge members 4712 may also and/or alternatively be attached, hingedly attached, and/or rotatably attached to a lower portion of one of the cover members 4702. The hinge members 4712 may be configured to provide for and/or allow for each of the cover members 4702 to rotatably move between the closed position 4832 and the opened position 4826 about a lower horizontal axis, and as such, the hinge members 4712 may provide for and/or allow for the cover members 4702 to rotatably move relative to the main body member 4701.

In some embodiments of the present invention the hinge members 4712 may be configured to readily move the cover members 4702 to the opened position 4826 from the closed position 4832. The hinge members 4712 may readily move the cover members 4702 from the closed position 4832 to the opened position 4826 upon the retention line 4818 associated with the cover member 4702 being moved to the released state 4836 from the retention state 4834. The hinge members 4712 may comprise one or more of a spring, a pulley, a magnet, a motor, a step motor, and/or constant force member as may be understood by those who may have skill in the art. In some embodiment of the present invention, the hinge members 4712 may be in communication with one or more of the power unit 4808 and/or with one or more of the controller(s) 4812. The hinge members 4712 may be configured to be controlled, selectively controlled, and/or operable to be controlled by the controller(s) 4812 to rotatably move to cause one or more of the cover members 4702 to rotatably move and/or move between the opened position 4826 and the closed position 4832.

Each release member 4706 may be operable to move between being in a neutral state and a charged state. The charged state may be defined as when and/or while the release member 4706 generates a temperature and/or energy comprising a predetermined temperature/energy amount that may be capable of severing the retention line 4818 and/or to cause the retention line 4818 to move from the retention state 4834 to the released state 4836. The neutral state may be defined as when and/or while the release member 4706 is not generating a temperature and/or energy that comprises a predetermined temperature/energy amount that is capable of severing the retention line 4818 to move the retention line 4818 from the retention state 4834 to the released state 4836. The predetermined temperature/energy amount capable of severing the retention line 4818 may be related to a melting point, boiling point, ignition temperature, kindling point, sublimation point, and/or transition temperature of the retention line 4818.

Each release member 4706 may comprise a heating element that may be located at the retention line connection point 4807 and that may be utilized to move the release member 4706 to and between the neutral state and the charged state. Each release member 4706 may be in communication with one or more of the controller(s) 4812 and/or power unit 4808. Each release member 4706 may be controlled one or more of the controller(s) 4812 to cause the release member 4706 to move between being in the neutral state and the charged state. In some embodiments of the present invention the one or more controller(s) 4812 may include one or more of a release controller 4846. One or more release controller 4846 may be in communication with one or more release member 4706, retention line connection point 4807, retention line 4818, the power unit 4808, and/or with one or more other controller(s) 4812. Each release controller 4846 may be adapted to control and/or selectively control the release members 4706 to move between being in the neutral state and the charged state to cause the retention line 4818 to move from the retention state 4834 to the released state 4836. The release controller 4846 may be configured to control the release members 4706 to move from the neutral state to the charged state based upon a release command received by the release controller 4846 from another one of the controller(s) 4812 and/or from the communication system 4802 and/or from a client terminal 4814.

Some embodiments of the present invention may include an attitude control system 4804. The attitude control system 4804 may be configured and/or utilized to monitor and control an orientation of the modular satellite 4700 and/or main body member 4701 of the modular satellite 4700. The attitude control system 4804 may be configured and/or utilized to detect a movement force 5001 associated with and/or caused by the cover members 4702 moving between the closed position 4832 and the opened position 4826. The movement force 5001 may comprise a rotational force and/or force that may be caused and/or generated by the cover members 4702 when and/or while the cover members 4702 move between the closed position 4832 and the opened position 4826, as may be understood by those who may have skill in the art.

The movement force 5001 generated by the cover members 4702 may cause an opposing movement force 5001 to be applied to the modular satellite 4700 and/or the main body member 4701. As may be understood by those who may have skill the art, while the modular satellite 4700 is within the environment of space, the opposing movement force 5001 may cause the modular satellite 4700 and/or main body member 4701 to rotate in a direction opposite from the rotational movement of the cover members 4702 when and/or while the cover members 4702 move between the closed position 4832 and the opened position 4826.

The attitude control system 4804 may be adapted and/or utilized to generate a counter force 5002 to counteract the opposing movement force 5001 generated by the cover members 4702. The counter force 5002 may comprise a force that may be equal and opposite to the opposing movement force 5001 generated by the cover members 4702, such that, the counter force 5002 may mitigate and/or eliminate the opposing movement force 5001, and such that, the orientation of the modular satellite 4700 and/or main body member 4701 may remain the same, which may be the orientation relative to the Earth 4842, the Sun 4840, a star 4822, an object located on earth and/or within space, and/or any combinations(s) thereof. The attitude control system 4804 may include, for example and without limitation, one or more of a propulsion system, pressure tank, thruster, reaction wheel, magnetorquer, position sensor, global positioning system, and gyroscope, and/or any combinations thereof as may be understood by those who may have skill in the art.

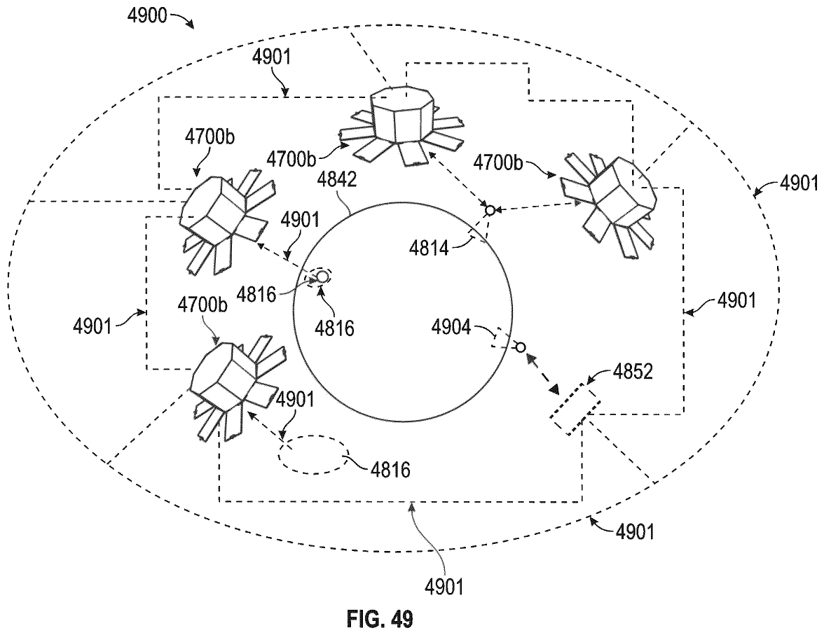

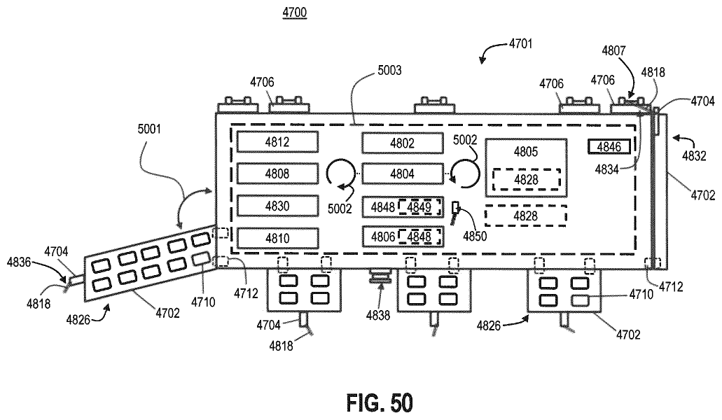

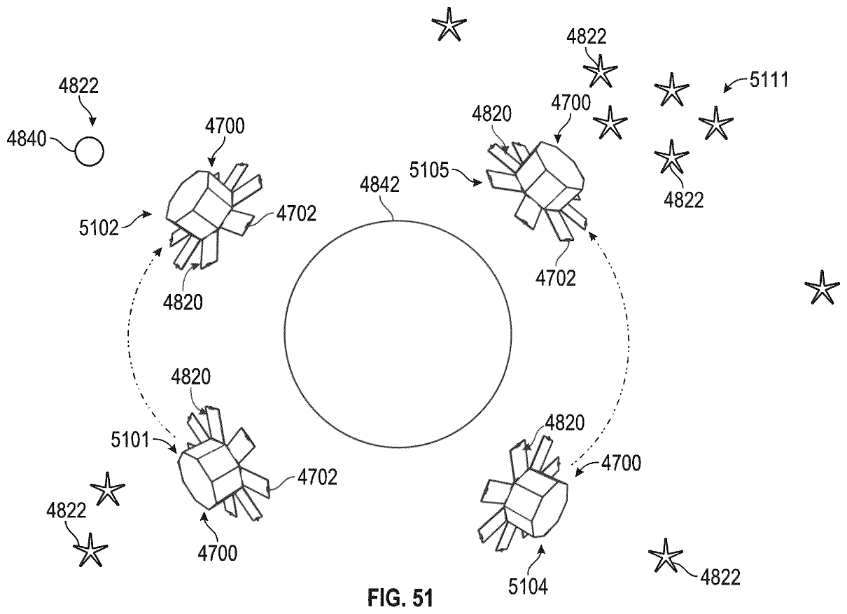

Now referring to FIGS. 48-51, in some embodiments of the present invention, the modular satellite 4700 and/or the attitude control system 4804 may include one or more of a star tracker 4810. The star tracker 4810 may be in communication with one or more of the controller(s) 4812, the communication system 4802, the datastore 4805, the attitude control system 4804, and/or the power unit 4808. The star tracker 4810 may be operable and/or utilized to sense, detect, monitor, and/or track at least one star 4822. The at least one star 4822 may include the Sun 4840. The star tracker 4810 may be operable and/or utilized to sense, detect, monitor, and/or track the at least one star 4822 to determine at least one star characteristic associated with the star(s) 4822 tracked by the star tracker 4810. A star characteristic may include one or more of the direction of the star 4822 relative to the star tracker 4810, the wavelength(s) of light received by the star tracker 4810 from the star 4822, the intensity of the wavelength(s) of light from the star 4822, and/or the proximity of the star 4822 with other stars 4822 within a predetermined vicinity distance.

One or more photovoltaic member 4710 may be mounted and/or carried by the cover members 4702 and/or one or more of the cover members 4702 may include one or more of a photovoltaic member 4710 mounted thereon and/or carried thereby. The photovoltaic members 4710 may be in communication with one or more of the controller(s) 4812, communication system 4802, the attitude control system 4804, the star tracker 4810, the datastore 4805, the power unit 4808, the release member 4706, the hinge members 4712, and/or the orbital camera 4806 and/or any combination(s) thereof. The photovoltaic members 4710 may be configured and/or operable to receive, transform, and/or convert light energy from light received by the photovoltaic member 4710 into another form of energy, such as, and without limitation, electrical energy, as may be understood by those who may have skill in the art.

The photovoltaic members 4710 may be mounted on and/or carried by one or more of the faces of the cover members 4702. The photovoltaic members 4710 may utilized to provide power, such as electrical power, to one or more of the electronically powered components of the modular satellite 4700. The attitude control system 4804, the one or more controller(s) 4812, and/or the star tracker 4810 may be operable and/or utilized to orient cause one or more of the cover members 4702, main body member 4701, and/or photovoltaic members 4710 to be oriented facing towards one or more direction(s) of at least one star 4822. For example, without limitation, the attitude control system 4804 and/or the star tracker 4810 may provide a tracked star signal associated with at least one star 4822 and/or associated with at least one star characteristic associated with the at least one star 4822.

The attitude control system 4804, the star tracker 4810, and/or one or more of the controller(s) 4812 may be operable to determine an ideal tracked star 4822 and/or an ideal tracked grouping of stars 5111 based on the tracked star signal. The ideal tracked star 4822 and/or ideal tracked grouping of stars 5111 may be associated with the one or more star(s) 4822 that may be determined to provide a level of light energy that may be higher than a level of light energy provided by other star(s) 4822 that may be tracked by the star tracker 4810 and/or attitude control system 4804. The ideal tracked star 4822 and/or ideal tracked grouping of stars 5111 may also and/or alternatively be associated with at least one star 4822 that may be determined to provide light energy to the modular satellite 4700 and/or photovoltaic member 4710 for a period of time that may be longer than a period of time than other stars 4822 tracked, which may be determined based on the direction of the at least one star 4822 relative to the modular satellite 4700/main body member 4701, the orbital path of the modular satellite 4700/main body member 4701, and/or the position of and object 4816/predetermined object 4816.

The controller(s) 4812 may be operable to control the attitude control system 4804 and/or the hinge members 4712 to cause the modular satellite 4700, main body member 4701, and/or the cover members 4702 to orient the modular satellite 4700, the main body member 4701, and/or the cover members 4702 to be facing towards the direction of the at least one star 4822 associated with the ideal tracked star 4822 and/or ideal tracked grouping of stars 5111 and/or to orient one or more of the photovoltaic member(s) 4710 to be facing towards the direction of the at least one star 4822 associated with the ideal tracked star 4822 and/or ideal tracked grouping of stars 5111.

In some embodiments of the present invention, the attitude control system 4804 may be operable, based on the ideal tracked star 4822 and/or ideal tracked grouping of stars 5111, to cause the modular satellite 4700, main body member 4701, and/or the cover members 4702 to orient the modular satellite 4700, the main body member 4701, and/or the cover members 4702 to be facing towards the direction of the at least one star 4822 associated with the ideal tracked star 4822 and/or ideal tracked grouping of stars 5111 and/or to orient one or more of the photovoltaic member(s) 4710 to be facing towards the direction of the at least one star 4822 associated with the ideal tracked star 4822 and/or ideal tracked grouping of stars 5111.

The orbital camera 4806 may be configured to filter at least one wavelength of light from light that is received by the orbital camera 4806. The resulting filtered light of the at least one wavelength of light filtered from the light received by the orbital camera 4806 may be referred to as, and/or may defined a, filtered light. The orbital camera 4806 may be adapted, operable, and/or utilized to sense and/or detect the filtered light to determine and/or generate sensed light data. For example, without limitation, the orbital camera 4806 may sense and/or detect the filtered light to determine and/or generate the sensed light data by sensing and/or detecting the one or more wavelength(s) of light of which the filtered light may comprise. The orbital camera 4806 may associate the sensed light data with the one or more images captured by the orbital camera 4806.

In some embodiments of the present invention, the image(s) captured by the orbital camera 4806 may be defined by the sensed light data. Additionally, and/or alternatively, the one or more of the images captured by the orbital camera 4806 may define the at least one wavelength of light received by the orbital camera 4806. The orbital camera 4806 may be operable and/or configured to provide the at least one captured image and/or the sensed light data to one or more of the controller(s) 4812, the datastore 4805, and/or the communication system 4802. The datastore 4805 may be operable and/or configured to store the at least one captured image and/or the sensed light data in the datastore 4805, which may be accessible by one or more of the controller(s) 4812 and/or the communication system 4802.

In some embodiments of the present invention, the mission instruction may be received by the modular satellite 4700, the one or more controller(s) 4812, and/or the communication system 4802 from the client terminal 4814. Additionally, in some embodiments of the present invention, the mission instruction may be defined as an original mission instruction. Moreover, in some embodiments of the present invention one or more of the controller(s) 4812 may be operable and/or configured to generate one or more of an additional mission instruction. For example, and without limitation, one or more of the controller(s) 4812 may be operable and/or configured to generate one or more of an additional mission instruction based on the original mission instruction.

One or more of the controller(s) 4812 may be operable to control the orbital camera 4806, and/or the orbital camera 4806 may be operable, to capture at least one of an additional image based on and/or associated with the additional mission instruction. In some embodiments of the present invention, the orbital camera 4806 may be operable and/or configured to capture an image associated with the original mission instruction and capture an image associated with the additional mission instruction simultaneously. The additional image captured based on and/or associated with the additional mission instruction may be referred to and/or defined as a captured at least one additional image. One or more of the controller(s) 4812 may be adapted and/or operable to sense, detect, and/or identify at least one additional predetermined object 4816 in and/or based on the captured at least one additional image, which may be defined as a detected at least one additional predetermined object 4816.

One or more of the controller(s) 4812 may be operable and/or configured to create and/or generate an additional mission analytics packet based upon the additional mission instruction, the captured at least one additional image, and/or the detected at least one additional predetermined object 4816. One or more of the controller(s) 4812 may be operable to store the additional mission analytics packet in the datastore 4805. Also, one or more of the controller(s) 4812 may be operable to transmit the additional analytics packet to the client terminal 4814.

In some embodiments of the present invention, the controller(s) 4812 and/or the communication system 4802 may be operable to receive a mission analytics packet request, which may be from one or more client terminal(s) 4814. The controller(s) 4812 may be operable and/or configured to retrieve data from the datastore 4805 responsive to the mission analytics packet request. The controller(s) 4812 may also be operable to transmit the data retrieved from the datastore 4805 to the client terminal(s) 4814 that transmitted to the mission analytics packet request. The data retrieved from the datastore 4805 by the controller(s) 4812 may comprise data associated with the mission analytics packet request, such as, and without limitation, one or more of a captured image, sensed light data, predetermined object 4816 data, detected predetermined object 4816 data, identified predetermined object 4816, mission instruction data, and a mission analytics packet.

In some embodiments of the present invention, one or more of the controller(s) 4812 may be operable and/or configured to perform a relevancy process to determine one or more of a relevancy parameter constraint. The relevancy process may be based upon the mission instruction and/or the original and/or additional mission instruction. The one or more controller(s) 4812 may be operable and/or configured to compare the data in the mission analytics packet, and/or in the additional mission analytics packet, to the one or more relevancy parameter constraint(s). The one or more controller(s) 4812 may identify one or more portion(s) of the data in the mission analytics packet based one the comparison of the data in the mission analytics packet/in the additional mission analytics packet and the one or more relevancy parameter constraint(s), which may be referred to and/or defined as relevant data.

The controller(s) 4812 may be operable and/or configured to remove data from the mission analytics packet/additional mission analytics packet based upon the relevant data. For example, and without limitation, the controller(s) 4812 may be operable and/or configured to remove data from the mission analytics packet/additional mission analytics packet based on the relevant data by removing data from the mission analytics packet/additional mission analytics packet that may not have been identified as relevant data.

In some embodiments of the present invention, one or more of the controller(s) 4812 may be operable and/or configured to identify expired data stored in the datastore 4805. Each portion of the data stored in the datastore 4805 may have and/or be associated with an age. The age of the data portion(s) may comprise a timestamp of when the data was created by a component of the modular satellite 4700 and/or a timestamp of when the data portion(s) were first stored in the datastore 4805. The one or more controller(s) 4812 may identify the expired data by comparing the age of each portion of the data with a predetermined age constraint. One or more of the controller(s) 4812 may be operable and/or configured to remove, delete, terminate, over-right, deactivate, and/or clear one or more portions of the data stored in the datastore 4805 which is identified as expired data.

Some embodiments of the present invention may comprise an archive datastore 4828 which may be carried by the main body member 4701. The archive datastore 4828 may be in communication with one or more of the controller(s) 4812, the communication system 4802, the datastore 4805, the power unit 4808, the orbital camera 4806, and/or the attitude control system 4804. Also, and/or alternatively, in some embodiments of the modular satellite 4700, the archive datastore 4828 may be included within and/or integrated with the datastore 4805. The archive datastore 4828 may be accessible by one or more of the controller(s) 4812, and/or data stored by the archive datastore 4828 may be accessible by one or more of the controller(s) 4812.

One or more of the controller(s) 4812 may be operable and/or configured to identify data stored in the datastore 4805 as matured data, which may be by comparing the age associated with each portion of the data with a predetermined age constraint and/or with a predetermined matured age constraint. The controller(s) 4812 may be operable and/or configured to transfer data identified in the datastore 4805 as matured data to the archive datastore 4828 to be stored therein. The controller(s) 4812 may also be operable and/or configured to identify data stored in the archive datastore 4828 as expired data based on and by comparing the age associated with each portion of the data with a predetermined age constraint to remove, delete, terminate, over-right, deactivate, and/or clear one or more portions of the data stored in the archive datastore 4828 which is identified by the controller(s) 4812 as expired data.

Some embodiments of the modular satellite 4700 may include a thermal system 4830. The thermal system 4830 may be carried within and/or by one or more portions of the main body member 4701. The thermal system 4830 may be in communication with one or more of the controller(s) 4812, the communication system 4802, the power unit 4808, and/or the photovoltaic member(s) 4710. The thermal system 4830 may include one or more heatsinks, radiators, heaters, and/or shielding. The thermal system 4830 may include one or more same and/or similar features as described above and herein regarding the thermal control system 1010, the heatsinks 1101, and/or the radiators 1105, illustratively shown in FIGS. 10-11, and/or the local thermal heatsinks 4602, the local thermal heater pads 4604, payload enclosure 4506, and/or the local radiation shield 4606, illustratively shown in FIGS. 45-46.

The thermal system 4830 may be configured to absorb, dissipate, generate, and/or transfer thermal energy to and/or from one or more of the communication system 4802, attitude control system 4804, datastore 4805, orbital camera 4806, power unit 4808, star tracker 4810, controller(s) 4812, archive datastore 4828, release controller 4846, and/or any combination(s) thereof and/or any other component of an embodiment of the modular satellite 4700 as may be understood by those who may have skill in the art. The thermal system 4830 may be utilized to remove excess heat and/or thermal radiation from components of the modular satellite 4700. The thermal system 4830 also may be operable and/or utilized to activate upon the determination and/or detection of a component being in a predetermined cold state temperature to generate and provide thermal energy to the component(s) in the cold state.

In some embodiments of the present invention, the modular satellite 4700, and/or the thermal system 4830, may comprise a protection member 5003. The protection member 5003 may be carried by the main body member 4701, and the protection member 5003 may carry and/or house one or more of the components of the modular satellite 4700. For example, without limitation, the protection member 5003 may carry and/or house one or more of, and/or a portion of one or more of, the controller(s) 4812, the power unit 4808, the thermal system 4830, the star tracker 4810, the communication system 4802, the attitude control system 4804, the datastore 4805, a filter selection device 4848, a filter library 4849, a filter selection arm 4850, and/or the orbital camera 4806, and/or any combination(s) thereof, which may be referred to herein as the electronic components of the system 4700 either individually, collectively, and/or in any combination(s) thereof as may be understood by those who may have skill in the art.

The protection member 5003 may include one or more of the same and/or similar features as the payload enclosure 4506 and/or the local radiation shielding 4606 described herein and illustratively shown in FIGS. 45-46. The protection member 5003 may provide for thermal and radiation mitigation and/or protection for the electronic components of the system 4700. The protection member 5003 may comprise one or more of graded-Z shielding, and/or one or more layers of material such as aluminum, polyethylene, and/or tungsten to provide protection to the components from events such as electrostatic discharge (ESD), single-event effects (SEEs), and/or cumulative radiation damage.

In low Earth 4842 orbit, objects may be exposed to a temperature range of around −30 to +100° C., which is generally outside the operating conditions for electronics. With the protection member 5003, the electronic components of the system 4700 in low Earth 4842 orbit may only be exposed to a reduced temperature range of −10 to +55° C. Moreover, the electronic components of the system 4700 exposure to single-event effects from radiation may be reduced by 98%, such as, from 4020 events/year, to 2 events/year. Additionally, the total ionizing dose to the electronic components of the system 4700 within the protection member 5003 may be reduced by 95%, from 20 k-rad, to 1 k-rad, over a 5-year mission (where the ionizing dose limit may be between 2 to 10 k-rad to avoid damage to the electronic components of the system 4700 within the protection member 5003).

Embodiments of the modular satellite 4700 may include one or more of an attachment member 4838. The attachment member 4838 may be mounted on and/or carried by the main body member 4701. Also, the attachment member 4838 may be mounted and/or carried by the main body member 4701 at a lower portion and/or on a lower face of the main body member 4701. The attachment member 4838 may be adapted and/or operable to be selectively grasped and/or removably attached to a space deployment arm (not shown), such as, a space deployment arm of a device operable in space, such as, and without limitation, a space shuttle, a space rocket, a space pod, and/or a space station. The attachment member 4838 may be configured to be utilized by the space deployment arm to allow for the modular satellite 4700 to be manipulated, handled, and/or launched in space.

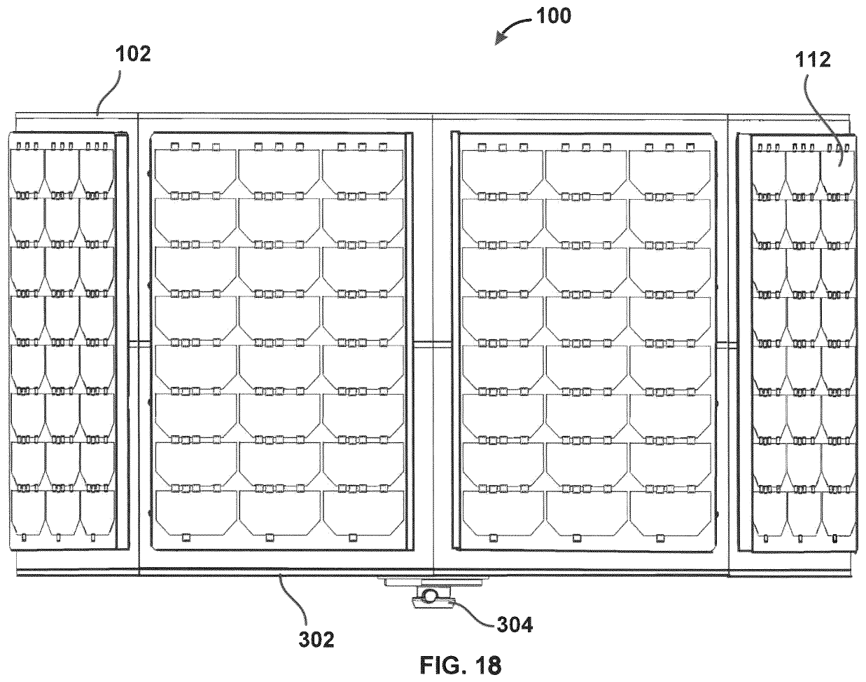

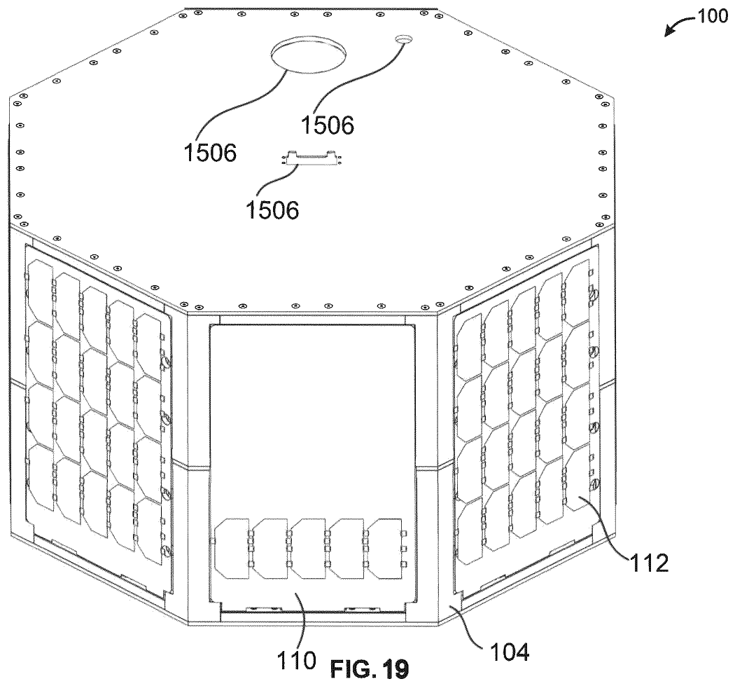

Embodiments of the attachment member 4838 may include one or more of the same and/or similar features of the attachment member 304 described herein and illustratively shown in FIGS. 3 and 18. The attachment member 4838 may be in communication with one or more of the electronic components of the system 4700, and the attachment member 4838 may be adapted and/or utilized to provide and/or allow for communications between one or more of the electronic components of the system 4700 and the space operable device via the attachment member 4838 and the space deployment arm of the space operable device when and/or while the attachment member 4838 is removably attached and/or selectively grasped by the space deployment arm.

In some embodiments of the present invention, the modular satellite 4700 may include one or more of a filter selection device 4848, a filter library 4849, and/or a filter selection arm 4850. filter selection device 4848 The filter selection device 4848 may be configured to be carried by a modular satellite 4700, and the filter selection device 4848 may be positioned and configured to selectively moveably position and/or swap-out one or more light filter(s) within one or more of the orbital camera(s) 4806. For example, without limitation, the orbital camera(s) 4806 may comprise and/or carry one or more of a light filter that may be configured the same and/or similar to a filter device 2201 as described herein and illustratively shown in FIGS. 22-24, 25-31, and/or 39.

The filter selection device 4848 may be configured to moveably position and store light filter(s) that are not being utilized by the orbital camera(s) 4806 to be stored and/or housed by a filter library 4849 carried by the modular satellite 4700. In some embodiments of the present invention, the at least one controller 4812 may be configured to selectively control the filter selection device 4848 to selectively moveably position and/or swap-out one or more light filter(s) of the orbital camera(s) 4806.

In some embodiments of the present invention, the filter selection device 4848 may be configured to carry and/or hold a plurality of light filters in a uniform and/or non-uniform pattern, which may be referred to as a pattern of light filters. The filter selection device 4848 may be operable and/or selectively operable to move (and/or rotatably move) relative to the modular satellite 4700 and/or an adjacent orbital camera 4806. The movement of the filter selection device 4848 may cause the pattern of light filters to correspondingly move, such that one of the light filters of the pattern of light filters may be selectively and/or movably positioned to be utilized by one or more of the orbital camera(s) 4806.

In some embodiments of the present invention, the filter selection device 4848 may comprise a rotatably moveable structure carrying more than one light filter(s) and configured to selectively rotatably move such that one of the light filter(s) may be selectively moveably positioned to be utilized by one or more of the orbital camera(s) 4806. In some other embodiments of the present invention, the filter selection device 4848 may comprise an actuation device and configured to selectively grasp, move, and/or position the light filter(s) to be utilized by one or more of the orbital camera(s) 4806, and to selectively grasp, move, and/or position the light filter(s) to be stored and/or housed by the filter library 4849.

The light filter(s) utilized and/or to be utilized by the orbital camera(s) 4806 may be chosen by the at least one controller 4812 based on a mission instruction. The at least one controller 4812 may determine a predetermined wavelength range based on the mission type and/or mission parameters of the mission instruction. For example, based on the mission instruction, the at least one controller 4812 may match one or more filter range(s) of the light filter(s) to the mission instruction to identify one or more matching light filter(s) that may have the matched filter range(s), and the at least one controller 4812 may selectively control the filter selection device 4848 to selectively moveably position and/or swap-out one or more light filter(s) utilized by the orbital camera(s) 4806 with the one or more matching light filter(s).

In addition to and/or alternatively to the embodiments of the modular satellite 4700 described above and herein, some embodiments of the present invention may be directed to a modular satellite cooperation 4900, which may alternatively and/or interchangeably be referred to herein as a satellite cooperation 4900, without any limitation intended or implied thereby. The satellite cooperation 4900 may comprise a plurality of modular satellites 4700. The modular satellites 4700 of the satellite cooperation 4900 may comprise one or more of the embodiments of the modular satellite 4700 as described above and herein.

For example, and without limitation, the modular satellites 4700 of the satellite cooperation 4900 may include a main body member 4701, a communication system 4802, a datastore 4805, a power unit 4808, one or more controller(s) 4812, and one or more an orbital camera(s) 4806 as described herein, and/or any combination(s) thereof. Additionally, for example and without limitation, the modular satellites 4700 of the satellite cooperation 4900 may include one or more cover member(s) 4702, retention member(s) 4704, release member(s) 4706, shield member(s) 4708, photovoltaic member(s) 4710, hinge member(s) 4712, attitude control system 4804, star tracker 4810, archive datastore 4828, thermal system 4830, attachment member 4838, release controller 4846, filter selection device 4848, filter library 4849, and/or filter selection arm 4850, as described herein and/or any combination(s) thereof.

Each modular satellite 4700 of the satellite cooperation 4900 may be operable and/or configured to perform a mission instruction. Also, each modular satellite 4700 of the satellite cooperation 4900 may be operable and/or configured to capture one or more images that may be associated with the mission instruction, which may be referred to and/or defined as a captured at least one image and/or as one or more captured image. Each modular satellite 4700 of the satellite cooperation 4900 may be operable and/or configured be in communication with and/or to communicate with client terminals 4814.

Additionally, each modular satellite 4700 of the satellite cooperation 4900 may be operable and/or configured to detect at least one and/or one or more of a predetermined object in the captured image(s). For example, without limitation, each modular satellite 4700 of the satellite cooperation 4900 may detect the one or more predetermined object(s) in the captured image(s) based upon the mission instruction. The one or more predetermined object(s) 4816 detected by the modular satellite(s) 4700 of the satellite cooperation 4900 may be referred to as and/or may be defined as a detected at least one predetermined object 4816. Also, the modular satellites 4700 of the satellite cooperation 4900 may be operable to identify the detected at least one predetermined object 4816, which may be defined as an identified at least one predetermined object 4816.

In some embodiments of the present invention, the datastore 4805 may store predetermined object 4816 data that may be accessible by one or more of the controller(s) 4812. One or more of the controller(s) 4812 may be operable and/or configured to access the predetermined object 4816 data stored in the datastore 4805 to detect one or more predetermined object 4816 in the captured image(s) based upon the predetermined object 4816 data, and/or to identify the identified at least one predetermined object 4816 based upon the predetermined object 4816 data.

Each of the modular satellite(s) 4700 of the satellite cooperation 4900 may be operable to generate a mission analytics packet based upon one or more of the captured image(s), the detected predetermined object(s) 4816, the identified predetermined object(s) 4816, and/or the mission instruction. Also, each of the modular satellite(s) 4700 may be operable to store the mission analytics packet, which, without limitation, may be stored in the datastore 4805 and/or the archive datastore 4828. Each of the modular satellite(s) 4700 may be operable and/or configured to transmit the mission analytics packet to one or more client terminal(s) 4814.

In some embodiments of the present invention, each of the modular satellite(s) 4700 of the satellite cooperation 4900 may be also operable and/or configured to be in communication with at least one other modular satellite 4700, 4700b of the satellite cooperation 4900 to form a mesh network 4902, which may be to share and/or coordinate performance of the mission instruction with the one or more other modular satellite(s) 4700, 4700b that are apart of and/or form the mesh network 4902. Each modular satellite 4700 of the mesh network 4902 may coordinate performance of the mission instruction with one another based upon the mission instruction and/or based upon one or more mission performance factor(s). Each of the modular satellite(s) 4700 may be operable and/or adapted to determine one or more mission performance factors based upon the mission instruction.

A mission performance factor may comprise one or more of an action, task, operation, and/or goal for one or more of the modular satellite(s) 4700 to take, execute, perform, accomplish, and/or achieve which may be based on one or more portion(s) of the mission instruction. Each of the modular satellite(s) 4700 in/of the mesh network 4902 may be operable and/or configured to identify and/or share status data to at least one other modular satellite 4700, 4700b within the mesh network 4902. As such, in some embodiments of the present invention, modular satellite(s) 4700 may be operable to determined one or more of the mission performance factor(s) based upon the mission instruction and/or the status data.

Each modular satellite 4700 may be operable and/or configured to generate and/or update its own respective status data that may be shared to other modular satellite(s) 4700, 4700b of the mesh network 4902. The status data may comprise one or more statuses relating to and/or associated with the respective modular satellite 4700. For example, and without limitation, the status data may comprise one or more of a relative location, a geographic location, location coordinates, a temperature amount, a power amount, a radiation exposure amount, an orientation, a velocity, an active operation time, a capabilities list, a fuel amount, a communication bandwidth, an altitude, a data transfer rate, a data transfer amount, an error log, a system health status, a power generation status, an uplink status, a downlink status, a software version report, a hardware report, an event log, a communication latency status, a vibration level status, a component temperature, a magnetic field strength, a task completion status, a task que status, telemetry data, an operational mode status, a memory use status, a processing load status, an emergency status, a data encryption status, and/or a time synchronization status, and/or any combination(s) thereof and/or any other status that may be monitored and/or reported by an orbital satellite or similar device as may be understood by those who may have skill in the art.

The coordination of the performance of the mission instruction by the modular satellite(s) 4700 of the satellite cooperation 4900 that form the mesh network 4902 may include one or more of the modular satellite(s) 4700, without limitation, being caused: to capture at least one image that may be associated with mission instruction, which may be defined as captured image(s); to transmit and/or share the captured image(s) via the mesh network 4902; to receive the captured image(s) via the mesh network 4902; to detect one or more of a predetermined object 4816 in the captured image(s), which may be based upon the mission instruction, and which may defined detected predetermined object(s) 4816; to transmit and share the detected predetermined object(s) 4816 via the mesh network 4902; to receive the detected predetermined object(s) 4816 via the mesh network 4902; to identify the detected predetermined object(s) 4816, which may be defined as identified predetermined object(s) 4816; to transmit and/or share the identified predetermined object(s) 4816 via the mesh network 4902; to generate a mission analytics packet based upon one or more of the captured image(s), the detected predetermined object(s) 4816, the identified predetermined object(s) 4816, and/or the mission instruction; to store the mission analytics packet; and/or to transmit the mission analytics packet to one or more client terminal(s) 4814.

In some embodiments of the satellite cooperation 4900, the mission instruction may comprise an original mission instruction, and one or more of the modular satellite(s) 4700 may be operable to generate one or more of an additional mission instruction. The additional mission instruction may be generated based upon one or more of the original mission instruction, the status data, the captured image(s), the detected predetermined object(s) 4816, the identified predetermined object(s) 4816, and/or one or more mission analytics packet(s).

The modular satellite(s) 4700 of the satellite cooperation 4900 may be operable and/or configured to capture one or more additional image(s) with and/or based upon the additional mission instruction to defined captured additional image(s). The modular satellite(s) 4700 of the satellite cooperation 4900 may also be operable and/or configured to detect one or more of an additional predetermined object 4816 in the captured additional image(s) to defined one or more of detected additional predetermined object(s) 4816. The modular satellite(s) 4700 may also be operable and/or configured to identify the detected additional predetermined object(s) 4816 to define one or more identified predetermined object(s) 4816, which may be based upon stored predetermined object 4816 data and/or the additional mission instruction.

Each of the modular satellite(s) 4700 of the satellite cooperation 4900 may be operable to generate one or more of an additional mission analytics packet, which may be generated based upon one or more of the additional mission instruction, the status data, the additional captured image(s), the detected additional predetermined object(s) 4816, the identified additional predetermined object(s) 4816, and/or one or more other mission analytics packet(s). Each of the modular satellite(s) 4700 may be operable to store the additional mission analytics packet in one or more of the modular satellite(s) 4700, such as, and without limitation, in the datastore 4805 and/or the archive datastore 4828 of or more of the modular satellites 4700 of the satellite cooperation 4900. Each of the modular satellite(s) 4700 of the satellite cooperation 4900 may also be operable to transmit the additional mission analytics packet to one or more of the client terminal(s) 4814.

In some embodiments of the present invention, each of the modular satellite(s) 4700 of the satellite cooperation 4900 may be operable to store data in one or more of the other modular satellite(s) 4700, 4700b of the satellite cooperation 4900. For example, and without limitation, when and/or while the modular satellite(s) 4700 of the satellite cooperation 4900 are formed in a mesh network 4902, each modular satellite 4700 may store data in the datastore 4805 and/or archive datastore 4828 of one or more of the other modular satellite(s) 4700, 4700b a part of the mesh network 4902, with the data comprising one or more of captured image(s), detected predetermined object(s) 4816, identified predetermined object(s) 4816, mission instruction(s), mission analytics packet(s), status data, mission performance factor data, additional captured image(s), detected additional predetermined object(s) 4816, identified additional predetermined object(s) 4816, additional mission instruction(s), additional mission analytics packet(s), status data, and/or additional mission performance factor data and/or any combination(s) thereof. Furthermore, in some embodiments of the present invention, each of the modular satellite(s) 4700 of the satellite cooperation 4900 may be operable to access the data stored in and/or by one or more of the other modular satellite(s) 4700, 4700b of the satellite cooperation 4900. For example, without limitation, each of the modular satellite(s) 4700, 4700b of the satellite cooperation 4900 may access data stored in and/or by one or more of the other modular satellite(s) 4700, 4700b of the satellite cooperation 4900 which may be stored and accessible in the datastore 4805 and/or the archive datastore 4828 thereof.

In some embodiments of the present invention, each modular satellite 4700 a part of the mesh network 4902 and/or the satellite cooperation 4900 may be operable to receive mission analytics packet request. The mission analytics packet request may be sent and/or received from one or more client terminals 4814 and received by the modular satellite 4700 of the satellite cooperation 4900. Each modular satellite 4700 of the satellite cooperation 4900 may be operable to retrieve data stored thereby/therein and/or stored in/by one or more of the other modular satellite 4700, 4700b of the satellite cooperation 4900 responsive to the mission analytics packet request.

Each modular satellite 4700 of the satellite cooperation 4900 may be operable to perform a relevancy process based on the mission instruction. Each modular satellite 4700 of the satellite cooperation 4900 may be operable to perform a relevancy process based on the mission instruction to determined at least one relevancy parameter constraint. Each modular satellite 4700 of the satellite cooperation 4900 may be operable to compare data in the mission analytics packet to the relevancy parameter constraint(s). Each modular satellite 4700 of the satellite cooperation 4900 may be operable to compare data in the mission analytics packet to the relevancy parameter constraint(s) to identify at least a portion of the data of the mission analytics packet based on the comparison between the data of the mission analytics packet and the relevancy parameter constraint(s). The portion(s) of the data of the mission analytics packet identified by the modular satellite(s) 4700 of the satellite cooperation 4900 may be referred to and/or defined as relevant data. Additionally, each modular satellite 4700 of the satellite cooperation 4900 may be operable to remove one or more portions of the data of the mission analytics packet that is not and/or has not been identified as relevant data.

In some embodiments of the present invention, the modular satellite 4700 and/or one or more of the modular satellite(s) 4700 of the satellite cooperation 4900 may be operable to be in communication with one or more of a third-party communication device 4852. The communication between the third-party communication device 4852 and the modular satellite(s) 4700 may comprise a relatively low data rate of machine-readable data and/or information compared to the communication between the modular satellite(s) 4700 and/or the client terminal(s) 4814. The modular satellite(s) 4700 may be operable to communicate with one or more of the client terminal(s) 4814 via the communication with the third-party communication device 4852.

The third-party communication device 4852 may be in communication with a third-party communication station 4902 that may be in communication with one or more of the client terminal(s) 4814. The modular satellite(s) 4700 may be operable to generate and transmit a priority notification signal to one or more of the client terminal(s) 4814 via the third-party communication device 4852 and/or third-party communication station 4904. The priority notification signal may comprise a data packet size that is smaller than a data packet size of the mission analytics packets.

Some embodiments of the modular satellite(s) 4700 may be operable to receive a maritime data signal from a maritime vessel 4853. The maritime data signal transmitted from a marine vessel 4853 may comprise an automatic identification system (AIS) signal from an AIS transponder carried by the maritime vessel 4853. The maritime data signal may comprise and/or be associated with one or more of a unique identifier of the maritime vessel 4853, a maritime mobile service identity of the maritime vessel 4853, a name of the maritime vessel 4853, an international maritime organization unique identifier number of the maritime vessel 4853, a call sign of the maritime vessel 4853, a ship type of the maritime vessel 4853, dimensions of the maritime vessel 4853, a geographical position of the maritime vessel 4853, a latitude of the maritime vessel 4853, a longitude of the maritime vessel 4853, a direction of the maritime vessel 4853, a course over ground (COG) of the maritime vessel 4853, a speed of the maritime vessel 4853, a speed over ground (SOG) of the maritime vessel 4853, a heading of the maritime vessel 4853, a rate of turn of the maritime vessel 4853, navigation status of the maritime vessel 4853, a destination of the maritime vessel 4853, an estimated time of arrival (ETA) of the maritime vessel 4853, a draught of the maritime vessel 4853, and/or the cargo type of the maritime vessel 4853 and/or any combination(s) thereof.

The modular satellite(s) 4700 may determine and/or generate a predicted maritime data signal to be associated with the maritime vessel 4853 based on one or more captured image(s), detected predetermined object(s) 4816, identified predetermined object(s) 4816, and/or based on the mission analytics packet(s), which may include the maritime vessel 4853 and/or which may be determined by the modular satellite(s) 4700 to include the maritime vessel 4853. The predicted maritime data signal associated with the maritime vessel 4853 may include, without limitation, one or more of a predicted unique identifier of the maritime vessel 4853, a predicted maritime mobile service identity of the maritime vessel 4853, a predicted name of the maritime vessel 4853, a predicted international maritime organization unique identifier number of the maritime vessel 4853, a predicted call sign of the maritime vessel 4853, a predicted ship type of the maritime vessel 4853, predicted dimensions of the maritime vessel 4853, a predicted geographical position of the maritime vessel 4853, a predicted latitude of the maritime vessel 4853, a predicted longitude of the maritime vessel 4853, a predicted direction of the maritime vessel 4853, a predicted course over ground (COG) of the maritime vessel 4853, a predicted speed of the maritime vessel 4853, a predicted speed over ground (SOG) of the maritime vessel 4853, a predicted heading of the maritime vessel 4853, a predicted rate of turn of the maritime vessel 4853, predicted navigation status of the maritime vessel 4853, a predicted destination of the maritime vessel 4853, a predicted estimated time of arrival (ETA) of the maritime vessel 4853, a predicted draught of the maritime vessel 4853, and/or a predicted cargo type of the maritime vessel 4853 and/or any combination(s) thereof.

In some embodiments of the present invention, the modular satellite(s) 4700 may store and/or have access to a predetermined list of predicted maritime data signals. The modular satellite(s) 4700 may be operable to match a maritime vessel 4853 that is captured in one of the captured image(s), and/or detected and identified from the captured image(s), and/or documented in one of the mission analytics packet(s), to the list of predicted maritime data signals to determine and/or identify a predicted maritime data signal that may be defined as a matched predicted maritime data signal. The modular satellite(s) 4700 may be operable to compare the predicted maritime data signal with the maritime data signal to generate and/or identify a priority notification characteristic and/or determine and/or identify a priority notification event. The predetermined priority notification event may include, without limitation, a non-match between at least one portion of the marine data signal to at least one corresponding portion of the predicted maritime data signal and/or the matched predicted maritime data signal. The at least one portion(s) non-matched between the marine data signal and the predicted/matched predicted marine data signal may define the predetermined priority notification characteristic.

The modular satellite 4700 may be operable to generate a priority notification signal. The modular satellite(s) 4700 may be operable to transmit the priority notification signal to the client terminal 4814 and/or to another modular satellite 4700, 4700b, and/or to the client terminal 4814 via another modular satellite 4700, 4700b, and/or to the client terminal 4814 via a third-party communication device 4852 and/or third-party communication station 4904. The modular satellite(s) 4700 may be operable to transmit the priority notification signal responsive to determining and/or identifying the priority notification event and/or the priority notification characteristic. The priority notification signal may be generated based on at least a portion of the captured image(s), the detected predetermined object(s) 4816, the identified predetermined object(s) 4816, the mission analytics packet(s), the priority notification characteristic, the priority notification event, the predicted maritime data signal, the matched predicted maritime data signal, and/or the maritime data signal.

In some embodiments of the present invention, the modular satellite(s) 4700 may be operable to generate a priority notification mission analytics packet. The modular satellite(s) 4700 may be operable to generate the priority notification mission analytics packet based on at least a portion of the captured image(s), the detected predetermined object(s) 4816, the identified predetermined object(s) 4816, the mission analytics packet(s), the priority notification characteristic, the priority notification event, the predicted maritime data signal, the matched predicted maritime data signal, and/or the maritime data signal. A data size of the priority notification mission analytics packet may comprise a higher/greater data size than a data size of the priority notification signal.

The modular satellite(s) 4700 may be operable to generate the priority notification mission analytics packet responsive to transmitting the priority notification signal and/or responsive to determining and/or identifying the priority notification event. The modular satellite(s) 4700 may be operable to transmit the priority notification mission analytics packet to the client terminal 4814 and/or to another modular satellite 4700, 4700b, and/or to the client terminal 4814 via another modular satellite 4700, 4700b, and/or to the client terminal 4814 via a third-party communication device 4852 and/or third-party communication station 4904.

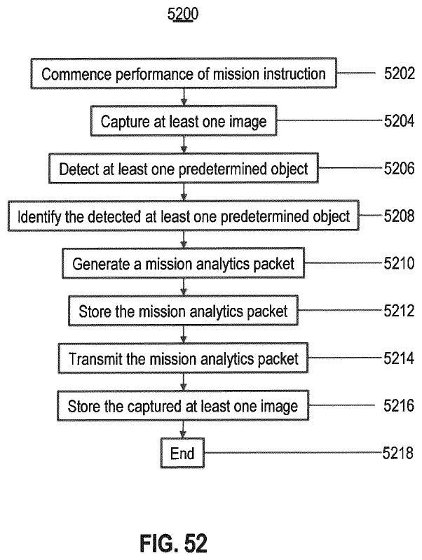

Now referring to FIG. 52, a method 5200 aspect of an embodiment of the present invention may be directed to using, operating, and/or performance of a modular satellite 4700 according to an embodiment of the present invention that may be related to capturing image(s). The method 5200 may begin at Block 5202 to commence performance of a mission instruction. At Block 5202, the method 5200 may move to Block 5204 to capture at least one image. At Block 5204, the method 5200 may move to Block 5206 to detect at least one predetermined object 4816. At Block 5206, the method 5200 may move to Block 5208 to identify the detected at least one predetermined object 4816.

At Block 5208, the method 5200 may move to Block 5210 to generate a mission analytics packet. At Block 5210, the method 5200 may move to Block 5212 to store the mission analytics packet. At Block 5212, the method 5200 may move to Block 5214 to transmit the mission analytics packet. At Block 5214, the method 5200 may move to Block 5215 to stored the captured at least one image. At Block 5216, the method 5200 may move to end at Block 5218.

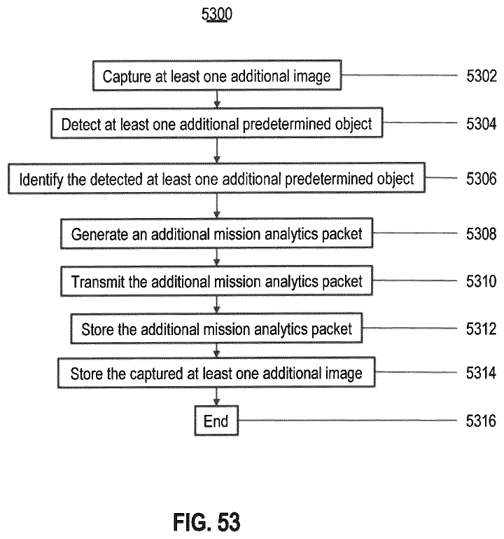

Now referring to FIG. 53, a method 5300 aspect of the present invention may be directed to using, operating, and/or performance of a modular satellite 4700 according to an embodiment of the present invention that may be related to capturing additional image(s). The method 5300 may begin at Block 5302 to capture at least one additional image. At Block 5302, the method 5300 may move to Block 5304 to detect at least one additional predetermined object 4816. At Block 5304, the method 5300 may move to Block 5306 to identify the detected at least one predetermined object 4816. At Block 5306, the method 5300 may move to Block 5308 to generate an additional mission analytics packet.

At Block 5308, the method 5300 may move to Block 5310 to transmit the additional mission analytics packet. At Block 5310, the method 5300 may move to Block 5312 to store the additional mission analytics packet. At Block 5312, the method 5300 may move to Block 5314 to store the captured at least one additional image. At Block 5314, the method 5300 may move to end at Block 5316.

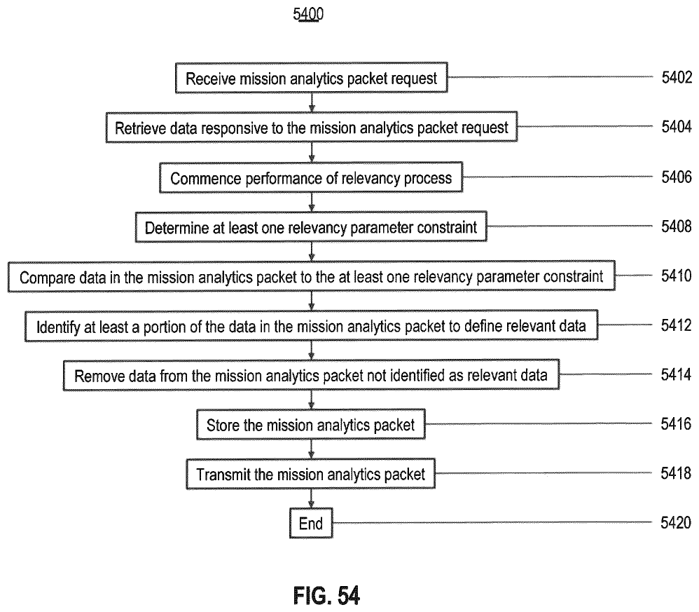

Now referring to FIG. 54, a method 5400 aspect of an embodiment of a modular satellite 4700 may be directed to performance of a modular satellite 4700 responsive to a mission analytics packet request. The method 5400 may begin at Block 5402 to receive a mission analytics packet request. At Block 5402, the method 5400 may move to Block 5404 to retrieve data responsive to the mission analytics packet request. At Block 5404, the method 5400 may move to Block 5406 to commence performance of a relevancy process. At Block 5406, the method 5400 may move to Block 5408 to determine at least one relevancy parameter constraint.

At Block 5408, the method 5400 may move to Block 5410 to compare data in the mission analytics packet to the at least one relevancy parameter constraint. At Block 5410, the method 5400 may move to Block 5412 to identify at least a portion of the data in the mission analytics packet to define relevant data. At Block 5412, the method 5400 may move to Block 5414 to remove data from the mission analytics packet that may not have been identified as relevant data. At Block 5414, the method 5400 may move to Block 5416 to store the mission analytics packet. At Block 5416, the method 5400 may move to Block 5418 to transmit the mission analytics packet. At Block 5418, the method 5400 may move to end at Block 5420.

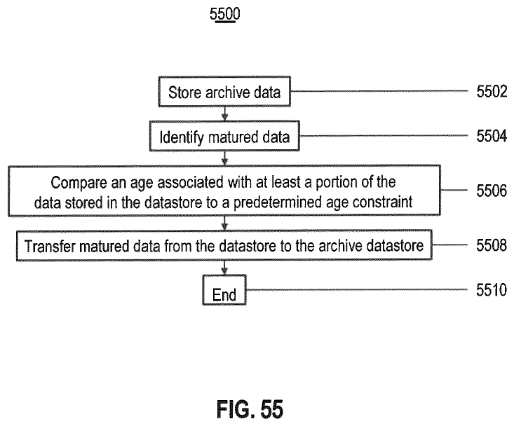

Now referring to FIG. 55, a method 5500 aspect of an embodiment of the present invention may be directed to using and/or performance of an archive datastore 4828 and/or of a modular satellite 4700 having an archive datastore 4828. The method 5500 may being at Block 5502 to store archive data. At Block 5502, the method 5500 may move to Block 5504 to identify matured data. At Block 5504, the method 5500 may move to Block 5506 to compare an age associated with at least a portion of the data stored in the datastore 4805 of the modular satellite 4700 to a predetermined age constraint. At Block 5506, the method 5500 may move to Block 5508 to transfer matured data from the datastore 4805 to the archive datastore 4828. At Block 5508, the method 5500 may move to end at Block 5510.

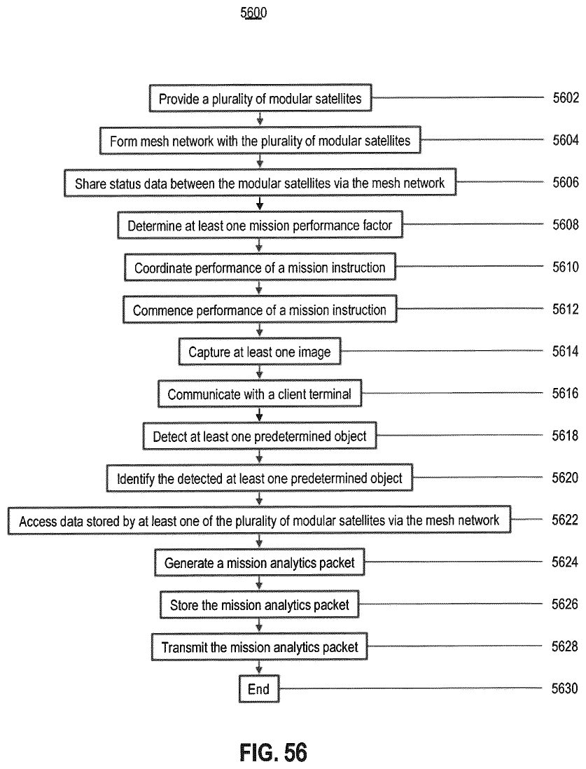

Now referring to FIG. 56, a method 5600 aspect of an embodiment of the present invention may be directed to using and/or the performance of a plurality of modular satellite(s) 4700, 4700b and/or of a satellite cooperation 4900 that comprises a plurality of modular satellite(s) 4700, 4700b. The method 5600 may begin at Block 5602 to provide a plurality of modular satellite(s) 4700. At Block 5602, the method 5600 may move to Block 5604 to form a mesh network 4902 with the plurality of modular satellite(s) 4700. At Block 5604, the method 5600 may move to Block 5606 to share status data. At Block 5606, the method 5600 may move to Block 5608 to determine at least one mission performance factor.

At Block 5608, the method 5600 may move to Block 5610 to coordinate performance of a mission instruction. At Block 5610, the method 5600 may move to Block 5612 to commence performance of the mission instruction. At Block 5612, the method 5600 may move to Block 5614 to capture at least one image. At Block 5614, the method 5600 may move to Block 5616 to communicate with a client terminal 4814. At Block 5616, the method 5600 may move to Block 5618 to detect at least one predetermined object 4816. At Block 5618, the method 5600 may move to Block 5620 to identify the detected at least one predetermined object 4816.

At Block 5620, the method 5600 may move to Block 5622 to access data stored by at least one of the plurality of modular satellite(s) 4700, 4700b via the mesh network 4902. At Block 5622, the method 5600 may move to Block 5624 to generate a mission analytics packet. At Block 5624, the method 5600 may move to Block 5626 to store the mission analytics packet. At Block 5626, the method 5600 may move to Block 5628 to transmit the mission analytics packet. At Block 5628, the method 5600 may move to end at Block 5630.a

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention.

In addition, many modifications may be made to adapt a particular situation or material to the teachings of the invention without departing from the essential scope thereof. Therefore, it is intended that the invention may not be limited to the particular embodiment disclosed as the best or only mode contemplated for carrying out this invention, but that the invention will include all embodiments falling within the scope of the appended claims.

Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Thus, the scope of the invention should be determined by the appended claims and their legal equivalents, and not by the examples given.

The claims in the instant application may be different than those of the parent application and any other related application(s). If so, Applicant therefore rescinds any disclaimer of claim scope made in the parent application or any predecessor application in relation to the instant application. Any such previous disclaimer and the cited references that it was made to avoid, may need to be revisited. Further, any disclaimer made in the instant application should not be read into or against the parent application.

What is claimed is:

1. A modular satellite comprising:
a main body member;
at least one controller carried by the main body member and operable to perform a mission instruction;
a communication system carried by the main body member and in communication with the at least one controller and a client terminal;
a datastore carried by the main body member and operable to store data accessible by the at least one controller;
a power unit carried by the main body member and in communication with the at least one controller; and
at least one orbital camera carried by the main body member and operable to capture at least one image associated with the mission instruction, defined as a captured at least one image;
wherein the at least one controller is operable to detect at least one predetermined object in the captured at least one image, defined as a detected at least one predetermined object;
wherein the at least one controller is operable to identify the detected at least one predetermined object, defined as an identified at least one predetermined object;
wherein the at least one controller generates a mission analytics packet based upon the captured at least one image, the detected at least one predetermined object, the identified at least one predetermined object, and the mission instruction;
wherein the at least one controller is operable to store the mission analytics packet in the datastore; and
wherein the at least one controller is operable to transmit the mission analytics packet to the client terminal.

2. The modular satellite of claim 1, further comprising a plurality of cover members carried by the main body member and movable between an opened position and a closed position; wherein each of the plurality of cover members includes a retention member; wherein the main body member includes a respective plurality of release members; wherein a retention line is extended between the retention member and a retention line connection point on the main body member adjacent to the release member; wherein the retention line is configured to be in contact with the release member when the cover member is in the closed position; wherein the retention line is moveable from a retention state to a released state; wherein when the retention line is in the retention state, the cover member is prevented from moving to the opened position; and wherein when the retention line is in the released state, the cover member is moveable from the closed position to the opened position.

3. The modular satellite of claim 2, wherein the release member is operable between a neutral state and a charged state; and wherein the charged state is defined as the release member being heated to a temperature suitable to cause the retention line to be severed.

4. The modular satellite of claim 3, wherein upon and while the retention line is severed, the cover member is moveable from the closed position to the opened position.

5. The modular satellite of claim 2, further comprising an attitude control system to monitor and control an orientation of the main body member; wherein the attitude control system detects a movement force associated with the cover members being moved between the closed position and the open position; and wherein the attitude control system generates a counter force to counteract the movement force.

6. The modular satellite of claim 5, further comprising a star tracker operable to track at least one star; wherein each of the cover members includes a photovoltaic member; and wherein the attitude control system is operable to orient the main body so that the photovoltaic members are oriented to face a direction of the at least one star.

7. The modular satellite of claim 1, wherein the at least one orbital camera is configured to filter at least one wavelength of light from light received thereby to define a filtered light; wherein the at least one orbital camera senses the filtered light to generate sensed light data; and wherein the captured at least one image is defined by the sensed light data.

8. The modular satellite of claim 1, wherein the mission instruction is an original mission instruction; wherein the captured at least one image is stored in the datastore; wherein the at least one controller is operable to generate at least one additional mission instruction based upon the original mission instruction; wherein the at least one orbital camera is operable to capture at least one additional image associated with the additional mission instruction, defined as a captured at least one additional image; wherein the at least one controller is operable to detect at least one additional predetermined object in the captured at least one additional image, defined as a detected at least one additional predetermined object; wherein the at least one controller is operable to identify the detected at least one additional predetermined object, defined as an identified at least one additional predetermined object; wherein the at least one controller is operable to generate an additional mission analytics packet based upon the additional mission instruction and the captured at least one additional image; wherein the at least one controller is operable to store the additional mission analytics packet in the datastore; and wherein the at least one controller is operable to transmit the additional mission analytics packet to the client terminal.

9. The modular satellite of claim 8, wherein the at least one orbital camera is operable to capture the at least one image associated with the mission instruction and the at least one additional image associated with the at least one additional mission instruction simultaneously.

10. The modular satellite of claim 1, wherein the at least one controller is operable to receive a mission analytics packet request from the client terminal; and wherein the at least one controller is operable to retrieve data from the datastore responsive to the mission analytics packet request.

11. The modular satellite of claim 1, wherein the at least one controller performs a relevancy process to determine at least one relevancy parameter constraint based upon the mission instruction; wherein the at least one controller is operable to compare data in the mission analytics packet to the at least one relevancy parameter constraint; wherein at least a portion of the data in the mission analytics packet is identified based on the comparison of the data in the mission analytics packet to the at least one relevancy perimeter constraint, defined as relevant data; and wherein the at least one controller is operable to remove data from the mission analytics packet that is not identified as the relevant data.

12. The modular satellite of claim 1, wherein the at least one controller is operable to identify expired data by comparing an age associated with at least one portion of the data stored in the datastore to a predetermined age constraint; and wherein the at least one controller is operable to delete the expired data.

13. The modular satellite of claim 1, further comprising an archive datastore carried by the main body member and operable to store archive data accessible by the at least one controller; wherein the at least one controller is operable to identify matured data by comparing an age associated with at least one portion of the data stored in the datastore to a predetermined age constraint; and wherein the at least one controller is operable to transfer the matured data from the datastore to the archive datastore.

14. A modular satellite cooperation comprising:
a plurality of modular satellites;
wherein each one of the plurality of modular satellites comprises:
a main body member;
at least one controller carried by the main body member;
a communication system carried by the main body member and in communication with the at least one controller;
a datastore carried by the main body member operable to store data accessible by the at least one controller;
a power unit carried by the main body member and in communication with the at least one controller; and
at least one orbital camera carried by the main body member and operable to capture images;
wherein each one of the plurality of modular satellites is operable to perform a mission instruction and is operable to capture at least one image associated with the mission instruction defined as a captured at least one image;
wherein each one of the plurality of modular satellites is configured to communicate with a client terminal;
wherein each one of the plurality of modular satellites is operable to detect at least one predetermined object in the captured at least one image based upon the mission instruction, defined as a detected at least one predetermined object;
wherein each one of the plurality of modular satellites is operable to identify the detected at least one predetermined object, defined as an identified at least one predetermined object;
wherein each one of the plurality of modular satellites is operable to generate a mission analytics packet based upon the captured at least one image, the detected at least one predetermined object, the identified at least one predetermined object, and the mission instruction;
wherein each one of the plurality of modular satellites is operable to store the mission analytics packet;
wherein each one of the plurality of modular satellites is operable to transmit the mission analytics packet to the client terminal; and
wherein each one of the plurality of modular satellites is operable to be in communication with at least one other modular satellite of the plurality of modular satellites to form a mesh network and to share and coordinate performance of the mission instruction.

15. The modular satellite cooperation of claim 14, wherein each one of the modular satellites in the mesh network coordinates performance of the mission instruction with one another based upon the mission instruction and at least one mission performance factor.

16. The modular satellite cooperation of claim 15, wherein each one of the modular satellites in the mesh network is operable to determine the at least one mission performance factor based upon the mission instruction.

17. The modular satellite cooperation of claim 16, wherein each one of the modular satellites in the mesh network is operable to identify and share status data to at least one other modular satellite via the mesh network; and wherein each one of the modular satellites in the mesh network is operable to determine the at least one mission performance factor based upon the mission instruction and the status data.

18. The modular satellite cooperation of claim 16, wherein coordination of performance of the mission instruction by the modular satellites in the mesh network includes causing at least one of the modular satellites in the mesh network to at least one of:
capture the at least one image associated with the mission instruction, defined as the captured at least one image;
transmit and share the captured at least one image via the mesh network;
receive the captured at least one image via the mesh network;
detect the at least one predetermined object in the captured at least one image based upon the mission instruction, defined as the detected at least one predetermined object;
transmit and share the detected at least one predetermined object via the mesh network;
receive the detected at least one predetermined object via the mesh network;
identify the detected at least one predetermined object, defined as the identified at least one predetermined object;
transmit and share the identified at least one predetermined object via the mesh network;
receive the identified at least one predetermined object via the mesh network;
generate the mission analytics packet based upon the captured at least one image, the detected at least one predetermined object, the identified at least one predetermined object, and the mission instruction;
store the mission analytics packet; and
transmit the mission analytics packet to the client terminal.

19. The modular satellite cooperation of claim 14, wherein each one of the plurality of modular satellites comprises a plurality of cover members moveable between an opened position and a closed position and that each include a retention member; wherein the main body member of each one of the plurality of modular satellites includes a respective plurality of release members; wherein a retention line is extended between the retention member and a retention line connection point on the main body member adjacent to the release member; wherein the retention line is configured to be in contact with the release member when the cover member is in the closed position; wherein the retention line is movable from a retention state to a released state; wherein when the retention line is in the retention state, the cover member is prevented from moving to the opened position; and wherein when the retention line is in the released state, the cover member is movable from the closed position to the opened position.

20. The modular satellite cooperation of claim 19, wherein the release member is operable between a neutral stated and a charged state; and wherein the charged state is defined as the release member being heated to a temperature suitable to cause the retention line to be severed.

21. The modular satellite cooperation of claim 20, wherein upon and while the retention line is severed, the cover member is moveable from the closed position to the opened position.

22. The modular satellite cooperation of claim 19, wherein each one of the plurality of modular satellites comprises an attitude control system to monitor and control an orientation of the main body member; wherein the attitude control system detects a movement force associated with the cover members being moved between the closed position and the opened position; and wherein the attitude control system generates a counter force to counteract the movement force.

23. The modular satellite cooperation of claim 22, wherein each one of the plurality of modular satellites comprises a star tracker operable to track at least one star; wherein each of the cover members includes a photovoltaic member; and wherein the attitude control system is operable to orient the main body so that the photovoltaic members are oriented to face a direction of the at least one star.

24. The modular satellite cooperation of claim 14, wherein each one of the plurality of modular satellites is configured to generate sensed light data by filtering at least one wavelength of light from light received thereby to define a filtered light and sensing the filtered light to generate the sensed light data; and wherein the captured at least one image is defined by the sensed light data.

25. The modular satellite cooperation of claim 14, wherein the mission instruction is an original mission instruction; wherein each one of the plurality of modular satellites is operable to store the captured at least one image; wherein each one of the plurality of modular satellites is operable to generate at least one additional mission instruction based upon the original mission instruction; wherein each one of the plurality of modular satellites is operable to capture at least one additional image associated with the additional mission instruction, defined as a captured at least one additional image; wherein each one of the plurality of modular satellites is operable to detect at least one additional predetermined object in the captured at least one additional image, defined as a detected at least one additional predetermined object; wherein each one of the plurality of modular satellites is operable to identify the detected at least one additional predetermined object, defined as an identified at least one additional predetermined object; wherein each one of the plurality of modular satellites is operable to generate an additional mission analytics packet based upon the at least one additional mission instruction and the captured at least one image; wherein each one of the plurality of modular satellites is operable to store the additional mission analytics packet; and wherein each one of the plurality of modular satellites is operable to transmit the additional mission analytics packet to the client terminal.

26. The modular satellite cooperation of claim 14, wherein each one of the plurality of modular satellites is operable to store the captured at least one image, the detected at least one predetermined object, and the identified at least one predetermined object; and wherein data stored by each one of the plurality of modular satellites in the mesh network is accessible by at least another one of the plurality of modular satellites in the mesh network.

27. The modular satellite cooperation of claim 26, wherein each one of the plurality of modular satellites is operable to receive a mission analytics packet request from the client terminal; and wherein each one of the plurality of modular satellites is operable to retrieve data stored by at least one of the plurality of modular satellites in the mesh network responsive to the mission analytics packet request.

28. The modular satellite cooperation of claim 14, wherein each one of the plurality of modular satellites is operable to perform a relevancy process to determine at least one relevancy parameter constraint based upon the mission instruction; wherein each one of the plurality of modular satellites is operable to compare data in the mission analytics packet to the at least one relevancy parameter constraint; wherein at least a portion of the data in the mission analytics packet is identified based on the comparison of the data in the mission analytics packet to the at least one relevancy parameter constraint, defined as relevant data; and wherein the each one of the plurality of modular satellites is operable remove data from the mission analytics packet that is not identified as the relevant data.
